(19) United States
(12) Patent Application Publication
(10) Pub. No.: US 2009/0177128 A1
(43) Pub. Date: Jul. 9, 2009

(54) Chair-Type Massaging Apparatus, Massaging Apparatus, Control Device of Chair-Type Massaging Apparatus And Remote Control Device For Chair-Type Massaging Apparatus

(75) Inventors: Yoshifumi Fukuyama, Yonago-shi (JP); Tomoki Nagamitsu, Saihaku-gun (JP); Akihiko Gondai, Saihaku-gun (JP); Keisuke Takatsuka, Yonago-shi (JP); Tomoharu Fukuda, Yonago-shi (JP); Mitsunori Kato, Yonago-shi (JP)

Correspondence Address: ALLEMAN HALL MCCOY RUSSELL & TUTTLE LLP, 806 SW BROADWAY, SUITE 600, PORTLAND, OR, 97205-3335, US

(73) Assignee: Family Co. Ltd., Osaka-shi (JP)

(21) Appl. No.: 11/922,719

(22) PCT Filed: May 23, 2006
(86) PCT No.: PCT/JP2006/310236

§ 371 Date: Sep. 18, 2008

(30) Foreign Application Priority Data
Jun. 20, 2005 (JP) 2005-179133
Jun. 21, 2005 (JP) 2005-180134
Jul. 25, 2005 (JP) 2005-213804
Jul. 25, 2005 (JP) 2005-213806
Jul. 25, 2005 (JP) 2005214693
Aug. 3, 2005 (JP) 2005-225091
Jan. 31, 2006 (JP) 2006-022893

(51) Int. Cl. A61H 7/00

(52) U.S. Cl. 601/98; 601/134; 601/101

(57) ABSTRACT

A chair-type massaging apparatus of the present invention, including a massaging element that is mounted in a back rest configured to support a back of a user and is configured to be movable in a substantially forward and backward direction to apply stimulation to the back, a control device that includes a grip that is tilted by the user to be displaceable from a predetermined neutral position in the forward and backward direction substantially corresponding with the direction in which the massaging element moves and is configured to output a signal indicating a displacement of the grip, and a controller configured to, based on the signal from the control device, execute control to move the massaging element in a direction substantially corresponding with a direction in which the grip is operated to move.

### TECHNICAL FIELD

The present invention relates to a chair-type massaging apparatus and a massaging apparatus that are configured to massage bodies of users, and various control devices equipped in these massaging apparatuses. More particularly, the present invention relates to a chair-type massaging apparatus and a massaging apparatus that are configured to massage bodies of users seated therein by operating a control device without mental effort or feeling discomfort, and various control devices equipped in these massaging apparatuses.

### BACKGROUND ART

Conventional massaging apparatuses that are capable of massaging bodies of users include a massaging element configured to stimulate the bodies of the users, and a control device operated by the users to change a position of the massaging element. One example of the conventional massaging apparatuses is a chair-type massaging apparatus disclosed in a Japanese Patent No. 2566275. This chair-type massaging apparatus includes a vertically movable massaging element mounted in a back rest, and a joystick control equipment (device) having a rod-shaped operation element vertically extending on an upper region of an arm rest. In this massaging apparatus, when the user tilts the operation element of the control device in a forward and backward direction, the vertical position of the massaging element is changed in response to the tilting operation.

In the massaging apparatus disclosed in the above identified U.S. Pat. No. 2,566,275, the user's operation to tilt the joystick control device in the forward and backward direction causes the vertical position of the massaging element to be changed, and thus, the direction in which the user operates to move the control device does not match the direction in which the massaging element moves. When there is a directional mismatch between the operation of the control device by the user and the movement of the massaging element, the user may in some cases feel discomfort and feel difficulty in operating the control device to move the massaging element to a desired position.

In the chair-type massaging apparatus disclosed in the above identified U.S. Pat. No. 2,566,275, when the user tilts the control device, only a signal indicating the tilting direction is output from a simple ON/OFF switch, causing the user to feel discomfort in operating the control device. The displacement amount is desirably proportional between the operation of the massaging element and the operation of the control device, because the user is able to easily move the massaging element to a desired position.

However, if the chair-type massaging apparatus is configured in such a manner that the displacement amount of the control device is proportional to the displacement amount of the massaging element, then the massaging element may be displaced with a delay with respect to the displacement of the control device, because the massaging element is typically mechanically driven by a motor, gears, etc. Such a delay occurring in the massaging element may make the user feel discomfort, and it is therefore desirable to eliminate such a delay.

Conventionally, there are known chair-type massaging apparatuses configured to stimulate the bodies of the users by, for example, kneading, tapping, finger-pressing, rolling, etc. Most of these chair-type massaging apparatuses are configured in such a manner that a massaging element applies stimulation to a waist, a back and a shoulder of the user or an air bag applies the stimulation to a calf, a thigh or a hip of the user.

The massaging element is vertically movable with respect to the back of the user so as to apply the stimulation to the waist, the back and the shoulder of the user. The massaging element is equipped in a massaging system, which is configured to provide a kneading operation or a tapping operation to an arm that generally supports the massaging element from a direction perpendicular to the waist and the back of the user, thus massaging the user in various manners.

The massaging system typically includes arms provided with the massaging elements on right and left sides relative to the center of the body of the user, which are movable along the length of the body including the waist, the back, and the shoulder of the user to apply the stimulation such as kneading, tapping, finger-pressing, rolling, etc, to the body of the user to thereby massage the body in various manners.

The air bag is expandable and contractable at a calf, a thigh, a hip, and other parts of the user so as to press the calf, the thigh, the hip of the user, thus applying the stimulation to them. The air bag is expanded and contracted by controlling inflow and outflow of compressed air by an air supply source.

How to operate the air bag and the massaging element may be determined by the user's operation of the control device equipped in the massaging apparatus. One typical example of the control device is a remote control device operated by the user so that the user selects the operation of the massaging element or the air bag, a tilting angle of a back rest, or a foot rest, etc. Another example is a joystick control device mounted on an arm rest.

The massaging apparatus equipped with the joystick control device is, for example, such that a desired operation mode is selected from plural operations modes by using a joystick device which is used like a shift lever (see e.g., Japanese Laid-Open Patent Application Publication No. 2004-16428 (page 3, FIG. 1)).

A massaging apparatus equipped with another control device is, for example, such that the control device is provided with a grip configured to be operated by one hand of a user so as to slightly adjust a position of a massaging element by pressing an operation portion attached at a head of the grip with a thumb in an axial direction of the grip and by pivoting it around the axis of the grip (see Japanese Laid-Open Patent Application Publication No. 2005-6735 (page 5, FIGS. 1 to 4).

However, in the joystick control device disclosed in the above identified Japanese Laid-Open Patent Application Publication No. 2004-16428, the user grips a joystick and tilts it forward and backward or rightward and leftward to select a desired operation mode from preset operation modes. In the joystick control device, since the desired operation mode is thus selected from the preset operation modes, choices are limited.

The user sometimes desires to select massage (massage operation) for an individual part of the body depending on a physical condition or a mood that may vary from day to day. For instance, when the user feels exhausted at the shoulder, the shoulder is required to be massaged intensively, or otherwise when the user feels exhausted at the waist, the waist or the back is required to be massaged intensively.

In the joystick control device disclosed in Japanese Laid-Open Patent Application Publication No. 2004-16428, since the selectable operation modes are limited as described above, the massage operation for the individual part is unable to be selected. If the operation mode is increased to correspond to each tilting position or tilting angle of the joystick, then operation becomes very complicated and wrong operation may be selected by a little mistake. As a result, stable operation is difficult. The massaging apparatus disclosed in Japanese Laid-Open Patent Application Publication No. 2005-6735 is not a chair-type massaging apparatus that carries out a desired massage operation. Under these circumstances, there is a need for a control device that enables various massage operations to be carried out and a chair-type massaging apparatus equipped with the control device.

In addition to the massaging apparatus disclosed in the Japanese Laid-Open Patent Application Publications Nos. 2004-16428 and 2005-6735, a massaging apparatus equipped with the joystick control device is disclosed in Japanese Laid-Open Patent Application Publication No. 2004-57465 (pages 8 and 9, FIGS. 9 to 12), in which a desired operation mode is selected from plural operation modes by a joystick device like a shift lever. In this massaging apparatus, the joystick device is configured to select the desired operation mode from the plural selection modes. This joystick is foldable at an upper surface region of an arm rest to be able to be stored into a concave storage portion that opens on the upper surface of the arm rest.

In the joystick control device disclosed in Japanese Laid-Open Patent Application Publication No. 2004-57465, the massage operation is selected by operating the joystick provided to protrude from the arm rest.

However, this joystick is provided to protrude from the upper surface of the arm rest, it may in some cases be an obstruction when the massage operation is carried out without the joystick or when the massaging apparatus is not operating.

In a case where the joystick is folded and stored as disclosed in the Laid-Open Patent Application Publication No. 2004-57465, the joystick is required to be provided with a bent portion at a shaft thereof, causing deviation from an upright position between upper and lower regions at the bent portion. Such deviation makes it difficult to operate the joystick and may be a hindrance to smooth operation. In addition, slight deviation of the joystick may make it difficult to operate the joystick when the joystick is used to precisely control the position or operation of the massaging element, although such slight deviation does not make it difficult to operate the joystick in a simple operation to select the desired operation from the plural operation modes as disclosed in Japanese Laid-Open Patent Application Publication No. 2004-57465. Under these circumstances, it is desirable to appropriately store the control device into the arm rest.

Conventionally, the operation of the massaging element and the operation of the air bag that are configured to be controlled by the joystick control device is typically controlled by the remote control device rather than the joystick control device. One example of the remote control device of this type is a control device equipped with switches arranged in a matrix on a display portion in a form of a human body as an input device with which a moving range of a massaging element is entered, and a display device configured to display the entered movement range (see for example, Japanese Laid-Open Patent Application Publication No. Hei. 5-168666, pages 2 and 3 and FIG. 1).

Another example of the remote control device is constructed in such a manner that a protrusion to specify a head of a human body is provided at an end in the longitudinal direction of the control device, and plural control buttons are arranged on a front surface of a body in the longitudinal direction in an order that corresponds to parts of the body to be massaged so that the plural control buttons corresponding to the respective parts of the human body are selectively operated by finger touch (see for example, Japanese Laid-Open Patent Application Publication No. 2003-310680, pages 4 and 5 and FIG. 3).

Another example of the remote control device is constructed to have a first surface corresponding to a back rest and a second surface corresponding to a seat portion and to be provided with plural control buttons that are attached on the first and second surfaces to enable a user to identify respective parts of a body by finger touch (see for example, Japanese Laid-Open Patent Application Publication No. 2003-310681, pages 3 to 5 and FIGS. 3, 4).

However, the remote control device disclosed in Japanese Laid-Open Patent Application Publication No. Hei. 5-168666 is configured to select the position of the movable massaging element and the operation for controlling the operation of the massaging element is carried out by selectively operating another plural switches. Therefore, the operation is complicated and difficult.

In the remote control device disclosed in Japanese Laid-Open Patent Application Publication No. 2003-310680, the operation position is not determined unless the plural control buttons are sequentially touched from the head, and a user must understand functions of the plural control buttons. So, simple operation is difficult.

In addition, in the remote control device disclosed in Japanese Laid-Open Patent Application Publication No. 2003-310681, since the plural control buttons are provided on the two surfaces, the operation position is roughly selected by the touch, but the user must understand how to operate the respective control buttons. In that case, also, simple operation is difficult. Under the circumstances, there is a need for a remote control device that is capable of being operated visually without mental effort by the user, and a massaging apparatus equipped with such a remote control device.

In addition to the joystick control device disclosed in Japanese Laid-Open Patent Application Publication No. 2004-57465 that is capable of selecting the operation mode like the shift lever, which has been described as the conventional control device, a massaging apparatus, in which a main control device is placed on an arm rest is disclosed (see for example, Japanese Laid-Open Patent Application Publication No. 2004-236709, pages 5 to 6 and FIGS. 1 and 7). This massaging apparatus is equipped with a cylindrical sensor that is configured to be held by one hand and to measure a pulse of a user.

Some massaging apparatuses are equipped with other control devices such as a biological information measurement device adapted to measure biological information such as a pulse, a skin electric resistance, or a skin temperature of a user (see for example, Japanese Laid-Open Patent Application Publication No. 2002-233506, pages 3 to 5 and FIGS. 1 and 9).

The joystick control device disclosed in Japanese Laid-Open Patent Application Publication No. 2004-57465 is typically mounted on an upper surface of one of right and left arm rests. By way of example, the joystick device is attached on the right arm rest, and the user operates the joystick device with a right hand to, for example, select the operation mode.

In some cases, the user may be forced to use an arm which is not a dominant arm to operate the joystick device mounted on one of the right and left arm rests to, for example, select the operation mode. In those cases, the user may have difficulty in operating the joystick device without discomfort.

Some users may have a desire to position the control device on one of the sides where the user is able to easily operate the control device without discomfort, irrespective of the dominant arm. Also, some users may have a desire to position the measurement devices disclosed in Japanese Laid-Open Patent Application Publication No. 2004-236709 and Japanese Laid-Open Patent Application Publication No. 2002-233506 on one of the sides where the user is able to easily operate the measurement device. Under the circumstances, there is a need for a chair-type massaging apparatus that enables a user to operate a control device with a right or left arm with which the control device is easy to operate.

The present invention has been developed under the above mentioned circumstances, and an object of the present invention is to provide a chair-type massaging apparatus that enables a massaging portion to move in a forward and backward direction when a user tilts a control device in the forward and backward direction from the perspective of the user and to enable the user to operate the control device without mental effort.

Another object of the present invention is to provide a massaging apparatus that is configured to move a massaging portion that stimulates a user according to a displacement amount of the control device so that the user does not feel discomfort in operating the control device that may be caused by a delay of an operation of the massaging portion.

Another object of the present invention is to provide a control device that enables a chair-type massaging apparatus to carry out various massage operations in such a manner that a massage operation is selected by selecting a massage operation switch and a massage position or massage intensity which is easily changed using an operation member, and a massaging apparatus equipped with the control device.

Another object of the present invention is to provide a control device that is attached on an arm rest and is able to be stably stored into the interior of the arm rest, and a chair-type massaging apparatus equipped with the control device.

Another object of the present invention is to provide a remote control device that enables the user to control operations of the massaging apparatus visually and without mental effort, and a massaging apparatus equipped with the remote control device.

Another object of the present invention is to provide a chair-type massaging apparatus that enables an arm rest equipped with a control device to be exchangeable between right and left sides so that the user operates the control device with an arm with which the user is able to easily operate the control device.

In order to achieve the above mentioned object, a chair-type massaging apparatus comprises a massaging element that is mounted in a back rest configured to support a back of a user and is configured to be movable to apply stimulation to the back of the user; a control device that includes a grip configured to be operated by the user to be displaceable from a predetermined neutral position and is configured to output a signal indicating an operation of the grip; and a controller configured to, based on the signal from the control device, execute control to move the massaging element in a direction corresponding with a direction in which the grip is operated to move. In such a configuration, since the massaging element moves in the direction corresponding with the direction in which the grip is operated to move (displaced) when the user displaces the grip of the control device from the predetermined neutral position, the user is able to operate the control device without mental effort and without feeling discomfort.

As a matter of course, the direction in which the massaging element moves does not necessarily precisely correspond with the direction in which the grip is operated to move. To be specific, when the user of the chair-type massaging apparatus operates the grip, the massaging element is configured to move in the direction that is substantially recognized by the user as the moving direction of the grip. To be more specific, when the user of the chair-type massaging apparatus operates the grip to move it in the forward and backward direction (or vertical direction), the massaging element is configured to move in the forward and backward direction (or vertical direction) that is recognized as the moving direction of the grip. The same applies to description below.

The massaging element and the grip of the control device may be each configured to be movable in a forward and backward direction, and the controller may be configured to cause the massaging element to move in the forward and backward direction when the grip is operated to move in the forward and backward direction. In such a configuration, since the massaging element moves in the forward and backward direction when the grip is operated to move in the forward and backward direction, the user is able to operate the grip without mental effort.

The controller may be configured to cause the massaging element to move according to a time period for which the grip of the control device is operated to move in the forward and backward direction from the neutral position. In such a configuration, the massaging element is able to be moved forward or backward so as to correspond with the direction in which the grip is operated to move, for a time period when the user is operating the grip. In this manner, the user is able to operate the control device easily and without mental effort to move the massaging element.

The controller may be configured to cause the massaging element to move according to a displacement amount of the grip of the control device that is operated to move in the forward and backward direction from the neutral position. In such a configuration, since the displacement of the control device and displacement of the massaging portion correspond with each other in the direction (forward and backward direction) and the distance (displacement amount), the user is able to operate the control device without mental effort.

The massaging element and the grip of the control device may be each configured to be vertically movable. The controller may be configured to cause the massaging element to move in a vertical direction when the grip is operated to move in the vertical direction. In such a configuration, since the massaging portion moves in the vertical direction when the grip is operated to move in the vertical direction, the user is able to operate the control device without mental effort.

The controller may be configured to cause the massaging element to move according to a time period for which the grip of the control device is operated to move in the vertical direction from the neutral position. In such a configuration, the massaging element is able to be moved upward or backward so as to correspond with the direction in which the grip is operated to move, for a time period when the user is operating the grip. Thus, the user is able to operate the control device easily and without mental effort to move the massaging element.

The controller may be configured to cause the massaging element to move according to a displacement amount of the grip of the control device that is operated to move in the vertical direction from the neutral position. In such a configuration, since the displacement of the grip of the control device and the displacement of the massaging portion correspond with each other in the direction (vertical direction) and the distance (displacement amount), the user is able to operate the control device without mental effort.

In order to achieve the above mentioned object, a massaging apparatus of the present invention comprises a massaging portion that is configured to be movable to apply stimulation to a user; a control device configured to output a signal indicating a displacement amount of the control device from a neutral position; and a controller configured to control an operation of the massaging portion based on the signal from the control device; wherein the controller is configured to cause the massaging portion to move by a displacement amount proportional to a displacement amount of the control device from the neutral position; and wherein a dead zone in which the massaging portion does not operate is set in a predetermined displacement range of the control device so as to include at least one of the neutral position and a maximum displacement position of the control device.

In such a configuration, in a case where the dead zone in which the massaging portion does not operate is set in the neutral position of the control device, a delay of the operation of the massaging portion that may occur, for example, when the control device is operated to move toward the neutral position, can be eliminated, while the control device is operated in the dead zone. Also, in a case where the dead zone is set in a maximum displacement position of the control device, a delay of the operation of the massaging portion that may occur, for example, when the control device is operated to move from the neutral position to the maximum displacement position, can be eliminated, while the control device is operated in the dead zone. As a result, discomfort that may be felt by the user due to the operation delay is reduced.

A massaging apparatus of the present invention comprises a massaging portion that is configured to be movable to apply stimulation to a user; a control device configured to output a signal indicating a displacement amount of the control device from a neutral position; and a controller configured to control an operation of the massaging portion based on the signal from the control device; wherein the controller is configured to cause the massaging portion to move by a displacement amount proportional to a displacement amount of the control device from the neutral position; and wherein the controller is configured to cause the massaging portion to move at a speed according to the maximum displacement speed of the control device during displacement of the control device. In such a configuration, for example, when the control device is displaced from the neutral position and then decreases the displacement speed to stop, the displacement speed of the massaging portion does not substantially decrease even when the displacement speed of the control device is decreasing. As a result, the operation delay can be inhibited.

The controller may be configured to cause the massaging portion to move at a speed varying in a step shape according to a displacement speed of the control device.

A massaging apparatus of the present invention comprises a massaging portion that is configured to be movable to apply stimulation to a user; a control device configured to output a signal indicating a displacement amount of the control device from a neutral position; and a controller configured to control an operation of the massaging portion based on the signal from the control device; wherein the controller is configured to cause the massaging portion to move by a displacement amount proportional to the displacement amount of the control device from the neutral position; and wherein the controller is configured to cause the massaging portion to increase its speed when a difference value between a target position of the massaging portion that corresponds to displacement of the control device and a current position of the massaging portion meets or exceeds a threshold. In such a configuration, when a delay distance corresponding to a difference between the current position and the target position of the massaging portion meets or exceeds a threshold, it can be reduced.

A massaging apparatus of the present invention comprises a massaging portion that is configured to be movable to apply stimulation to a user; a control device configured to output a signal indicating a displacement amount of the control device from a neutral position; and a controller configured to control an operation of the massaging portion based on the signal from the control device; wherein the controller is configured to cause the massaging portion to move by a displacement amount proportional to the displacement amount of the control device from the neutral position; and wherein the controller is configured to, when a displacement speed of the control device increases, set an acceleration to enable the massaging portion to reach a target displacement speed after the increase in the displacement speed of the control device, using, as a gain, the displacement speed of the control device or the massaging portion before the increase. In such a configuration, when the displacement speed of the control device is changed, the displacement speed of the massaging portion can be gradually increased based on the displacement speed of the control device or the massaging portion before the increase in the displacement speed of the control device without causing the user to feel great change.

A massaging apparatus of the present invention comprises a massaging portion that is configured to be movable to apply stimulation to a user; a control device configured to output a signal indicating a displacement amount of the control device from a neutral position; and a controller configured to control an operation of the massaging portion based on the signal from the control device; wherein the controller is configured to cause the massaging portion to move by a displacement amount proportional to the displacement amount of the control device from the neutral position; and wherein the controller is configured to, when a displacement speed of the control device increases, set an acceleration to enable the massaging portion to reach a target displacement speed after the increase in the displacement speed of the control device, using, as a gain, a difference value between displacement speeds of the control device or a difference value between target displacement speeds of the massaging portion before and after the increase in the displacement speed of the control device. In such a configuration, when the displacement speed of the control device is changed, the displacement speed of the massaging portion can be gradually increased based on the difference value between the displacement speeds of the control device or the difference value between the target displacement speeds of the massaging portion before and after the increase in the displacement speed.

A massaging apparatus of the present invention comprises a massaging portion that is configured to be movable to apply stimulation to a user; a control device configured to output a signal indicating a displacement amount of the control device from a neutral position; and a controller configured to control an operation of the massaging portion based on the signal from the control device; wherein the controller is configured to cause the massaging portion to move by a displacement amount proportional to the displacement amount of the control device from the neutral position, and to cause the massaging portion to stop when a displacement direction of the control device is changed. In such a configuration, after the displacement direction of the control device is changed, it is possible to inhibit the massaging portion from being displaced in the displacement direction of the control device before the change which is caused by the operation delay of the massaging portion. So, the user is able to operate the control device without feeling discomfort.

A massaging apparatus of the present invention comprises a massaging portion that is configured to be movable to apply stimulation to a user; a control device configured to output a signal indicating a displacement amount of the control device from a neutral position; and a controller configured to control an operation of the massaging portion based on the signal from the control device; wherein the controller is configured to output a control signal to the massaging portion to cause the massaging portion to move by a displacement amount proportional to the displacement amount of the control device from the neutral position; wherein the massaging portion includes a motor configured to be driven based on the control signal from the controller; and wherein a PWM signal including pulse signals with a duty ratio that is able to at least start-up the motor is input to the motor, and a pulse string signal including one or a plurality of pulse signals is input to the motor at predetermined time intervals, when a displacement speed of the control device is a predetermined low speed or less.

For instance, when the control device is being displaced at a very low speed of a predetermined speed or lower, the massaging portion reaches its target displacement speed during the displacement of the control device if the PWM signal required to generate at least a start-up torque of the motor is output continuously to the motor configured to drive the massaging portion. So, the controller stops the motor. Because the control device is still being displaced, a difference between a stop position and a target position of the massaging portion occurs after a while. So, the massaging portion re-starts moving, and thus operates intermittently, causing the user to feel discomfort. Since the PWM signal required to generate at least the start-up torque of the motor is output with a predetermined duty ratio to the motor as described above, it is possible to inhibit stoppage of the motor during the displacement of the control device, and to inhibit the intermittent operation of the massaging portion.

The massaging portion may be mounted in a back rest configured to support a back of a user. The massaging portion and the control device may be each movable in a forward and backward direction. The controller may be configured to control an operation of the massaging portion such that a displacement direction of the control device corresponds with a displacement direction of the massaging portion. In such a configuration, since the displacement direction of the control device corresponds with the displacement direction of the massaging portion, the user is able to operate the control device more easily.

The control device may be configured to be able to hold a position of the control device that has been displaced from the neutral position, in a non-operating state. In such a configuration, the user need not continue to hold the control device at the predetermined position during a time period that elapses from when the control device being displaced by the user's operation is stopped until the massaging portion reaches the target position corresponding to the stop position. Thus, the user is able to operate the control device easily.

In order to achieve the above mentioned object, a control device of a chair-type massaging apparatus of the present invention, including a massaging system that is equipped in a back rest and is provided with a massaging element configured to massage a back of a user, and the control device comprises an operation member configured to be able to control movement of the massaging system; and a plurality of massage operation switches with which a massage operation of the massaging element is able to be selected; wherein the control device is configured to move the massaging system according to an operation of the operation member in addition to the massage operation selected with the massage operation switch. Thus, in the chair-type massaging apparatus, the user is able to accomplish a desired massage operation by combining selection of the massage operation switches and operation of the operation member.

The operation member may include a grip configured to be gripped by a user. The grip may be equipped with a reclining operation switch of the chair-type massaging apparatus. Thereby, a reclining operation is easily performed only by using the operation member.

The control device may further comprise a storage device configured to store an operation history of the operation member and the massage operation switch. Thereby, later, the massage operation according to the user's preference is easily reproduced.

A chair-type massaging apparatus of the present invention comprises the above mentioned control device that is mounted in an arm rest; and a controller configured to execute control to cause a massage operation to be performed according to an operation of the control device. In accordance with this chair-type massaging apparatus, the massage is carried out according to the user's preference by the operation of the massage operation switch and the operation of the operation member.

In order to achieve the above mentioned object, a control device of a chair-type massaging apparatus of the present invention comprises a back rest including a massaging system provided with a massaging element configured to massage a back of a user, and an arm rest; wherein the control device is configured to be mountable on the arm rest and to be stored into a storage portion provided in the arm rest; and wherein the control device is configured to be stored into the storage portion by a storing operation, and the control device stored into the storage portion is configured to be placed into an operation position by a placing operation. Thereby, the control device mounted on the arm rest is stored into the interior of the arm rest when it is not used, while the control device is placed into the operation position during use and is stably operated.

The control device may further comprise a lid member that is attached to a region of the arm rest where the control device is located and is configured to cover an upper region of the control device to form an upper surface of the arm rest with the control device stored into the storage portion. Thereby, the upper surface of the arm rest is made flat with the control device stored into the arm rest.

The control device may further comprise a shutter mounted in an opening that is formed in an upper region of the arm rest to allow the control device to move into and out of an interior of the arm rest, the shutter being configured to be opened and closed when the control device moves out of and into the interior of the arm rest. This makes it possible to inhibit unwanted substances from entering into the arm rest through the opening.

The control device may further comprise an open system configured to start the placing operation of the control device, by the user's operation of opening the lid member attached on the arm rest. Thereby, only by opening the lid member, is the control device placed into the operation position.

The control device may further comprise a storing system configured to start a storing operation by the user's operation of closing the lid member attached on the arm rest. Thereby, only by closing the lid member, is the control device stored.

The control device may further comprise a drive device configured to place the control device stored into an interior of the arm rest into the operation position and an air drive device. In such a configuration, the control device is stored and placed into the operation position slowly by using the air.

In order to achieve the above mentioned object, a chair-type massaging apparatus of the present invention comprises the above mentioned control device that is mounted on an arm rest and a detecting device configured to detect a storage state and a placement state of the control device. In accordance with this chair-type massaging apparatus, the storage state and the placement state of the control device mounted on the arm rest are detected, and the operation of the control device is selected.

In order to achieve the above mentioned object, a remote control device for a chair-type massaging apparatus of the present invention comprises a massage position control portion at which selection buttons are arranged in a side view shape of a user seated in the chair-type massaging apparatus, the selection buttons being configured to be operated to select massage positions of a massaging element mounted in a back rest and massage positions of air bags mounted in a foot rest and a seat portion. Since the user is able to see and easily find a part to be massaged and to press the selection button corresponding to that part, a desired part can be easily massaged intensively. In addition, since the selection buttons are arranged in the side-view shape of the user, the operation position is checked by the user's touch. Thus, the desired part to be massaged is selected visually and by the touch.

The remote control device for a chair-type massaging apparatus may further comprise a position control portion at which control buttons are arranged in a side view shape of the chair-type massaging apparatus, the control buttons being configured to be operated to control an angle of the back rest, and an angle and a position of the foot rest. So, the user is able to see and easily find control buttons of the angle of the back rest or the angle and position of the foot rest and to press the control buttons. Thus, the user is able to easily operate the control buttons.

The selection buttons with which the massage position of the massaging element in the back rest is selected and the massage positions of the air bags in the foot rest and the seat portion are selected may be configured to be combined to enable massage including a combination of massage of the massaging element and massage of the air bag to be selectively carried out. In such a configuration, the massage is selectively carried out according to the user's preference. The user is able to see and easily find the massage part of the back rest and the massage parts of the foot rest and the seat portion.

A chair-type massaging apparatus including a back rest, a seat portion, and a foot rest of the present invention, comprises any of the above mentioned remote control devices for a chair-type massaging apparatus, wherein the remote control device is configured to select a massage operation of a massaging element mounted in the back rest and air bags mounted in the foot rest and the seat portion. In accordance with this chair-type massaging apparatus, the user is able to see and easily select the massage position and the massage operation. So, even users who are unfamiliar with the operation of the chair-type massaging apparatus are able to easily massage a desired part to be massaged.

In order to achieve the above mentioned object, a chair-type massaging apparatus of the present invention that is equipped with arm rests on right and left sides of a base, comprise a control device mounted on one of the arm rests, wherein the arm rest on which the control device is mounted and an opposite arm rest are configured to be removably mounted to be exchangeable; and the massaging apparatus may further comprise a transmission device that is mounted between the arm rest on which the control device is mounted and the base, and is configured to allow a signal to be transmitted therethrough between the control device and the base. Thereby, the arm rest on which the control device is mounted and the opposite arm rest are exchangeable so that the control device is positioned on the arm side where the user easily operates the control device.

The control device mounted on one of the arm rests may be a massage control device configured to control a massage operation of a massaging system equipped in the massaging apparatus. Thereby, the control device is positioned on the arm side where the user easily operates the control device.

The massage control device may be configured to be stored into an interior of the arm rest, and the massaging apparatus may further comprise a drive device that is mounted in the interior of the arm rest and is configured to place the massage control device stored in the interior of the arm rest into a predetermined position; and a connecting device that is removably mounted between the arm rest and the base to allow a drive force of the drive device to be supplied therethrough from the base to the arm rest. By mounting the connecting device, the drive device to place the massage control device storable into the interior of the arm rest into the predetermined position is easily removably mountable to the base along with the arm rest.

The control device mounted on one of the arm rests may be a measurement device configured to measure biological information of a user to be massaged by the massaging apparatus. Thereby, the measurement device is easily positioned on the arm side where the user easily measures the biological information such as a pulse wave of the user.

The chair-type massaging apparatus may further comprise a controller configured to detect a connecting state of the transmission device, and to cause a remote control device of the chair-type massaging apparatus to display the detected connecting state. Thereby, the user is able to easily check the connecting state of the arm rest equipped with the control device and the base by using the remote control device.

The above and further objects and features of the invention will more fully be apparent from the following detailed description with accompanying drawings.

### EFFECTS OF THE INVENTION

In accordance with the present invention, it is possible to provide a chair-type massaging apparatus, a massaging apparatus, a control device of the chair-type massaging apparatus, and a remote control device for the chair-type massaging apparatus, which are user friendly.

To be specific, it is possible to provide a massaging apparatus that is configured to move a massaging portion that stimulates a user according to a displacement amount of the control device so that the user does not feel discomfort in operating the control device that may be caused by a delay of an operation of the massaging portion.

It is possible to provide a control device that enables a chair-type massaging apparatus to carry out various massage operations in such a manner that a massage operation is selected by selecting a massage operation switch and a massage position or massage intensity is easily changed using an operation member, and a massaging apparatus equipped with the control device.

It is possible to provide a control device that is attached on an arm rest and is able to be stably stored into the interior of the arm rest, and a chair-type massaging apparatus equipped with the control device.

It is possible to provide a remote control device that enables the user to control operations of the massaging apparatus visually and without mental effort, and a massaging apparatus equipped with the remote control device.

It is possible to provide a chair-type massaging apparatus that enables an arm rest equipped with a control device to be exchangeable between right and left sides so that the user operates the control device with an arm with which the user is able to easily operate the control device.

### BRIEF DESCRIPTION OF THE DRAWINGS

FIG. 1 is a perspective view showing an external appearance of a chair-type massaging apparatus according to an embodiment of the present invention;

FIG. 2 is a rear view showing a construction of a massaging system and a moving device that are equipped in the chair-type massaging apparatus of FIG. 1;

FIG. 3 is an exploded perspective view schematically showing a construction of a massaging system of FIG. 2 to explain an operation principle of the massaging system of FIG. 2;

FIG. 4 is a functional block diagram showing the construction of the chair-type massaging apparatus of FIG. 1;

FIG. 5 is a perspective view showing a construction of a joint system of a base and a rod of a control device equipped in the chair-type massaging apparatus of FIG. 1 as viewed from rightward and backward, a part of which is omitted;

FIG. 6 is a perspective view showing the construction of the joint system of FIG. 5, as viewed from leftward and backward;

FIG. 7 is a perspective view showing a construction of a grip of the control device of FIG. 1 and the rod in the interior of the grip;

FIG. 8 is a functional block diagram showing a construction of the control device of FIG. 1;

FIG. 9 is a flowchart showing an operation of the massaging system equipped in the chair-type massaging apparatus that is performed when the grip of the control device is tilted in a forward and backward direction;

FIG. 10 is a flowchart showing another operation of the massaging system equipped in the chair-type massaging apparatus that is performed when the grip of the control device is tilted in the forward and backward direction;

FIG. 11 is a flowchart showing an operation of the massaging system equipped in the chair-type massaging apparatus that is performed when the grip of the control device is operated to move in a vertical direction;

FIG. 12 is a perspective view showing another construction of the joint system of the control device equipped in the chair-type massaging apparatus of FIG. 1 as viewed from rightward and backward, a part of which is omitted;

FIG. 13 is a perspective view showing an external construction of a control device which is different from that of the control device shown in FIGS. 5 to 8;

FIGS. 14(a) and 14(b) are cross-sectional views of the grip included in the control device of FIG. 13, which is taken in the direction of an arrow XIV of FIG. 13, showing a construction of a handle, in which FIG. 14(a) shows an open configuration of the handle and FIG. 14(b) shows a closed configuration of the handle;

FIG. 15 is a side view showing an operation of the massaging system of FIG. 2, which is pivoted in the forward and backward direction;

FIG. 16 is a functional block diagram of the chair-type massaging apparatus of FIG. 1 according to a second embodiment;

FIG. 17 is a graph showing a positional relationship between a lever and the massaging system equipped in the chair-type massaging apparatus of FIG. 1;

FIG. 18 is a graph showing a control process for controlling the operation of the massaging system in the forward and backward direction according to an example 1;

FIGS. 19(a) and 19(b) are graphs showing a control process for controlling the operation of the massaging system in the forward and backward direction according to an example 2, in which FIG. 19(a) shows a position of the lever being displaced and FIG. 19(b) shows a corresponding target displacement speed of the massaging system in the forward and backward direction, with respect to a time axis;

FIGS. 20(a) and 20(b) are graphs showing a control process for controlling the operation of the massaging system in the forward and backward direction according to an example 3, in which FIG. 20(a) shows a time lapse variation in a target position of the massaging system in the forward and backward direction with respect to the position of the lever by a solid line and an actual time lapse variation in the position of the massaging system by a dashed line, and FIG. 20(b) shows a time lapse variation in a corresponding displacement speed of the massaging system;

FIGS. 21(a) and 21(b) are graphs showing a control process for controlling the operation of the massaging system in the forward and backward direction according to an example 4, in which FIG. 21(a) shows a position of the lever being displaced and FIG. 21(b) shows a corresponding target displacement speed of the massaging system in the forward and backward direction, with respect to the time axis;

FIGS. 22(a) and 22(b) are graphs showing a control process for controlling the operation of the massaging system in the forward and backward direction according to an example 5, in which FIG. 22(a) shows a displacement of the lever and FIG. 21(b) shows a corresponding target displacement speed of the massaging system in the forward and backward direction, with respect to the time axis;

FIGS. 23(a) and 23(b) are graphs showing a time lapse variation in the displacement speed of the lever and a PWN signal input to a motor for driving the massaging system, in which FIG. 23(a) shows that the lever is displaced at a low speed, and FIG. 23(b) shows that the lever is displaced at a very low speed;

FIG. 24 is a perspective view showing a construction of an entire chair-type massaging apparatus according to a third embodiment of the present invention;

FIG. 25 is a side view schematically showing a moving state of a massaging system of the chair-type massaging apparatus of FIG. 24;

FIGS. 26(a) and 26(b) are views showing a joystick which is an example of an operation member of the control device of the chair-type massaging apparatus of FIG. 24, in which FIG. 26(a) is a perspective view from the back side and FIG. 26(b) is a front view;

FIG. 27 is a longitudinal sectional view schematically showing an internal mechanism of the joystick of FIG. 26;

FIG. 28 is a plan view showing a control device of the chair-type massaging apparatus according to the third embodiment;

FIG. 29 is a block diagram of a control circuit including a control circuit of the control device of FIG. 28 and a control circuit of a remote control device of the chair-type massaging apparatus of FIG. 28;

FIG. 30 is a view showing an example of the operation of the control device of the chair-type massaging apparatus of FIG. 28;

FIGS. 31(a) and 31(b) are views showing another example of the operation of the control device of the chair-type massaging apparatus of FIG. 28;

FIG. 32 is a perspective view showing a construction of an entire chair-type massaging apparatus according to a fourth embodiment of the present invention;

FIG. 33 is a longitudinal sectional view schematically showing an internal mechanism of the joystick of FIG. 32;

FIG. 34 is a cross-sectional view showing the interior of an arm rest with the joystick control device of the chair-type massaging apparatus of FIG. 32 placed in an operation position;

FIG. 35 is a cross-sectional view showing the interior of the arm rest with the joystick control device of the chair-type massaging apparatus of FIG. 32 stored therein;

FIG. 36 is a perspective view of the arm rest, showing an open system configured to open a lid member attached on an upper portion of the joystick control device of the chair-type massaging apparatus of FIG. 32;

FIGS. 37(a) to 37(d) are perspective views showing a progression of how the lid member is opened by the open system of FIG. 36 and how the joystick control device is placed in the operation position;

FIG. 38 is a front view showing a construction of an entire remote control device of the chair-type massaging apparatus according to a fifth embodiment of the present invention;

FIGS. 39(a) and 39(b) are views showing the remote control device of the chair-type massaging apparatus of FIG. 38, in which FIG. 39(a) is a side view and FIG. 39(b) is a cross-sectional view along B-B;

FIG. 40 is a perspective view showing a construction of an entire chair-type massaging apparatus according to a sixth embodiment of the present invention;

FIG. 41 is a plan view of the chair-type massaging apparatus of FIG. 40;

FIG. 42 is a side view of an arm rest equipped with the joystick control device of FIG. 40;

FIG. 43 is a side view of the arm rest equipped with a pulse wave measurement device of FIG. 40;

FIG. 44 is a partial perspective view showing a region of the arm rest on which the pulse wave measurement device is mounted;

FIG. 45 is a perspective view showing another construction of the interior of the arm rest into which the joystick control device is stored;

FIGS. 46(a) to 46(c) are views showing an operation of a storing system that takes place when the joystick is stored into the arm rest, wherein FIG. 46(a) shows a state in which the joystick is placed in the operation position with the lid member being in a fully open position, FIG. 46(b) shows a state in which the lid member is closed to a position, and FIG. 46(c) shows a state in which the joystick is stored into the arm rest with the lid member being in a fully closed position;

FIG. 47 is a perspective view showing a construction of a shutter that is applicable to an opening through which the joystick moves into and out of the interior of the arm rest, and a state in which the shutter is closed; and

FIG. 48 is a perspective view showing a state in which the shutter of FIG. 47 is opened.

### EXPLANATION OF REFERENCE NUMERALS

1 chair-type massaging apparatus
3 back rest
5 arm rest
200 massaging system
200a moving device
7, 7a, 300 control device
8 control device
10 massaging element (massaging portion)
11, 12, 214, 226 motor
40 controller
28 up-down base
29a guide rail
70 base
71 rod
72 grip
73, 73b joint system
77a, 77b spring hook
77c spring
81 rotary damper (damping portion)
81a rotary damper (holding portion)
83 rotary switch
200a moving device
200b up-down mechanism
200c pivot mechanism

### BEST MODE FOR CARRYING OUT THE INVENTION

Hereinafter, embodiments of the present invention will be described with reference to the drawings.

### First Embodiment

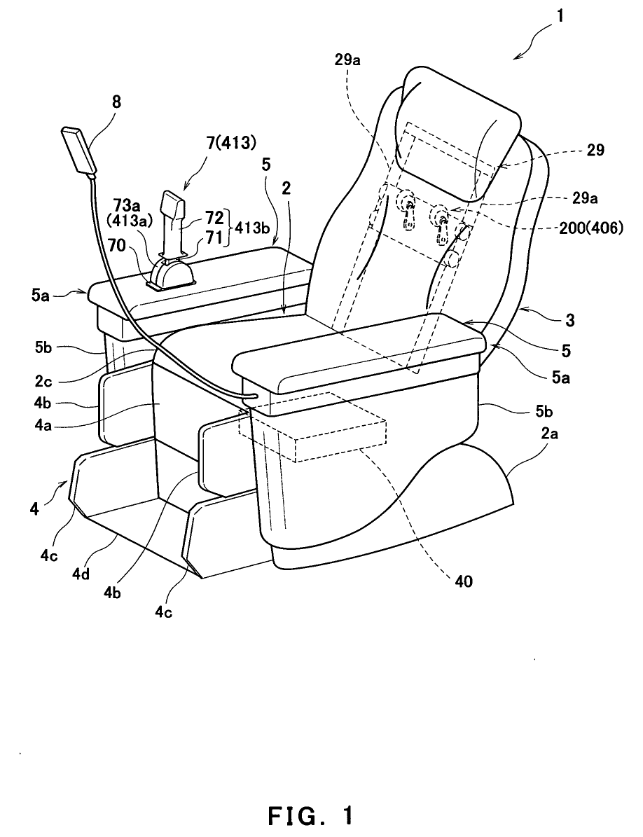

FIG. 1 is a perspective view showing a construction of an entire chair-type massaging apparatus according to embodiments of the present invention. A chair-type massaging apparatus 1 mainly comprises a seat portion 2, a back rest 3, a foot rest 4 and arm rests 5. The seat portion 2 is constructed such that a cushion portion 2c whose upper surface is substantially flat for use as a seat surface is disposed on an upper region of a base (not shown) having leg portions 2a on both sides under the base (left leg portion 2a is illustrated in FIG. 1). The cushion portion 2c is formed in such a manner that an internal material (not shown) such as urethane foam, sponge, or foamed polystyrene is provided over an upper surface of the base and is covered with an outer material (cover) formed of a raised-fiber tricot made of polyester, artificial leather, or natural leather, etc.

The foot rest 4 is pivotally attached at an upper end thereof to a front side of an upper region of the seat portion 2 to massage ankles and calves of the legs of the user by inflowing and outflowing air to and from an air bag (not shown). Thereby, the foot rest 4 is pivotable forward and backward around the upper end thereof. As used herein, the term “directions” in the first embodiment correspond with the directions from the perspective of the user (not shown) seated in the seat portion 2 of the chair-type massaging apparatus 1, except for a case specifically illustrated.

The foot rest 4 includes a flat lower thigh support surface 4a extending downward from a front end of the seat portion 2 in FIG. 1, side walls 4b and 4c protruding forward from both sides of the lower support surface 4a, and a sole support wall 4d protruding forward from a lower end of the lower thigh support surface 4a, i.e., an end of the lower thigh support surface 4a that is most distant from the seat portion 2. In FIG. 1, the foot rest 4 that is pivotable forward and backward is illustrated as being backward.

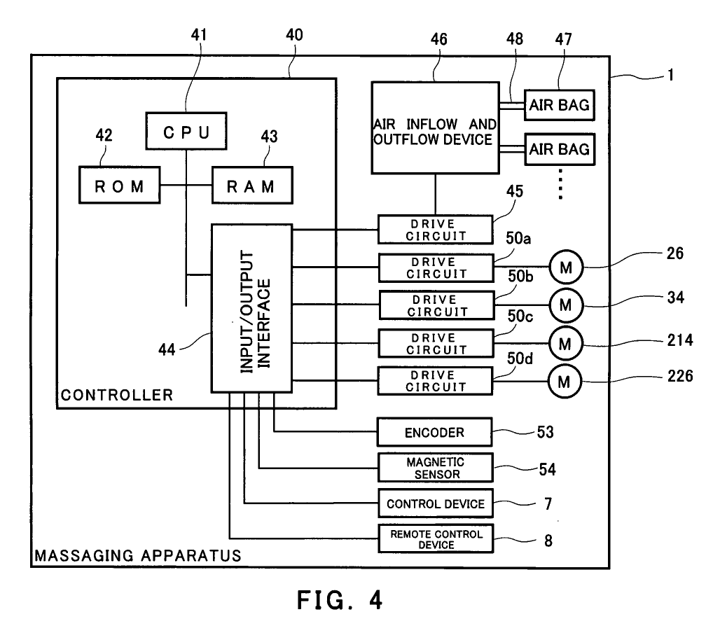

Air bags 47 (see FIG. 4) are mounted inside the side walls 4b and 4c, and are coupled through air hoses 48 (see FIG. 4) to an air inflow and outflow device 46 including a pump, a valve, and other components which are built into the seat portion 2 or the back rest 3. The air bags 47 are expandable or contractable by air inflow and outflow by the air inflow and outflow device 46. With the user seated in the seat portion 2, the air bags 47 are expanded and contracted repeatedly, thus applying pressing stimulation to outer regions of the lower thighs, side and upper regions of feet.

The lower support wall 4a supports the lower thighs of the user in contact with them with the user seated in the chair-type massaging apparatus 1. The air bags 47 (see FIG. 4) are mounted at plural positions of the lower thigh support surface 4a and are coupled to the air inflow and outflow device 46 through the air hoses 48. The air bags 47 are expanded and contracted repeatedly, thus applying pressing stimulation to the calves and regions near Achilles' tendon of the user.

The sole support wall 4d supports the soles of the user in contact with them with the user seated in the chair-type massaging apparatus 1. A vibrator and the air bags 47 (see FIG. 4) are mounted inside the sole support wall 4d. The air bags 47 are coupled to the air inflow and outflow device 46 through the air hoses 48. The vibrator is constructed such that an eccentric mass is attached to an output shaft of a DC motor and is configured to be driven to generate small vibration. The air bags 47 are expanded and contracted repeatedly, thus applying pressing stimulation to the soles of the user. In addition, the vibrator operates to apply vibrational stimulation to the soles of the user.

The plurality of air bags 47 are further mounted on a back side of the seat surface of the seat portion 2. These air bags 47 are also coupled to the air inflow and outflow device 46 through the air hoses 48 and are configured to be expanded and contracted by air inflow and outflow by the air inflow and outflow device 47. A vibrator (not shown) which is similar to that described above is mounted on the back side of the center of the seat surface of the seat portion 2. With such a construction, the air bags 47 are expanded and contracted repeatedly to apply pressing stimulation to a hip of the user, and the vibrator is driven to apply vibrational stimulation to an anus region of the user, with the user seated on the seat portion 2.

The back rest 3 is located at a rear region of the seat portion 2. The back rest 3 is sized so that an adult with a standard constitution is seated on the seat portion 2 of the chair-type massaging apparatus 1 so as not to protrude outward therefrom and is shaped to be substantially rectangular as viewed from front, in order to support an upper half body of the user. The back rest 3 is pivotally mounted at a lower end portion thereof to the rear region of the seat portion 2 by a pivot (not shown) extending in a rightward and leftward direction and is rotatable around the pivot to enable reclining forward and backward. The arm rests 5 are respectively mounted on both sides of the back rest 103 and are fixedly supported on the base of the seat portion 2. The arm rests 5 extend forward from both sides of the back rest 3. A control device 7 described later is coupled to a controller 40 (see FIG. 4) built into the chair-type massaging apparatus 1 and is mounted on the right arm rest 5. The chair-type massaging apparatus 1 includes a remote control device 8 coupled to the controller 40, separately from the control device 7 coupled to the controller 40.

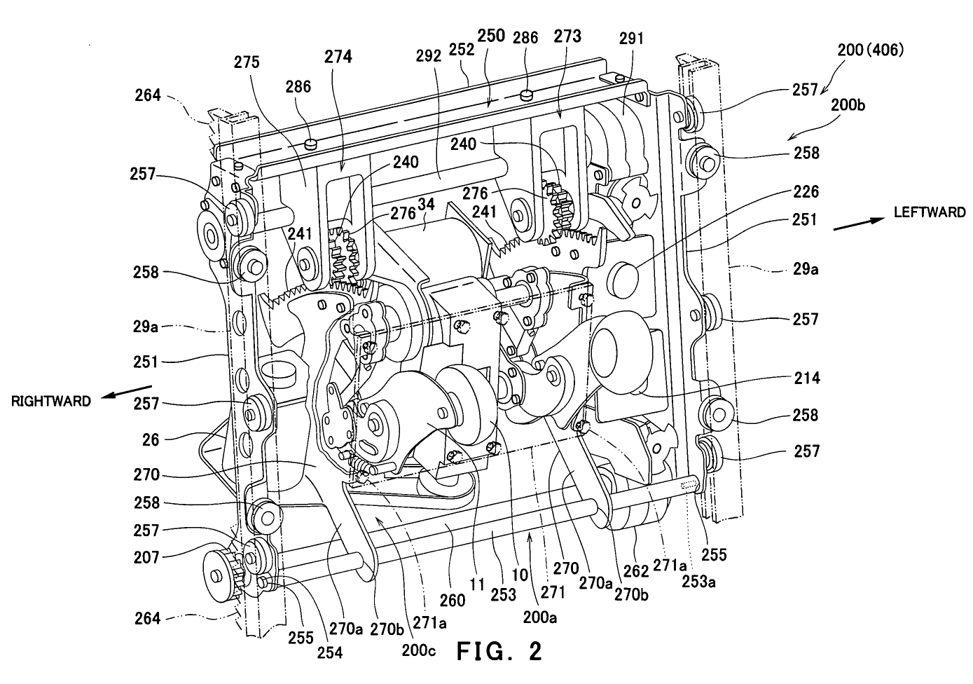

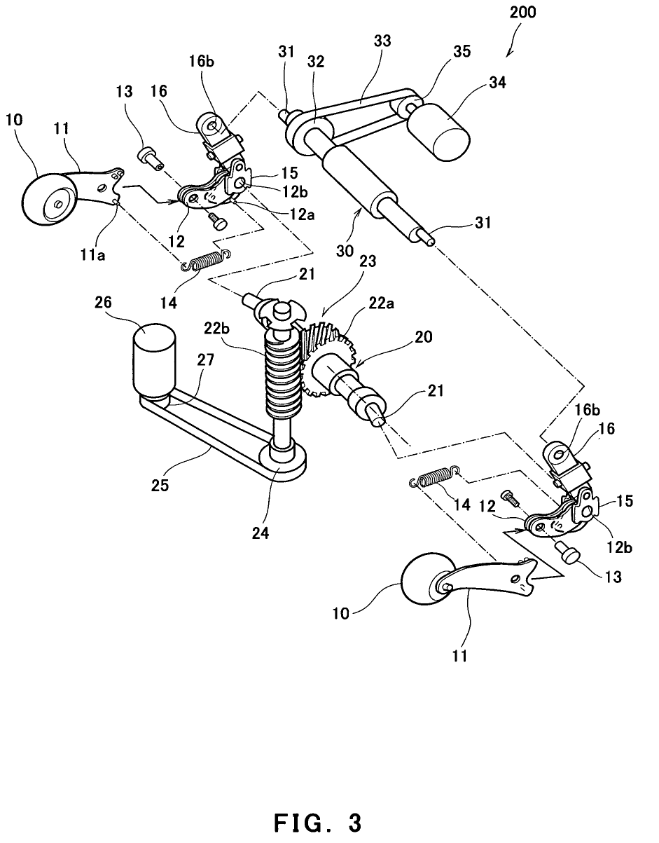

A massaging system 200 is mounted in the interior of the back rest 3 and is configured to apply stimulation to the back of the user seated. The massaging system 200 is mounted to a moving device 200a configured to move the massaging system 200. As described later in detail, the moving device 200a enables the massaging system 200 to move up and down along up-down frames 29 mounted in the interior of the back rest 3 and to move forward and backward in the direction to cross a back rest surface (front surface) of the back rest 3. FIG. 2 is a rear view showing a construction of the massaging system 200 and the moving device 200a and FIG. 3 is an exploded perspective view schematically showing a construction of the massaging system 200 to explain an operation principle of a kneading operation and a tapping operation which are performed by the massaging system 200. First, the operation principle of the massaging system 200 will be described with reference to FIG. 3. As shown in FIG. 3, the massaging system 200 includes two roller-shaped massaging elements 10 on right and left sides to apply mechanical stimulation to the body of the user. The massaging elements 10 are respectively coupled to tip ends of right and left arms 11 extending forward.

Each arm 11 is coupled at a base portion to one end portion of a kneading connecting rod 12 to be pivotable around a support shaft 13. A spring 14 is mounted between each arm 11 and each kneading connecting rod 12 and is configured to engage with engagement portions 11a and 12a protruding from inner surfaces of the arm 11 and the connecting rod 12. The spring 14 causes the arm 11 to be pivoted downward around the support shaft 13.

An opposite end portion of each kneading connecting rod 12 is coupled to one end portion of a tapping connecting rod 16 through a coupling member 15. As described later, the kneading connecting rod 12 operates three-dimensionally, specifically, upward and downward, rightward and leftward, and forward and backward, to cause the massaging element 10 to perform the kneading operation, and the tapping connecting rod 16 operates two-dimensionally, specifically, upward and downward and forward and backward to cause the massaging element 10 to perform the tapping operation. The coupling member 15 has a flexible coupling structure to enable the kneading connecting rod 12 and the tapping connecting rod 16 to be coupled to each other, allowing respective operations. In the massaging system 200 of this embodiment, the coupling structure is a ball joint.

A kneading shaft 20 is provided between the right and left kneading connecting rods 12 to extend in the rightward and leftward direction. Tilted shaft portions 21 are provided at right and left end portions of the kneading shaft 20 in such a manner that they are tilted at a predetermined angle in the same direction with respect to a center axis of the kneading shaft 20. A fitting hole 12b is formed on a coupling portion configured to couple the kneading connecting rod 12 to the coupling member 15 and is configured to open toward the center in the rightward and leftward direction. Each tilted shaft portion 21 of the kneading shaft 20 is rotatably fitted into the fitting hole 12b by a bearing (not shown).

A helical gear 22a is coaxially mounted on a center region in the rightward and leftward direction of the kneading shaft 20. The helical gear 22a is in mesh with a worm 22b having a vertical rotational axis. Thus, the helical gear 22 and the worm 22b form a worm gear mechanism 23. A pulley 24 is coaxially mounted on a lower end portion of the worm 22b. The pulley 24 is coupled, through a belt 25, to a pulley 27 mounted to an output shaft of a kneading motor 26 such as a servo motor.

The rotation of the output shaft of the motor 26 is transmitted to the worm 22b through the belt 25. According to the rotation of the worm 22b, the kneading shaft 20 rotates. According to the rotation of the kneading shaft 20, the tilted shaft 21 is displaced to draw a conical track, causing the connecting rod 12 to operate regularly. As a result, the right and left massaging elements 10 move three-dimensionally, specifically, upward and downward, rightward and leftward, and forward and backward. This movement is the kneading operation of the massaging element 10.

A tapping shaft 30 is provided between right and left tapping rods 16 at a location above the kneading shaft 20. The tapping shaft 30 is provided with eccentric shaft portions 31 at right and left ends thereof. Each eccentric shaft portion 31 has an axis parallel to the axis of the tapping shaft 30. The eccentric shaft portions 31 are configured such that their phases are shifted 180 degrees from each other. A fitting hole 16b is formed on an opposite end portion of the tapping connecting rod 16, i.e., an end portion of the tapping connecting rod 16 to which the coupling member 15 is not coupled and is configured to open toward the center in the rightward and leftward direction. Each of the eccentric shaft portions 31 provided on both ends of the tapping shaft 30 is rotatably inserted into the fitting hole 16b by a bearing (not shown). A pulley 32 is coaxially attached to a right region of the tapping shaft 30. The pulley 32 is coupled, through a belt 33, to a pulley 35 attached to an output shaft of a tapping motor 34 such as a servo motor or the like.

The rotation of the output shaft of the motor 34 is transmitted to the tapping shaft 30 through the belt 33, causing the eccentric shaft portions 31 at both ends of the tapping shaft 30 to rotate. Thereby, the connecting rod 16 operates two-dimensionally, specifically, upward and downward and forward and backward. This operation is transmitted to the arm 11 through the coupling member 15. As a result, the massaging element 10 moves. The movement of the massaging element 10 is the tapping operation.

The massaging system 200 constructed above is mounted on the moving device 200a. The moving device 200a includes an up-down mechanism 200b and a pivot mechanism 200c. The massaging system 200 is driven by the up-down mechanism 200b to move up and down in the interior of the back rest 3 (see FIG. 1) in the vertical direction along the back rest 3 and is driven by the pivot mechanism 200c to pivot forward and backward in the interior of the back rest 3. Hereinbelow, the up-down mechanism 200b and the pivot mechanism 200c equipped in the moving device 200a of the massaging apparatus 1 will be described.

As shown in FIG. 2, the up-down mechanism 200b includes an up-down frame body 250 comprised of right and left side frames 251 formed of plates, an upper frame 252 that is provided between upper regions of the side frames 251 so as to support them and is formed of a plate, and a lower frame (pivot shaft) 253 that is provided between lower regions of the side frames 251 so as to support them and is formed of a round rod pole.

A penetrating hole 255 is formed in the lower region of each side frame 251 to extend in the rightward and leftward direction to allow a threaded member 254 to penetrate therethrough. A threaded hole 253a into which the threaded member 254 is threaded is formed on each of both ends of the lower frame 253 formed of the round-rod pole and is configured to open outward in the rightward and leftward direction.

The lower frame 253 is fixed to the side frames 251 in such a manner that the threaded holes 253a are caused to conform to the penetrating holes 255 of the side frames 251 from inward and the threaded members 254 are threaded into the penetrating holes 255 and the threaded holes 253a from outward. Conversely, by removing the right and left threaded members 254, the lower frame 253 is easily detachable from the side frames 251.

Guide rollers 257 and 258 are rotatably attached to the right and left side frames 251. The guide rollers 257 and 258 are able to roll along the guide rails 29a that are mounted in the interior of the back rest 3 of the massaging apparatus 1 and are adapted to form the-up-down frame 29. In more detail, the up-down frame 29 mounted in the interior of the back rest 3 is of a longitudinally elongated rectangle shape as viewed from front and includes the right and left guide rails 29a extending vertically in parallel with each other. Each guide rail 29a has a channel-shaped cross-section extending to cross the longitudinal direction and is configured to open toward the center in the rightward and leftward direction.

The guide rollers 257 have rotational axes extending in the rightward and leftward direction and are mounted on an upper region, an intermediate region, and a lower region of each side frame 251. The guide rollers 257 are configured to roll on an inner wall of each guide rail 29a to restrict the movement in the forward and backward direction of the up-down frame body 250. The guide rollers 258 have rotational axes extending in the forward and backward direction and are each located between guide rollers 257 adjacent in the vertical direction. The guide rollers 258 are configured to roll on the inner wall of each guide rail 29a to restrict the movement in the rightward and leftward direction of the up-down frame 250.

An up-down drive shaft 260 is rotatably attached between lower regions of the right and left side frames 251. Up-down pinions 207 are attached on both ends of the up-down drive shaft 260 and on outer sides of the side frames 251. A reduction gear 262 and an up-down motor 214 are mounted to a left lower region of the up-down frame body 250. The up-down drive shaft 260 is driven to rotate by a drive force transmitted from the up-down motor 214 through the reduction gear 262. An up-down rack 264 provided with a plurality of teeth aligned along the guide rail 29a is mounted on a rear region of each guide rail 29a. The up-down pinion 207 is configured to mesh with the up-down rack 264.

When the up-down drive shaft 260 is driven to rotate by the up-down motor 214, the up-down pinions 207 roll in the vertical direction along the up-down racks 264. In this case, the guide rollers 257 and 258 rolling along the inner walls of the guide rails 29a restrict the movement of the up-down frame body 250 in the forward and backward direction and in the rightward and leftward direction, thus enabling the up-down frame body 250 to move up and down stably.

As shown in FIG. 2, a pivot mechanism 200c is mounted on the lower frame 253. The pivot frame 200c includes pivot frames 270 formed of plates disposed opposite to each other on right and left sides, and extending portions 270a extending downward from the pivot frames 270. A bearing portion 270b is formed at a tip end region (lower end region) of each extending portion 270a and includes a penetrating hole extending in the rightward and leftward direction. The round-rod shaped lower frame 253 of the up-down frame 250 is inserted into the hole. The lower frame 253 forms a pivot shaft of the pivot frames 270. The pivot frames 270 are rotatably supported to the lower frame 253 by the bearing portions 270b and are pivotable in the forward and backward direction around the lower frame 253.

A rectangular support plate 271 is provided between the right and left pivot frames 270. The support frame 271 is fastened at four corners to the right and left pivot frames 270 by bolts 271a. The above mentioned massaging system 200 is disposed behind the support plate 271 and is mounted on the support plate 271. The support plate 271 is provided with penetrating holes (not shown) on right and left sides. The arms 11 of the massaging system 200 protrude forward from the support plate 271 through the penetrating holes.

Intermediate idle reduction gear units 273 and 274 are mounted to lower regions on right and left sides of the upper frame 252 and are configured to pivot the massaging system 200 supported by the pivot frames 270. Since the right and left intermediate idle reduction gear units 273 and 274 are symmetric in shape, the intermediate reduction gear unit 273 will be described.

The intermediate idle reduction gear unit 273 includes a case 275, an idle gear 276 and a rack drive gear (gearwheel) 240 that are mounted in the interior of the case 275 and are configured to rotate integrally with each other. The intermediate idle reduction gear unit 273 is fastened to the lower region of the upper frame 252 of the up-down frame 250 by a threaded member 286.

As shown in FIG. 2, an advancement and retraction motor 226 and a worm reduction gear 291 are mounted on an upper region of the left side frame 251 of the up-down frame body 250. The worm reduction gear 291 is coupled to an output shaft of the advancement and retraction motor 226 and is configured to reduce the speed of rotation of the output shaft. The output of the worm reduction gear 291 is transmitted to a transmission shaft (rotational shaft) 292. The transmission shaft 292 is provided above the massaging system 200 with the axis oriented in the rightward and leftward direction. A left end portion of the transmission shaft 292 is coupled to the worm reduction gear 291 and a right end portion thereof is rotatably mounted to the upper region of the right side frame 251 of the up-down frame body 250.

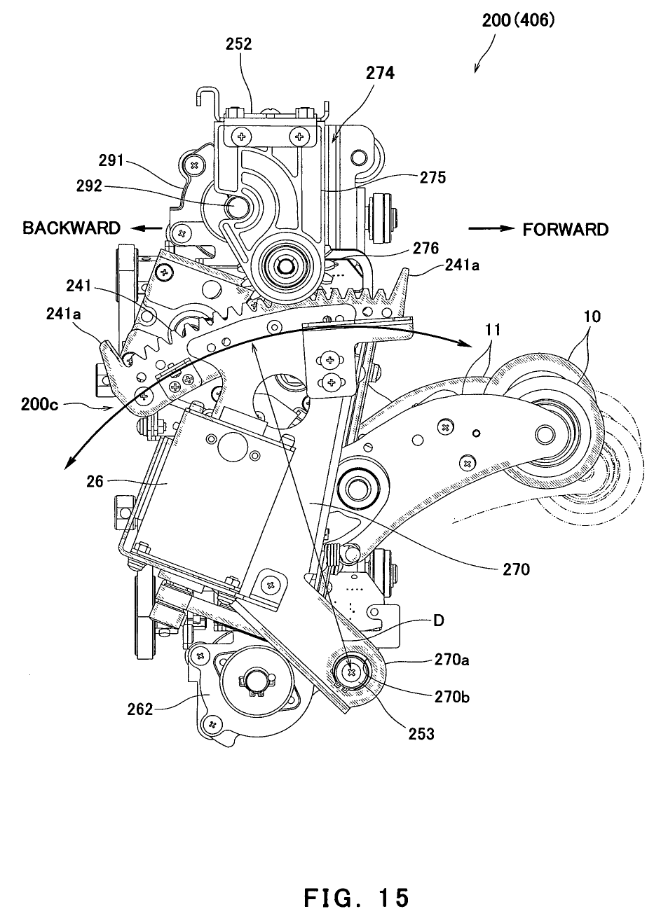

The transmission shaft 292 is supported by the case 275 of the intermediate idle reduction gear unit 273. A transmission gear (not shown) is mounted coaxially on the transmission shaft 292 and is configured to mesh with the idle gear 276 of the intermediate idle reduction gear unit 273. Advancement and retraction racks 241 of a substantially circular arc shape are mounted to upper regions of the right and left pivot frames 270 that support the massaging system 200. Each advancement and retraction rack 241 has a plurality of teeth arranged on a circumference of a circle with a radius D and with a center corresponding to the axis of the lower frame 253 that supports the lower regions of the pivot frames 270. A drive gear 240 of the intermediate idle reduction gear unit 273 is configured to mesh with the advancement and retraction rack 241 from above. As shown in FIG. 15, each advancement and retraction rack 241 is provided with stoppers 241a protruding upward from a front region and a rear region of the advancement and retraction rack 241. The stoppers 241a serve to restrict a moving range of the rack drive gear 240 which is rollable along the advancement and retraction rack 241.

In the pivot mechanism 200c constructed above, the rotation of the advancement and retraction motor 226 is transmitted to the advancement and retraction rack 241 through the worm reduction gear 291, the transmission shaft 292, and the intermediate idle reduction gear unit 273. In this case, the number of rotations of the advancement and retraction motor 226 is suitably reduced while being transmitted to the rack drive gears 240 through the worm reduction gear 291, the idle gear 276, and the transmission gear. Thereby, the rack drive gear 240 rotates, causing the advancement and retraction rack 241 in mesh therewith to move in the forward and backward direction. As a result, the pivot frame 270 that supports the massaging system 200 is pivoted in the forward and backward direction around the lower frame 253 (see arrow in FIG. 15). In this case, a hatched region in FIG. 15, specifically, the massaging system 200, the pivot frame 270, and the advancement and retraction rack 24a are pivoted in the forward and backward direction.

FIG. 4 is a functional block diagram showing a construction of the chair-type massaging apparatus 1. As shown in FIG. 4, the chair-type massaging apparatus 1 includes the controller 40 that is typically built into a lower region of the back rest 3. In this embodiment, the controller 40 is built into the interior of the seat portion 2 (see FIG. 1). The controller 40 mainly includes a CPU 41, a ROM 42, a RAM 43, and an input/output interface 44. The control device 7 that is located outside the controller 40 and above the arm rest 5 (see FIG. 1) is coupled to the input/output interface 44.

The CPU 41 is able to run the program stored in the ROM 42 and/or the program loaded into the RAM 43. The ROM 42 includes a mask ROM, a PROM, an EPROM, an EEPROM, etc, and contains the program run by the CPU 41 and data or the like for use in association with the data. The CPU 41 causes the program stored in the ROM 42 to run, enabling the massaging apparatus 1 to carry out the massage operations such as the kneading operation, the tapping operation, and the finger-pressing operation, or the massaging system 200 to move up and down or forward and backward. The RAM 43 includes SRAM, DRAM, and the like. The RAM 43 is used as a work area of the CPU 41 when the program stored in the ROM 42 is run.

The input/output interface 44 includes a serial interface such as USB, IEEE1394, or RS-232C, a parallel interface such as SCSI, IDE, or IEEE1284, or an analog interface such as a D/A converter or an A/D converter. As described above, the control device 7 and the remote control device 8 are coupled to the input/output interface 44, which is able to receive the signals from the control device 7 and the remote control device 8.

A drive circuit 45 is coupled to the input/output interface 44 and is configured to drive the air inflow and outflow device 46. The air inflow and outflow device 46 includes a switching valve such as an electromagnetic valve, an air pump, etc. The air inflow and outflow device 46 is coupled through the air hoses 48 to a plurality of air bags 47 mounted in the foot rest 4, the seat portion 2, and the like and is configured to inflow and outflow air to and from each of the air bags 47 individually.

Drive circuits 50a to 50d are coupled to the input/output interface 44 and are configured to drive the motors 26, 34, 214, and 226, respectively. The drive circuits 50a to 50d are coupled to a power supply (not shown) and are configured to supply electric power according to rotation instruction signals output from the input/output interface 44 to the motors 26, 34, 214, and 226. To be more specific, based on the signal received from the control device 7 or the remote control device 8, the CPU 41 determines a rotational direction and a rotational speed of each of the motors 26, 34, 214, and 226, or the number of rotations (rotational angle) of each motor in addition to the rotational direction or the rotational speed. The CPU 41 causes the input/output interface 44 to generate the rotational instruction signal indicating the determination. The drive circuits 50a to 50d are respectively provided with pulse generators, which are each configured to generate a voltage (pulse signal) with a pulse width according to the rotational instruction signals from the input/output interface 44. The voltages are applied between terminals of each of the motors 26, 34, 214, and 226. Under such PWM control, the electric power is supplied to each of the motors 26, 34, 214, and 226, which is thereby driven to meet its desired rotational direction, rotational speed, and number of rotations (rotational angle).

While in this embodiment, the motors 26, 34, 214, and 226 are DC servo motors, they may be AC servo motors. As a matter of course, the drive circuits 50a to 50d may be configured depending on the type of the motors to be driven.

Furthermore, an encoder 53 and a magnetic sensor 54 are coupled to the input/output interface 44. The encoder 53 is configured to generate a pulse signal indicating the rotation of the motor 214 that causes the massaging system 200 to move up and down. The CPU 41 counts pulses of the pulse signal to detect a vertical position of the massaging system 200. The magnetic sensor 54 is disposed at a location near the kneading shaft 20 in the axial direction thereof to oppose magnets (not shown) disposed at plural positions of the kneading shaft 20 to be arranged in the circumferential direction. The magnetic sensor 54 is configured to output a voltage corresponding to magnetic strength around it. When the kneading shaft 20 rotates, the magnets sequentially pass through a region near the magnetic sensor 54. So, the CPU 41 counts peaks of the voltage output from the magnetic sensor 54, thus detecting the rotational angle of the kneading shaft 20, i.e., the position of the massaging element 10.

Subsequently, a construction of the control device 7 mounted on the chair-type massaging apparatus 1 will be described. As shown in FIG. 1, the arm rests 5 of the chair-type massaging apparatus 1 include arm rest bases 5b and upper covers 5a provided to cover the arm rest bases 5b from above. The control device 7 is mounted on the upper cover 5a of the right arm rest 5. The control device 7 is of a joystick type configuration. As shown in FIG. 1, the control device 7 includes a base 70 fixed on the upper cover 5a of the arm rest 5, a rod 71 extending upward from the base 70, and a tubular grip 72 that is externally fitted to an upper region of the rod 71 and is adapted to be gripped by the user.

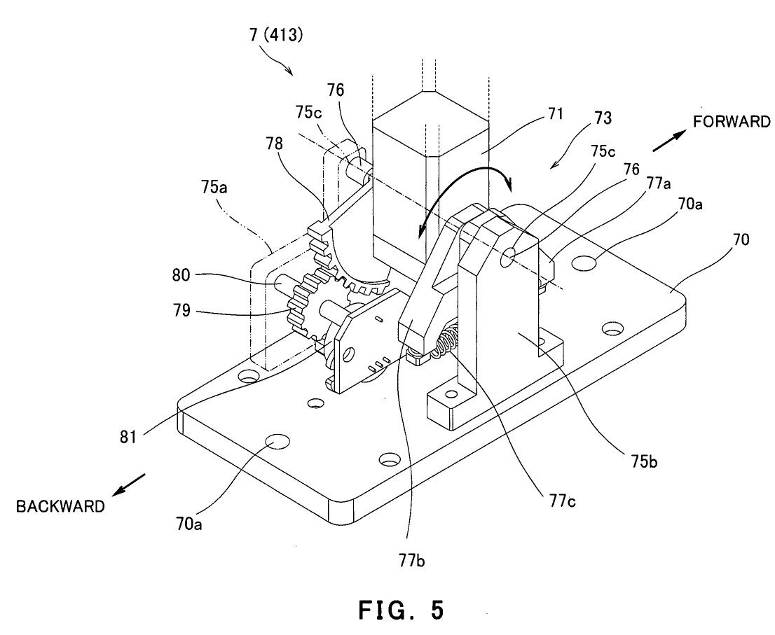

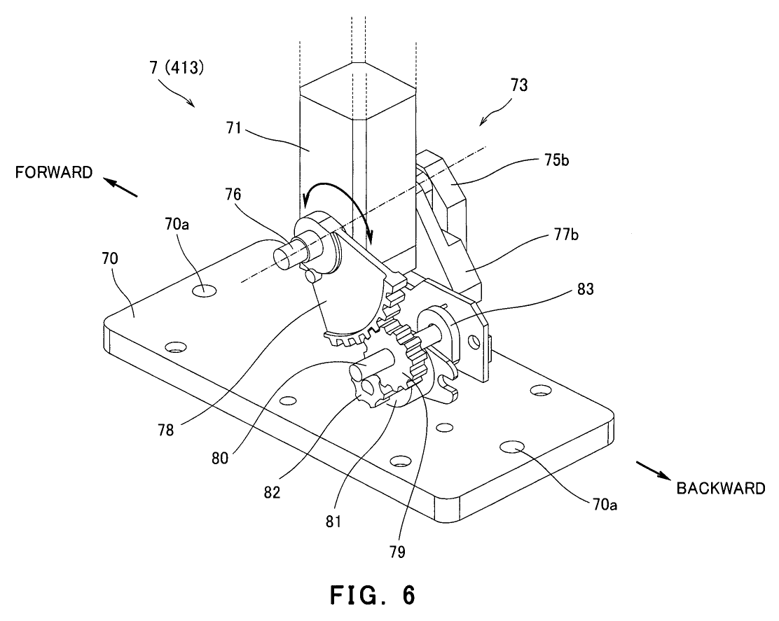

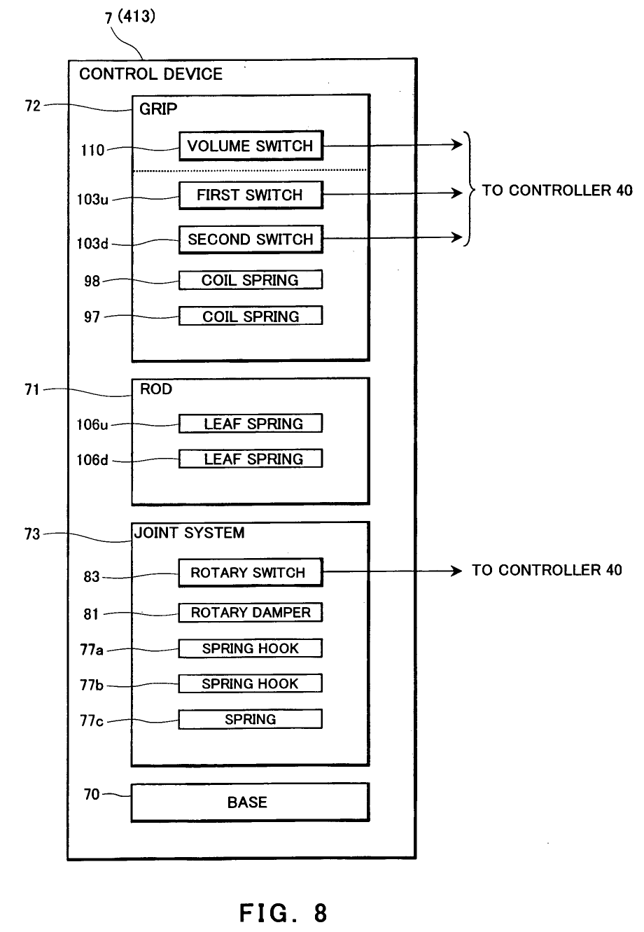

FIG. 5 is a perspective view showing a construction of a joint system 73 of the base 70 and the rod 71 of the control device 7 of FIG. 1 as viewed from rightward and backward, a part of which is omitted. FIG. 6 is a perspective view showing the construction of the joint system 73 of FIG. 5, as viewed from leftward and backward. FIG. 8 is a functional block diagram showing the construction of the control device 7 of FIG. 1. In FIGS. 5 and 6, the cover 73a (see FIG. 1) covering the joint system 73 from above is omitted. As shown in FIGS. 5 and 6, the base 70 is provided with a plurality of threaded holes 70a. The base 70 is fixed on the upper region of the upper cover 5a in such a manner that a plurality of mounting threaded members (not shown) are inserted into the threaded holes 70a and are threaded through the upper cover 5a and into the arm rest 5b thereunder (see FIG. 1).

As shown in FIGS. 5 and 6, the joint system 73 includes rod pivot plates 75a and 75b (left rod pivot plate 75a is represented by a two-dotted line in FIG. 5) configured to vertically extend on the upper surface of the right and left regions of the base 70. Pivot shafts 76 protrude rightward and leftward from right and left side regions of a lower end portion of the rod 71. The pivot shafts 76 are inserted into pivot holes 75c formed on upper regions of the rod pivot plates 75a and 75b. As a result, the rod 71 is mounted on the base 70 to be pivotable in the forward and backward direction around the pivot shaft 76.

As shown in FIG. 5, two spring hooks 77a and 77b are provided between the rod 71 and the right rod pivot plate 75b. Upper portions of the spring hooks 77a and 77b penetrate through the pivot shaft 76. The spring hook 77a extends forward and downward from the pivot shaft 76, and the spring hook 77b extends backward and downward from the pivot shaft 76. A spring 77c is mounted between lower end regions of the spring hooks 77a and 77b and is configured to bias the lower end regions of them closer to each other.

The spring hook 77a extending forward and downward is pivoted around the pivot shaft 76 together with the rod 71 when the rod 71 is tilted backward such that its lower end region is oriented forward and is stopped such that it will not be pivoted by a projection (not shown) protruding from an inner side surface of the rod pivot plate 75b when the rod 71 is tilted forward. The spring hook 77b extending backward and downward is pivoted around the pivot shaft 76 together with the rod 71 when the rod 71 is tilted forward such that its lower end region is oriented backward and is stopped such that it will not be pivoted by the projection when the rod 71 is tilted forward. So, when the rod 71 is tilted forward or backward, the spring 77c between the lower end regions of the spring hooks 77a and 77b is expanded to return the rod 71 to its upright state (neutral position).

The term “neutral position” of the rod 71 means an attitude of the rod 71 in which forward and backward movement of the massaging system 200 because of the tilted state of the rod 71 as described later does not take place. It shall be understood that the neutral position of the rod 71 is not necessarily the upright position, but may be selected desirably in view of the easiness of the user's operation of the control device 7, for example, a slightly tilted position in the forward and backward direction.

As shown in FIG. 5, a gear portion 78 corresponding to a predetermined center angle portion of a spur gear is mounted between the rod 71 and the left rod pivot plate 75a. As shown in FIG. 6, a center region of a pitch circle of the gear portion 78 is fixed to the pivot shaft 76, and the gear portion 78 is pivotable around the pivot shaft 76 together with the rod 71 when the rod 71 is tilted forward or backward. The gear portion 78 is in mesh with a first gear 79 which is another spur gear. The first gear 79 is mounted coaxially on a pivot shaft 80 mounted to a support portion (not shown) extending vertically on the base 70. As shown in FIG. 6, a second gear 82 is mounted on a rotational shaft of a rotary damper (damping portion) 81 fixed to the support portion (not shown) and is in mesh with the first gear 79. Furthermore, a rotary switch 83 is attached to an end portion of the pivot shaft 80 on which the first gear 79 is mounted. The rotary switch 83 is coupled to the input/output interface 44 of FIG. 4 through a signal (not shown).

When the user tilts the rod 71 of the control device 7 constructed above, the rotation of the gear portion 78 is transmitted to the second gear 82 of the rotary damper 81 through the first gear 79. In this case, the viscosity resistance in the rotational direction of the second gear 82 which is applied by the rotary damper 81 causes a displacement speed of the rod 71 to decrease. A signal indicating a tilting angle and a tilting direction of the rod 71 is output from the rotary switch 83 and is input to the controller 40 through the input/output interface 44. The controller 40 causes the advancement and retraction motor 226 (see FIGS. 2 and 4) to rotate based on the input signal, causing the massaging system 200 to move forward and backward. To be specific, when the rod 71 is tilted forward, the controller 40 causes the advancement and retraction motor 226 to rotate in one direction, causing the massaging system 200 to move forward, whereas when the rod 71 is tilted backward, the controller 40 causes the advancement and retraction motor 226 to rotate in the opposite direction, causing the massaging system 200 to move backward.

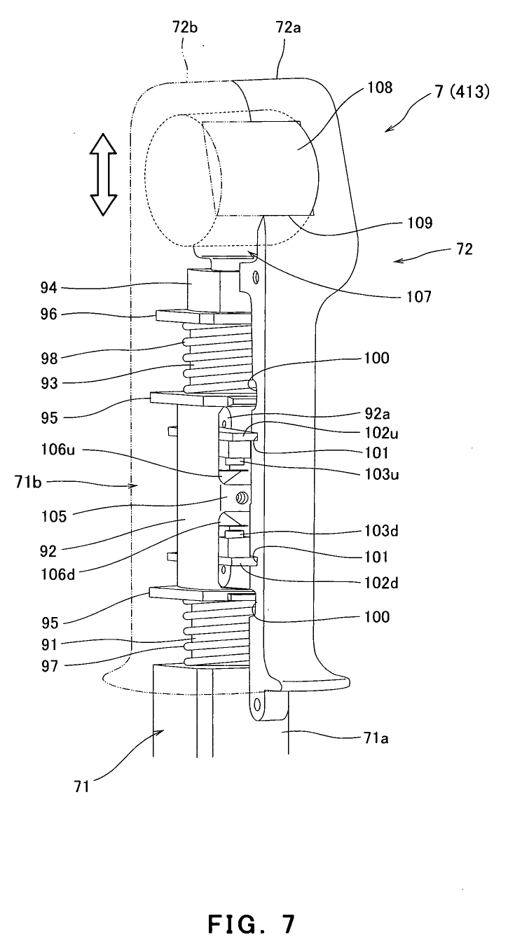

FIG. 7 is a perspective view showing a construction of the grip 72 of the control device 7 in FIG. 1 and the rod 71 located in the interior of the grip 72. As shown in FIG. 7, the grip 72 includes a right grip member 72a (indicated by a solid line) and a left grip member 72b (indicated by a two-dotted line) which are joined to each other from right and left sides. The grip 72 is substantially tubular and is configured to open at a lower end region thereof. An upper portion of the rod 71 is inserted into the inner space of the grip 72. As described later, the grip 72 is coupled to the rod 71 so as to move vertically relative to the rod 71.

The rod 71 has, at its lower region, a rectangular column portion 71a with a substantially rectangular cross-section, and a cylindrical portion 71b with steps that extends upward from an upper end of the rectangular column portion 71a and is internally fitted to the grip 72. The cylindrical portion 71b includes in the following order from below: a first small-diameter portion 91, a first large-diameter portion 92 having a diameter larger than that of the first small-diameter portion 91, a second small-diameter portion 93 having a diameter smaller than that of the first large diameter portion 92, and a second large-diameter portion 94 having a diameter larger than that of the second small-diameter portion 93. The first large-diameter portion 92 is provided with a longitudinally elongated penetrating hole 92a penetrating in the forward and backward direction over the whole length of the first large-diameter portion 92.

Grip support plates 95 of a substantially rectangular shape are provided on an upper end region of the first small-diameter portion 91 and a lower end region of the second small-diameter portion 93 and are configured to sandwich the first large-diameter portion 92 from above and from below. The grip support plates 95 serve to support the grip 72. The upper and lower grip support plates 95 are provided with holes (not shown) at center regions thereof. The first small-diameter portion 91 of the rod 71 is inserted into the hole of the lower grip support plate 95 and the second small-diameter portion 93 is inserted into the hole of the upper grip support plate 95. A spring support plate 96 having a substantially rectangular cross-section and a hole (not shown) at a center region thereof is mounted at an upper end portion of the second small-diameter portion 93. The second small-diameter portion 93 is inserted into the hole of the spring support plate 96.

A coil spring 97 is externally fitted to the first small-diameter portion 91 between a lower surface of the lower grip support plate 95 and an upper end surface of the rectangular column portion 71a. A coil spring 98 is externally fitted to the second small-diameter portion 93 between an upper surface of the upper grip support plate 95 and a lower surface of the spring support plate 96 located thereabove. The coil springs 97 and 98 are compressed to bias the lower grip support plate 95 upward and to bias the upper grip plate 95 downward, respectively.

First grooves 100 are formed on inner walls of the grip members 72a and 72b of the grip 72 so as to correspond to the upper and lower grip support plates 95 and so as to extend in a circumferential direction of the grip 72. The first grooves 100 have a width larger than a depth. That is, the first grooves 100 are vertically elongated in FIG. 7. Peripheral regions of the grip support plates 95 are configured to engage with the first grooves 100. While a detailed structure of only the right grip member 72a is illustrated in FIG. 7, the left grip member 72b is symmetric to the right grip member 72a in the rightward and leftward direction, and will not be further described here.

In the control device 7 constructed above, when the grip 72 is operated to move upward from the neutral position, it is movable upward by a distance corresponding to the width of the lower first groove 100. That is, the grip 72 is able to be operated to move upward to a position (uppermost position) in which the lower grip support plate 95 comes into contact with an inner surface of a lower region of the lower first groove 100. The upper grip support plate 95 is moved together with the grip 72 in engagement with the upper first groove 100. This causes the coil spring 98 to be compressed, biasing the grip 72 downward. Upon upward movement being stopped, the compressed coil spring 98 is expanded, causing the grip 72 to return downward to the neutral position. The term “neutral position” of the grip 72 means an arrangement of the grip 72 in which forward and backward movement of the massaging system 200 because of the vertical displacement of the rod 71 as described herein does not take place. In the above mentioned control device 7, the neutral position is the position of the grip 72 which is not operated by the user.

On the other hand, when the grip 72 is operated to move downward from the neutral position, it is movable downward by a distance corresponding to the width of the upper first groove 100. That is, the grip 72 is able to be operated to move downward to a position (lowermost position) in which the upper grip support plate 95 comes into contact with an inner surface of an upper region of the upper first groove 100. The lower grip support plate 95 is moved downward together with the grip 72 in engagement with the lower first groove 100. This causes the coil spring 97 to be compressed, biasing the grip 72 upward. Upon downward movement being stopped, the compressed coil spring 97 is expanded, causing the grip 72 to return upward to the neutral position.

Second grooves 101 are formed on inner side walls of the left grip member 72a and the right grip member 72b at a location near and under the upper first groove 100 and at a location near and above the lower first groove 100 so as to extend in the circumferential direction. A switch support plate 102u has a rectangular shape that is elongated in the forward and backward direction and is supported in such a manner that a front end portion and a rear end portion thereof are fitted into the upper second groove 101. The switch support plate 102u extends through an upper region in the interior of a penetrating hole 92a formed in the first large-diameter portion 92 of the rod 71. A first switch 103u of a press button type is attached on a lower surface of the switch support plate 102u. The first switch 103u is vertically movable together with the grip 72 when the grip 72 is operated to move vertically.

Likewise, a switch support plate 102d has a rectangular shape that is elongated in the forward and backward direction and is supported in such a manner that a front end portion and a rear end portion thereof are fitted into the lower second groove 101 formed on inner side walls of the grip members 72a and 72b. The switch support plate 102d extends through a lower region in the interior of a penetrating hole 92a formed in the first large-diameter portion 92 of the rod 71. A second switch 103d of a press button type is attached on an upper surface of the switch support plate 102d. The second switch 103d is vertically movable together with the grip 72 when the grip 72 is operated to move vertically.

A rib 105 is provided at a center in the vertical direction of the penetrating hole 92a formed on the first large-diameter portion 92 of the rod 71 and is configured to extend between right and left side walls of the first large-diameter portion 92 to provide stiffness to the first large-diameter portion 92. Leaf springs 106u and 106d are mounted on upper and lower sides of the rib 105. The upper leaf spring 106u is elastically bendable downward and the lower leaf spring 106d is elastically bendable upward. The upper first switch 103u is located above the leaf spring 106u mounted on the upper side of the rib 105 to be spaced a distance apart from (with play) and opposite to the leaf spring 106u. The lower second switch 103d is located below the leaf spring 106d mounted on the lower side of the rib 105 to be spaced a distance apart (with play) from and opposite to the leaf spring 106d.

When the user operates the grip 72 to move upward as described above, the lower second switch 103d moves upward closer to the lower leaf spring 106d, and comes into contact with the lower leaf spring 106d. Upon the contact, the second switch 103d is switched from an off-state to an on-state, and outputs an on-state signal until the second switch 103d moves away from the leaf spring 106d. The signal is input to the controller 40 (see FIG. 4) through the signal line (not shown). Based on the input signal, the controller 40 causes the motor 214 (see FIG. 2 or FIG. 4) to rotate in one direction so that the massaging system 200 moves upward together with the moving device 200a.

Likewise, when the user operates the grip 72 to move downward, the upper first switch 103u moves downward closer to the upper leaf spring 106u, and comes into contact with the upper leaf spring 106u. Upon the contact, the first switch 103u is switched from an off-state to an on-state, and outputs an on-state signal until the first switch 103u moves away from the leaf spring 106u. The signal is input to the controller 40 (see FIG. 4) through the signal line. Based on the input signal, the controller 40 causes the motor 214 to rotate in the opposite direction so that the massaging system 200 moves downward together with the moving device 200a.

Because of elasticity of the leaf springs 106u and 106d, impact applied to the switches 103u and 103d by the contact with the leaf springs 106u and 106d is alleviated. When the grip 72 is operated to move further upward or downward after the switches 103u and 103d contact the leaf springs 106u and 106d, the leaf springs 106u and the 106d are bent. Therefore, damage, such as breaking, to the first switches 103u and 103d does not occur when they contact the leaf springs 106u and 106d.

As shown in FIG. 7, a roller accommodating space 107 is formed in an upper region of the grip 72 and is located above the rod 71. A roller 108 is accommodated in the roller accommodating space 107 and is configured to rotate around an axis oriented in the rightward and leftward direction. A rectangular aperture 109 is formed in a rear surface of the upper region of the grip 72 and is connected to the roller accommodating space 107. A part of a peripheral region of the roller 108 accommodated in the roller accommodating space 107 is exposed to outside through the aperture 109. A volume switch 110 (see FIG. 8) is accommodated in the roller accommodating space 107. A rotational shaft of the volume switch 110 cooperates with a rotational shaft of the roller 108.

The roller 108 serves to control rotational speeds of the motors 26 and 34 (see FIG. 3) of the massaging system 200. When the user rotates the roller 108 by a predetermined angle in one direction with, for example, a thumb, a signal indicating the rotational angle is input from the volume switch 110 to the controller 40 (see FIG. 4) through the signal line (not shown), thereby accelerating the massage operation of the massaging element 10. On the other hand, when the user rotates the roller 108 by a predetermined angle in the opposite direction, a signal indicating rotational angle is input from the volume switch 110 to the controller 40 through the signal line, thereby slowing the massage operation of the massaging element 10.

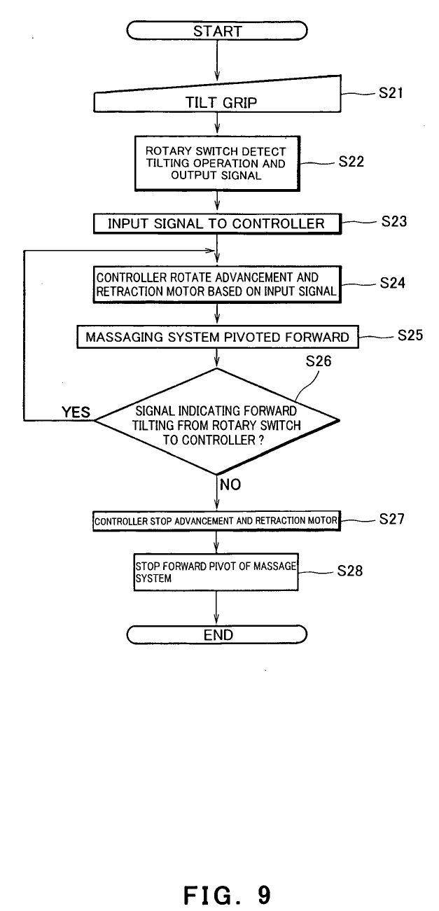

By operating the control device 7 to move forward and backward and upward and downward, the massaging system 200 of the chair-type massaging apparatus 1 operates to move forward and backward and upward and downward as well. Hereinbelow, the operation of the control device 7 and the operation of the massaging system 200 will be described in detail. First, the operation of the massaging system 200 in the case where the rod 71 of the control device 7 is tilted in the forward and backward direction will be described with reference to a flowchart of FIG. 9. As described previously, the massaging system 200 is capable of various types of massage operations such as a kneading operation, a tapping operation and a finger-pressing operation, which are carried out by using the remote control device 8 in this embodiment. Since the operation of the massaging system 200 is controlled by the operation of the remote control device 8 with a known technique, it will not be further described.

As shown in FIG. 9, when the user tilts the control device 7 forward (S21), the rotary switch 83 (see FIGS. 6 and 8) mounted on the joint system 73 detects a tilting direction (forward) of the rod 71 (S22), and a detection signal is input to the controller 40 (S23). The controller 40 causes the advancement and retraction motor 226 to rotate based on the input signal (S24). Thereby, the massaging system 200 is pivoted forward (S25).

Then, the controller 40 determines whether or not the signal indicating that the rod 71 is tilted forward is input from the rotary switch 83 to the controller 40 (S26). While the user holds the control device 7 tilted forward and the signal continues to be input from the rotary switch 83 to the controller 40 (S26: YES), the operation in step S24 and the following steps is repeated. On the other hand, when the user returns the grip 72 to its neutral position in which the grip 72 is in the upright position, or otherwise the user releases his/her hand from the grip 72 to cause the rod 71 to return to its neutral position by the action of the spring 77c (see FIG. 5), the signal input from the rotary switch 83 to the controller 40 stops. So, the controller 40 determines that the signal indicating that the rod 71 is tilted forward is not input from the rotary switch 83 any more (step S26: NO). Then, the controller 40 stops the rotation of the advancement and retraction motor 226 (S27) and stops forward pivot movement of the massaging system 200 (S28).

In accordance with the above configuration, the massaging system 200 is pivoted forward during a time period in which the user is tilting the control device 7 forward, while when the user stops operating the control device 7 by, for example, releasing the hand from the grip 72, the massaging system 200 is held at that position. Likewise, the massaging system 200 is pivoted backward during a time period in which the user is tilting the control device 7 backward, while when the user stops operating the control device 7 by, for example, releasing the hand from the grip 72, the massaging system 200 is held at that position. The controller 40 may be alternatively configured to cause the massaging system 200 to return to a predetermined position when the user stops operating the grip 72 to turn the control device 7 to a non-operating state, that is, the signal is not input from the rotary switch 83 of the joint system 73 to the controller 40 anymore.

As described above, by causing the tilting operation of the control device 7 to correspond with the pivot operation of the massaging system 200 in the forward and backward direction, the tilting direction, i.e., the forward and backward direction of the control device 7 matches the pivot direction, i.e., the forward and backward direction of the massaging system 200 from the perspective of the user seated in the seat portion 2 of the chair-type massaging apparatus 1. Therefore, the user tilts the control device 7 in the forward and backward direction without mental effort to enable the massaging system 200 to a desired position in the forward and backward direction. The user is able to operate the control device 7 easily without feeling discomfort.

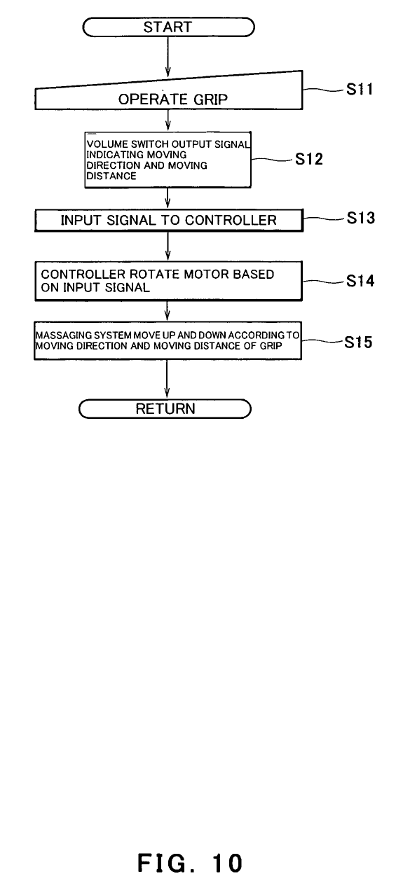

While the control device 7 includes the rotary switch 83 that detects the tilting direction of the rod 71 to detect the tilting operation of the rod 71, another configuration may alternatively be used. For example, the rotary switch 83 in FIGS. 6 and 8 may be replaced by a volume switch. In this case, when the rod 71 is tilted, a displacement amount (or rotational angle) in the tilting operation is able to be detected, in addition to the tilting direction. An operation of the massaging system 200 performed with the control device 7, which includes the volume switch, will be described with reference to the flowchart of FIG. 10.

Referring to FIG. 10, when the grip 72 of the control device 7 is tilted forward by the user (S11), the volume switch outputs a signal indicating the tilting direction, i.e., forward of the grip 72 and a tilting displacement amount (moving distance) from the neutral position of the rod 71 in the upright position (S12), and the signal is input to the controller 40 (S13). Based on the input signal, the controller 40 causes the motor 226 (see FIG. 2 or 4) to rotate in the direction according to the tilting direction of the grip 72 and by the amount corresponding to the tiling displacement amount of the rod 71 (S14). As a result, the advancement and retraction pinions 240 of the massaging system 200 roll on the advancement and retraction racks 241 of the moving device 200a, and the massaging system 200 is moved in the direction corresponding with the tilting direction of the grip 72 and a by a distance corresponding to the tilting displacement amount (moving distance) of the rod 71 (S15).

The use of the control device 7 including the volume switch allows the operation of the control device 7 by the user and the operation of the massaging system 200 to have a continuous correlation between them. Specifically, the tilting direction (forward and backward direction) of the grip 72 is caused to match the moving direction (forward and backward direction) of the massaging system 200, and the massaging system 200 is moved by the distance according to, for example, proportional to the tilting displacement amount of the rod 71. When the user stops operating the control device 7 by, for example, releasing the hand from the grip 72, the rod 71 returns to the neutral position in which the rod 71 is in the upright position by the action of the spring 77c, and the massaging system 200 returns to an initial position.

The moving distance of the massaging system 200 in step 15, i.e., the number of rotations (or rotational angle) of the motor 226 in step 14 may be proportional to the tilting displacement amount of the rod 71, or may be represented in approximation by a quadratic or higher-order function of the displacement amount of the rod 71. Also, the moving distance of the massaging system 200 may be represented in approximation by an exponential function of the displacement amount of the rod 71. Furthermore, the moving distance of the massaging system 200 may be represented by a combination of these functions, or by a discontinuous function. In this case, table data or the like that contains input values and the associated output values of the proportional function, the quadratic or higher-order function, or the exponential function are pre-stored in the ROM 42 of the controller 40. Upon the signal from the volume switch of the control device 7 being input to the controller 40, the controller 40 may refer to the table data contained in the ROM 42, and obtain a signal corresponding to the input signal to drive the motor 226. Alternatively, the table data may be replaced by a calculation program. As a further alternative to this, a calculation circuit including a flip flop may be additionally provided.

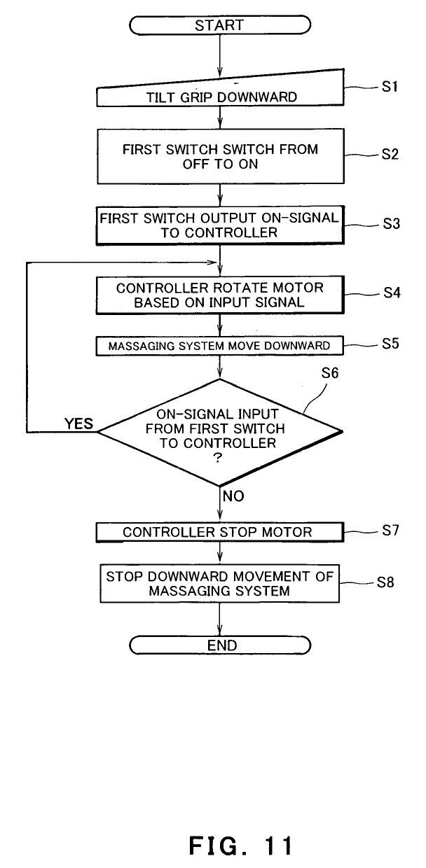

Subsequently, the operation of the massaging system 200 performed when the grip 72 of the control device 7 is operated to move in the vertical direction will be described with reference to the flowchart in FIG. 11. As shown in FIG. 11, when the grip 72 of the control device 7 is operated to move downward from the neutral position (S1), it moves downward by the distance between the first switch 103u and the upper leaf spring 106u, and the first switch 103u contacts the leaf spring 106u, causing the first switch 103u to turn from the off-state to the on-state (S2). The first switch 103u outputs the signal to the controller 40 (S3). Based on this signal, the controller 40 causes the motor 214 to rotate (S4). Thereby, the up-down pinion 207 rolls along the guide rail 29a and the massaging system 200 moves downward along the guide rail 29a together with the moving device 200a (S5).

Then, the controller 40 determines whether or not the signal indicating the on-state is input from the first switch 103u to the controller 40 (S6). When the user holds the grip 72 of the control device 72 in a downward position and the signal indicating the on-state is being input from the first switch 103u to the controller 40 (S6: YES), the controller 40 repeats the step 4 and the following steps. On the other hand, when the user operates the grip 72 to return it to the neutral position, or otherwise releases the grip 72 to return it to the neutral position by the action of the lower coil spring 97, the first switch 103u moves away from the leaf spring 106u, and the controller 40 determines that the signal indicating the on-state is not input from the first switch 103u to the controller 40 anymore in step 6 (S6: NO). Then, the controller 40 stops the rotation of the motor 214 (S7) to stop the downward movement of the massaging system 200 (S8).

In the chair-type massaging apparatus 1 of this embodiment, the massaging system 200 moves downward while the grip 72 of the control device 7 is operated to move downward by the user, and when the operation of the control device 7 is stopped by, for example, releasing the hand from the grip 72, the massaging system 200 is held at that position. Likewise, the massaging system 200 moves upward while the grip 72 of the control device 7 is operated to move upward by the user, and when the operation of the control device 7 is stopped by, for example, releasing the hand from the grip 72, the massaging system 200 is held at that position. The controller 40 may be configured to cause the massaging system 200 to return to a predetermined position (e.g., uppermost position or lowermost position) when the user stops operating the grip 72 to turn the control device 7 to a non-operating state, that is, the signal indicating the on-state is not input from the first switch 10u and the second switch 103d to the controller 40 anymore.

In the chair-type massaging apparatus 1 of this embodiment, the moving direction (i.e., vertical direction) of the grip 72 of the control device 7 matches the moving direction (vertical direction) of the massaging system 200 from the perspective of the user seated in the seat portion 2. So, the user is able to operate the grip 72 of the control device 7 in the vertical direction without mental effort to move the massaging system 200 to a desired position (height). As a result, the user is able to operate the control device 7 easily without feeling discomfort.

The massaging system 200 may be moved up and down by the distance corresponding to the moving distance of the control device 7 in the vertical direction in addition to the moving direction of the grip 72. By way of example, instead of the first switch 103u, the second switch 103d, and the leaf springs 106u and 106d, the rod 71 of the control device 7 may be provided with a rack, and the grip 72 may be provided with a pinion that is able to roll in mesh with the rack, and a volume switch rotatable integrally with the pinion may be provided. A signal indicating the tilting direction and the moving distance of the grip 72 which has been detected by the volume switch may be input to the controller 40, which may cause the up-down motor 214 to rotate based on the input signal.

Subsequently, another control device 7a which includes an altered construction of the control device 7 will be described. The control device 7a is configured not to return the rod 71 to the upright position but to hold the rod 71 at a current position (tilting attitude) even when the control device 7a turns to a non-operating state with the rod 71 tilted.

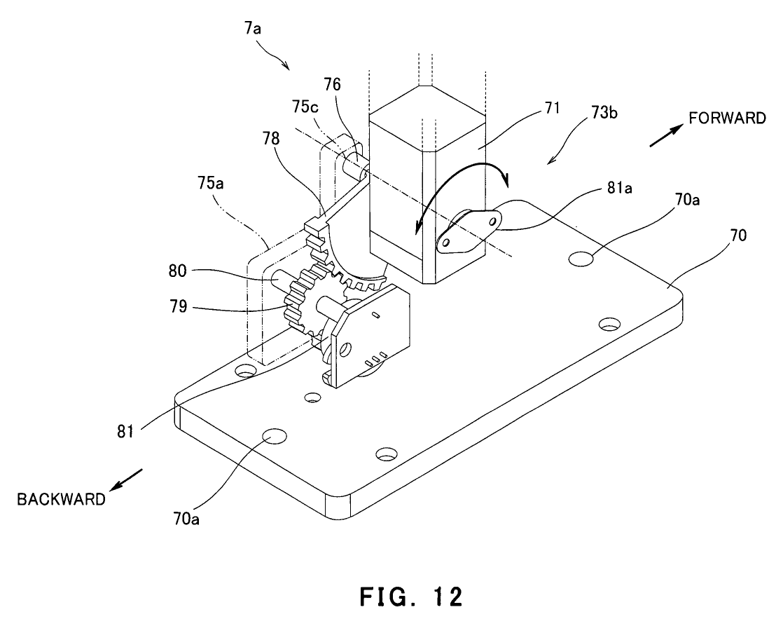

FIG. 12 is a perspective view showing a construction of a joint system 73b of the control device 71a, a part of which is omitted. As shown in FIG. 12, the control device 7a includes a rotary damper (holding portion) 81a instead of the spring hooks 77a and 77b, the spring 77c, and one the pivot plate 75b of the control device 7. The rotary damper 81a is constructed in such a manner that its base is threadedly engaged with an inner wall of the cover 73a (see FIG. 1) covering the joint system 73b, and its rotational shaft (not shown) is coupled to the rod 71 with its axis conforming to an axis of the pivot shaft 76. The rotary damper 81a provides viscous frictional force to the pivot movement of the rod 71 in the forward and backward direction, together with the rotary damper 81. The frictional force cancels the force to tilt the rod 71.

When the user stops operating the control device 7a by releasing the hand from the grip 72 with the rod 71 tilted by the user's operation, the above constructed control device 7a holds its current attitude, i.e., tilted attitude. Therefore, when the user releases the hand from the grip 72 with the control device 7a tilted, the signal indicating the tilting operation continues to be output from the rotary switch 83 of the control device 7a to the controller 40, causing the massaging system 200 to move in the forward and backward direction. In the control device 7a including the volume switch instead of the rotary switch 83, when the user releases the hand from the grip 72 with the control device 7a tilted, the massaging system 200 is held at the position in the forward and backward direction according to the tilting direction and tilting displacement amount of the rod 71 of the control device 7a at the time when the user releases the hand from the grip 72. It shall be understood that the rotary damper 81a may be omitted when the rotary damper 81 is able to produce sufficient viscous frictional force by itself. It shall be also understood that the rotary damper 81 may be omitted when the rotary damper 81a is able to produce sufficient viscous frictional force by itself.

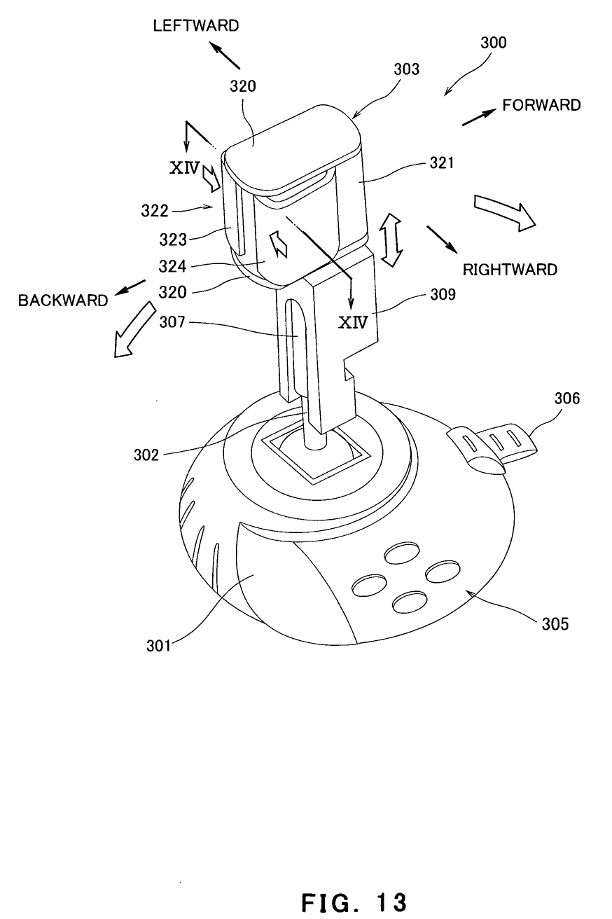

Another control device having a construction different from those of the control device 7 and the control device 7a mentioned above will be described with reference to FIG. 13 which is a perspective view showing its external appearance. A control device 300 illustrated in FIG. 13 may be applied to the chair-type massaging apparatus 1 of FIG. 1 as in the control devices 7 and 7a, and is mounted on the upper cover 5a of the right arm rest 5 of the chair-type massaging apparatus 1.

As shown in FIG. 13, the control device 300 mainly includes a base 301, a rod 302 extending vertically on the base 301, and a grip 303 mounted on an upper portion of the rod 302. Although a cover is generally provided to cover the grip 303, it is omitted in FIG. 13. The base 301 is of an inverted bowl shape, and is provided with various types of buttons and switches such as a reclining control button 305 for controlling a reclining position of the back rest 3, and a speed control switch 306 for controlling a speed of the tapping operation of the massaging element 10 of the massaging system 200.

The rod 302 extending upward on the base 301 is coupled at a lower end thereof to the base 301 by a ball joint, and is able to be tilted in all directions, forward and backward and rightward and leftward. A rotary switch (not shown) is contained in the base 301, and is configured to detect a tilting direction of the rod 302 and to output a detection signal to the controller 40 (see FIG. 4). Furthermore, a spring and a rotary damper (not shown) are contained in the base 301 and are configured to provide viscous resistance in the opposite direction to the displacement direction when the rod 302 is tilted or returns to the upright position. Such a construction functions as in the joint system 73 of the control device 7 illustrated in FIGS. 5 and 6. It shall be understood that the rotary switch may be replaced by the volume switch and a spring for returning the rod 302 may be omitted to provide a function similar to the function of the joint system 73b of the control device 7a of FIG. 12.

A cylindrical rod accommodating portion 307 is externally fitted to an upper region of the rod 302. The rod 302 and the rod accommodating portion 307 are coupled to each other in the same manner that the rod 71 and the grip 72 of the control device 7 of FIG. 7 are coupled to each other. The rod accommodating portion 307 contains switches (not shown) that detect the movement of the rod accommodating portion 307 in the vertical direction, which correspond to the first switch 103u and the second switch 103d in FIG. 7, or the coil spring (not shown) that applies a force to return the rod accommodating portion 307 to a center position (neutral position) in the vertical direction, which corresponds to the coil springs 97 and 98 in FIG. 7. The rod accommodating portion 307 is operated to move up and down relative to the rod 302. When the rod accommodating portion 307 is operated to move up and down, it is caused to move to the neutral position, and a signal indicating the moving direction is output to the controller 40 (see FIG. 4).

In the control device 300 constructed above, the massaging system 200 is operated to move in the forward and backward direction and in the vertical direction by the user's operation without mental effort, as in the control devices 7 and 7a. To be specific, when the grip 303 of the control device 300 is tilted in the forward and backward direction, the massaging system 200 is moved in the forward and backward direction substantially corresponding with the tilting direction, while when the grip 303 is operated to move in the vertical direction, the massaging system 200 is moved in the vertical direction. So, the user is able to operate the control device 300 easily without mental effort. The operation of the massaging system 200 in the forward and backward direction and in the vertical direction that is performed when the grip 300 is operated is substantially identical to the operation illustrated in the flowcharts of FIGS. 9 to 11, and will not be further described.

The rod accommodating portion 307 is coupled to the grip 303 located thereabove through a coupling member 309. The coupling member 309 is two-fork shaped to extend to the right or to the left. The coupling member 309 is fastened to the rod accommodating portion 307 by threaded members so as to support the rod accommodating portion 307 from the right and left sides. The grip 303 is mounted to an upper region of the coupling member 309. When the grip member 303 is operated to move in the vertical direction, the grip 303, the coupling member 309, and the rod accommodating portion 307 move integrally in the vertical direction. The switch (not shown) in the rod accommodating portion 307 outputs the signal indicating the moving direction to the controller 40 (see FIG. 4).

The grip 303 mainly includes upper and lower plates 320 that are elongated in the forward and backward direction, a support member 321 that supports the plates 320, and a grip handle 322 that is provided between the plates 320 and is configured to be gripped by the user. The grip handle 322 includes a left grip member 323 and a right grip member 324. The user holds the grip members 323 and 324 to cause them to move close to or away from each other, thereby opening and closing the grip handle 322.

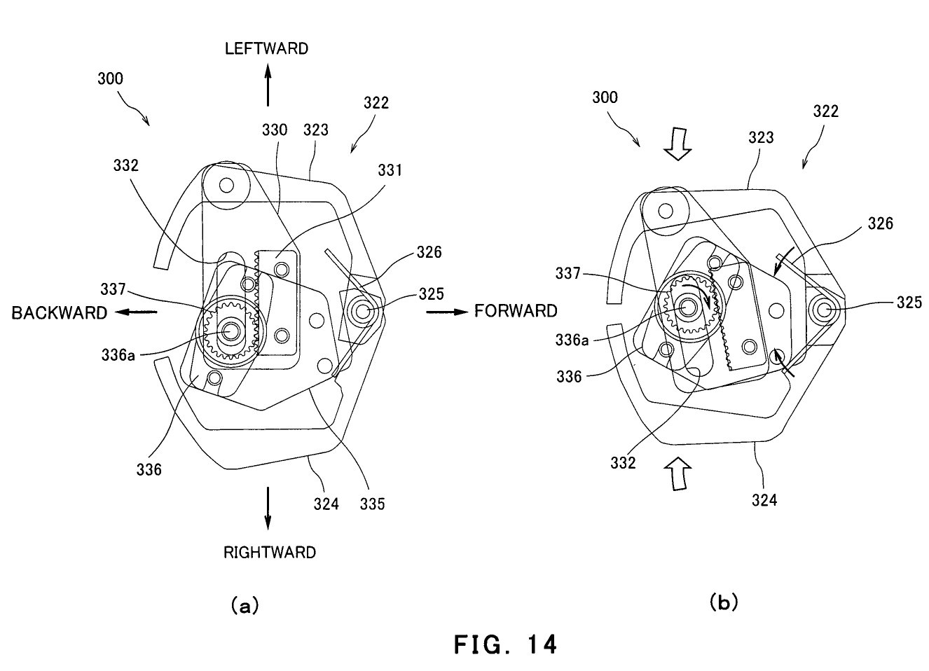

FIGS. 14(a) and 14(b) are cross-sectional views of the grip member 303 of the control device 300 in FIG. 13, taken in the direction of arrow along XIV in FIG. 13, to show the construction and operation principle of the grip handle 322. FIG. 14(a) shows the grip handle 322 in an open configuration and FIG. 14(b) shows the grip handle 322 in a closed configuration. All the components in FIGS. 14(a) and 14(b) are represented by solid lines so that they are clearly seen and the operation principle is well understood. The positional relationship of these components will be described below.

As shown in FIG. 14(a), the left grip member 323 and the right grip member 324 have substantially channel-shaped cross-sections. The grip members 323 and 324 have openings opposite to each other and are pivotally mounted at front end portions thereof by a pivot shaft 325. A coil spring 326 is mounted on the pivot shaft 325 and is configured to apply a force to open the left grip members 323 and the right grip member 324 when the grip members 323 and 324 are closed to a predetermined opening degree or less.

A plate-shaped rack support plate 330 extending inward is pivotally mounted to the left grip member 323. A rack 331 extending substantially in the rightward and leftward direction is mounted on an upper surface of the rack support plate 330. The rack support plate 330 is provided with a guide hole 332 extending substantially rightward and leftward along the rack 331 behind the rack 331. A plate-shaped pinion support plate 335 extending inward is mounted to the right grip member 324 by a bracket (not shown). The pinion support plate 335 is disposed above the rack support plate 330. A rotary damper 336 is mounted on a lower surface of the pinion support plate 335 with an output shaft 336a oriented downward. A pinion 337 is coaxially mounted on the output shaft 336a and is in mesh with the rack 331. A lower end portion of the output shaft 336a of the rotary damper 336 is inserted into the guide hole 332 formed on the rack support plate 330.

As shown in FIG. 14(b), when the user grips the grip 303 constructed above, the left grip member 323 and the right grip member 324 rotate around the pivot shaft 325 against the force applied by the spring 326. When the left grip member 323 and the right grip member 324 move closer to each other, the output shaft 336a of the rotary damper 336 is guided through the guide hole 332 and the pinion 337 at the end portion of the output shaft 336a rolls in mesh with the rack 331. When the user, for example, releases the hand from the grip handle 322 to cause the control device 300 to turn to a non-operating state, the grip members 323 and 324 move away from each other by the action of the spring 326, causing the grip handle 322 to re-open to an initial state (in FIG. 14(a)).

A volume switch (not shown) is coaxially mounted on the pinion 337 or the pivot shaft 325, and is configured to output a signal indicating a distance between the left and right grip members 323 and 324 (or opening degree of the grip handle 322) to the controller 40 (see FIG. 4). Based on the input signal and according to the distance between the left grip member 323 and the right grip member 324, the controller 40 changes the distance between the right and left massaging elements 10 of the massaging system 200 (see FIG. 4), thus carrying out the kneading operation. Thus, by gripping the grip handle 322 of the control device 300, the massaging system 200 carries out the kneading operation, i.e., massages closer to actual hand kneading action.

While the configuration to operate the massaging elements 10 mounted in the back rest 3 of the chair-type massaging apparatus 1 has been described above, the massaging elements 10 to be controlled by the control device 7 and the like may be disposed at other positions. Also, the air bags 47 (see FIG. 4) mounted on the lower thigh support surface 4a (see FIG. 1) of the foot rest 4 may be expanded or contracted such that regions of the air bags 47 that contact the lower thighs of the user are moved in the forward and backward direction by tilting the control device 7 or the like in the forward and backward direction. Furthermore, the control device 7 and the like are not necessarily fixed to the chair-type massaging apparatus 1 but may be removably mounted to it.

### Embodiment 2

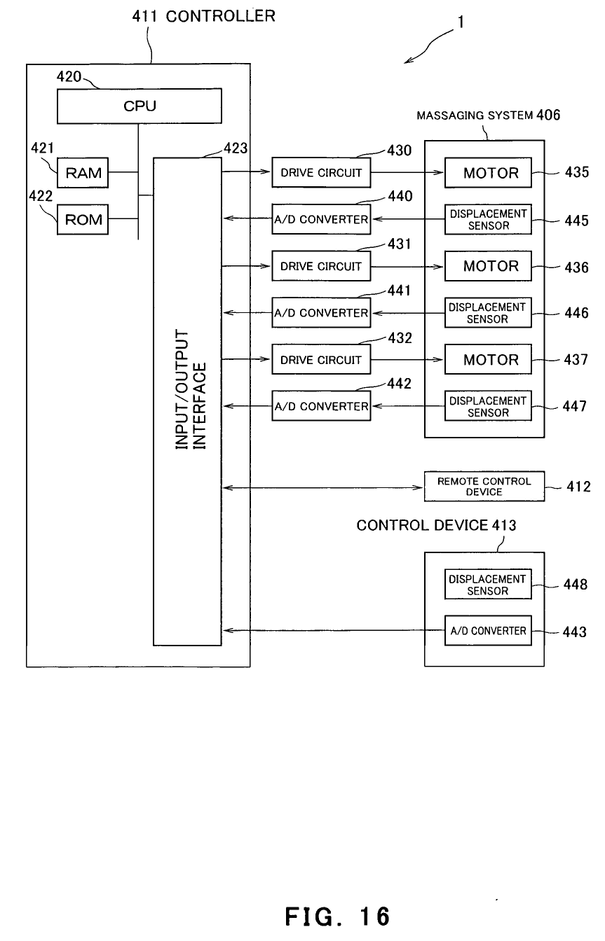

FIG. 16 is a functional block diagram showing a second embodiment of the chair-type massaging apparatus 1 illustrated in FIG. 1. In FIG. 16, a massaging system 406, a controller 411, a remote control device 412, and a control device 413, which respectively correspond to the massaging system 200, the controller 40, the remote control device 8, and the control device 7 (or the control device 300) are illustrated, and other functions of the foot rest 4 or the like having the air bags are omitted. Since the massaging system 406, the remote control device 412, and the control device 413 are identical in construction to the massaging system 200, the remote control device 8, and the control device 7 (or the control device 300) described in the first embodiment, except for a case specifically illustrated, they will not be further described.

As shown in FIG. 16, the controller 411 of the chair-type massaging apparatus 1 mainly includes, a CPU 420, a RAM 421, a ROM 422, and an input/output interface 423. The CPU 420 is able to run a program stored in the ROM 422 and/or a program loaded into the RAM 421. The RAM 421 is used as a work area of the CPU 420 when the CPU 420 is running the program stored in the ROM 422. The ROM 422 contains the program to be run by the CPU 420 and the data used to run the program, etc. The CPU 420 runs the program stored in the ROM 422, causing the chair-type massaging apparatus 1 to carry out various massage operations.

Motors 435 to 437 of the massaging system 406 are electrically coupled to a input/output interface 423 of the controller 411 through drive circuits 430 to 432. The drive circuits 430 to 432 are configured to respectively and individually drive the motors 435 to 437 based on control signals output from the input/output interface 423. To be specific, the drive circuit 430 drives a motor 435 corresponding to the up-down motor 214 (see FIG. 4) of the first embodiment to cause the massaging system 406 to move up and down, thus changing the massage position in the vertical direction or carrying out the rolling massage. The drive circuit 431 drives a motor 436 corresponding to the advancement and retraction motor 226 of the first embodiment to cause the massaging system 406 to move forward and backward, thus carrying out the press massage against the back of the user. The drive circuit 432 drives a motor 437 corresponding to the kneading motor 26 or the tapping motor 34 of the first embodiment to cause the massaging elements 10 (see FIG. 1) of the massaging system 406 to operate, thus carrying out the kneading massage or the tapping massage. While in this embodiment, one motor 437 is used to cause the massaging element 10 to perform the kneading operation or the tapping operation for the sake of simplicity, two motors may alternatively be equipped to correspond to the kneading operation and the tapping operation, respectively, as a matter of course, as in the first embodiment.

The drive circuits 430 to 432 drive the motors 435 to 437 under the PWM control. The drive circuits 430 to 432 are respectively provided with pulse generators, which are each configured to generate a voltage (pulse signal) with a pulse width according to the control signal from the input/output interface 423. The voltage is applied between terminals of the respective motors 435 to 437. Under such PWM control, the electric power is supplied to each of the motors 435 to 437, which is thereby driven to meet its desired rotational direction, rotational speed, and number of rotations (rotational angle). The drive circuits and motors may be added as necessary depending on the operation of the massaging system 406.

Displacement sensors 445 to 447 are attached at suitable positions of the massaging system 406 and are electrically coupled to the input/output interface 423 through the A/D converters 440 to 442. The displacement sensors 445 to 447 are each configured to output an analog detection signal indicating the displacement amount of the massaging system 406, and A/D converters 440 to 442 are each configured to output the detection signal in a digital format. To be specific, the displacement sensor 445 detects the position of the massaging system 406 in the vertical direction, the displacement sensor 446 detects the position of the massaging system 406 in the forward and backward direction, and the displacement sensor 447 detects the positions of the massaging elements 10 of the massaging system 406. The displacement sensors and the A/D converters may be increased as necessary. The A/D converters 440 to 442 and the displacement sensors 445 to 447 may be replaced by pulse counters and encoders. In that case, the encoders are configured to output digital detection signals according to the displacement amount of the massaging system 406.

The remote control device 412 and the control device 413 are electrically coupled to the input/output interface 423. In this embodiment, the remote control device 412 includes a plurality of button switches (not shown), which are operated to enable the massaging system 406 to move up and down and the massaging elements 10 to operate. The control device 413 includes an A/D converter 443, and a displacement sensor 448, which is electrically coupled to the input/output interface 423 of the controller 411 through the A/D converter 443. The displacement sensor 448 is configured to detect the displacement amount (tilting angle) of the lever 413b equipped in the control device 413 and including the rod 71 and the grip 72 (see FIG. 1). The A/D converter 443 is configured to output an analog detection signal indicating the displacement amount to the controller 411 in the digital format. Based on the detection signal from the displacement sensor 448, the controller 411 causes the massaging system 406 to move forward and backward.

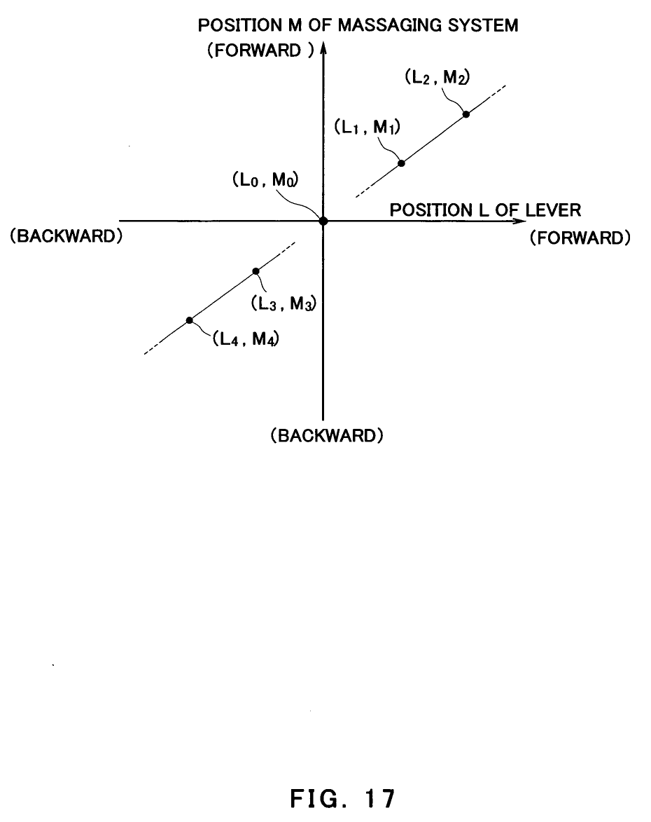

The chair-type massaging apparatus 1 of the second embodiment is configured in such a manner that the displacement direction of the lever 413b of the control device 413 matches the displacement direction of the massaging system 406, and the massaging system 406 moves by the displacement amount proportional to the displacement amount of the lever 413b. As can be seen from a graph in FIG. 17, representing the positional relationship between the lever 413b and the massaging system 406, when the lever 413b is tilted forward, the massaging system 406 is pivoted forward, while when the lever 413b is tilted backward, the massaging system 406 is pivoted backward. Also, the massaging system 406 is pivoted by the displacement amount (pivot distance) proportional to the displacement amount (tilting angle) of the lever 413b. In FIG. 17, L₀ represents the neutral position of the lever 413b, L₁ to L₄ represent other tilting positions of the lever 413b, and M₀ to M₄ represent the positions of the massaging system 406 corresponding to the positions L₀ to L₄ of the lever 413b, respectively.

The control device 413 equipped in the chair-type massaging apparatus 1 of the second embodiment is configured in such a manner that the lever 413b holds its tilted attitude with respect to the base 413a (see FIG. 1). In the control device 413 thus configured, a gear is mounted to rotate integrally with the lever 413b with a rotational axis of the gear conforming to the rotational axis of the lever 413b pivotally mounted to the base 413a, and a rotary damper having a rotational shaft provided with a gear in mesh with the gear rotatable integrally with the lever 413b is fixed to the base 413a. In such a construction, the viscous property of the rotary damper enables the lever 413b to hold its tilted attitude. The specific construction of the control device 413 is identical to that described with reference to FIGS. 5 to 7 (or FIGS. 13 and 14) in the first embodiment, and will not be further described.

In the above constructed chair-type massaging apparatus 1, since the massaging system 406 is motor-driven by plural gears, a delay occurs from when the controller 411 outputs the control signal by the operation of the control device 413 until when the massaging system 406 is driven based on the control signal. Such a delay may cause the user operating the control device 413 to feel discomfort. The chair-type massaging apparatus 1 of the embodiment 2 is directed to eliminating such discomfort, and is devised to control the operation of the massaging system 406 in the forward and backward direction. Below, examples of the control process for controlling the operation of the massaging system 406 in the forward and backward direction will be described. The control process for controlling the operation of the massaging system 406 is executed such that the CPU 420 runs the control program stored in the ROM 422 of the controller 411. As a matter of course, the control configurations in the respective examples may be combined.

### Example 1

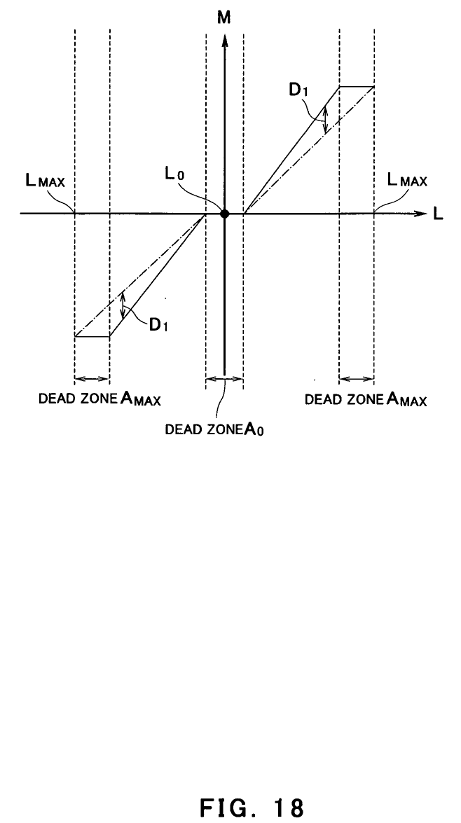

FIG. 18 is a graph showing a configuration of a control process for controlling the operation of the massaging system 406 in the forward and backward direction according to an example 1. In FIG. 18, the relationship between the position (tilting angle) L of the lever 413b and the corresponding target position (pivot angle) M of the massaging system 406 in the forward and backward direction is represented by a solid line. As shown in FIG. 18, dead zones A₀ and A_{MAX} in which the massaging system 406 does not operate are set in a predetermined displacement range of the control device 413b including a neutral position L₀ and a maximum displacement position L_{MAX} of the lever 413b. The maximum displacement position L_{MAX} of the lever 413b includes a maximum forward displacement position of the lever 413b and a maximum backward displacement position of the lever 413b.

By setting the dead zone A_{MAX} including the maximum displacement position L_{MAX} of the lever 413b, difference in displacement between the lever 413b and the massaging system 406 is eliminated in the dead zone A_{MAX}. By way of example, the relationship between the displacement of the lever 413b and actual displacement of the massaging system 406 is indicated by a dotted line in FIG. 18. As should be understood from the solid line and the dotted line in FIG. 18, a difference D₁ between a target position (solid line) of the massaging system 406 corresponding to a position of the lever 413b being operated and an actual position (dotted line) of the massaging system 406 is eliminated while the lever 413b is being displaced in the dead zone A_{MAX} including the maximum displacement position L_{MAX}. Therefore, continued operation of the massaging system 406 is inhibited after the lever 413b is stopped. As a result, discomfort which may be felt by the user is reduced.

Furthermore, by setting the dead zone A₀ including the neutral position L₀ of the lever 413b, it becomes unnecessary to precisely set the neutral position of the lever 413b. As a result, it is possible to avoid unexpected operation of the massaging system 406 which may result from an inadvertent slight contact to the lever 413b.

### Example 2

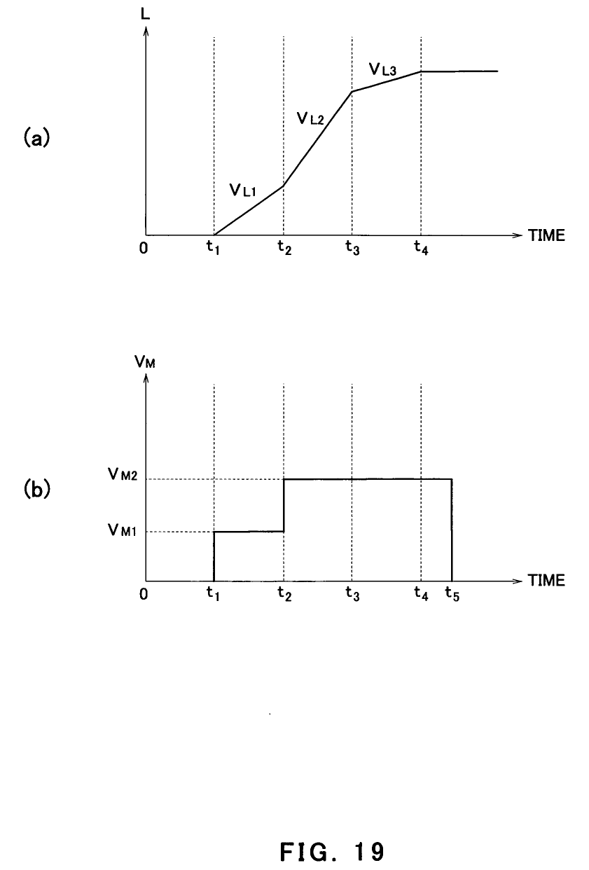

FIGS. 19(a) and 19(b) are graphs showing a configuration of a control process for controlling the operation of the massaging system 406 in the forward and backward direction according to an example 2. FIG. 19(a) illustrates a position (tilting angle) L of the displacing lever 413b with respect to a time axis and FIG. 19(b) illustrates a corresponding target displacement speed (pivot speed) V_{M} of the massaging system 406 in the forward and backward direction with respect to the time axis. As shown in FIG. 19(a), the lever 413b starts to be displaced at a constant speed V_{L1} at time t₁ and then is accelerated at time t₂ to be displaced at a constant speed V_{L2} (>V_{L1}) to time t₃. Then, the lever 413b is decelerated at time t₃ to be displaced at a constant speed V_{L3} (<V_{L2}) and stops at time t₄.

On the other hand, as shown in FIG. 19(b), the massaging system 406 is displaced at a constant speed V_{M1} during a time period from t₁ to t₂ and then is displaced at a constant speed V_{M2} (>V_{M1}) from time t₂ at which displacement of the lever 413b is accelerated to time t₃. Thereafter, the massaging system 406 keeps the speed V_{M2} without deceleration at time t₃ and time t₄ at which displacement of the lever 413b is decelerated. After the lever 413b stops at time t₄, the massaging system 406 stops at time t₅ at which the massaging system 406 reaches a target position corresponding to the stop position of the lever 413b. During this time, the massaging system 406 changes the speed V_{M} (V_{M1}, V_{M2}) in the form of steps.

In this manner, the massaging system 406 is configured to change the speed in such a manner that the speed is accelerated only when the displacement of the lever 413b is accelerated (time t₁, time t₂) but is not decelerated according to the deceleration of the lever 413b (time t₃, time t₄). For this reason, the massaging system 406 is able to be displaced at a speed equal to a maximum speed before the lever 413b being displaced stops, after the stop, and to reach a target position in a short time period (time t₄ to time t₅). Therefore, a delay of the displacement of the massaging system 406 with respect to the lever 413 is substantially reduced. As a result, discomfort which may be felt by the user is reduced.

### Example 3

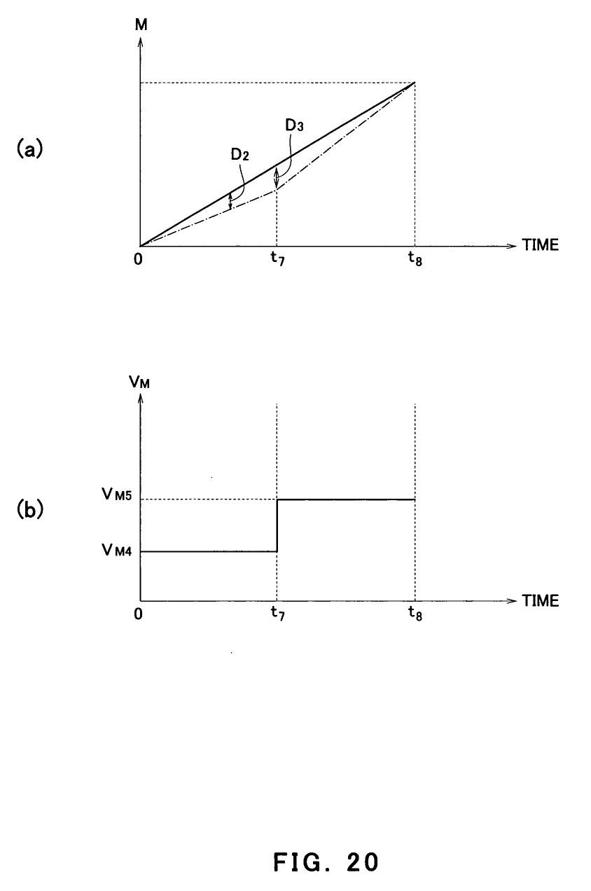

FIGS. 20(a) and 20(b) are graphs showing a configuration of a control process for controlling the operation of the massaging system 406 in the forward and backward direction according to an example 3. In FIG. 20(a), an example of a time lapse variation of a target position (pivot angle) M of the massaging system 406 in the forward and backward direction with respect to a position (tilting angle) of the lever 413b is represented by a solid line, and an example of an actual time lapse variation of the position of the massaging system 406 is represented by a dotted line. FIG. 20(b) illustrates a time lapse variation in a displacement speed of the massaging system 406 so as to correspond to the time lapse variations in FIG. 20(a).

As can be seen from FIG. 20(b), the massaging system 406 is displaced at a speed V_{M4}. As can be seen from FIG. 20(a), there is a difference (difference value) D₂ between the time lapse variation (solid line) of the target position of the massaging system 406 and the actual time lapse variation of the position of the massaging system 406. In this example, when the difference D₂ reaches a predetermined threshold D₃ (time t₇), the massaging system 406 is accelerated, and its speed changes from V_{M4} to V_{M5} in the form of a step as shown in FIG. 20(b).

When the difference (difference value) between the target position and the actual position of the massaging system 406 reaches the predetermined threshold D₃ according to the displacement of the lever 413b, the speed of the massaging system 406 is forcibly increased to reduce the difference to a predetermined threshold or less. As a result, a delay of the displacement of the massaging system 406 with respect to the lever 413 is substantially reduced.

### Example 4

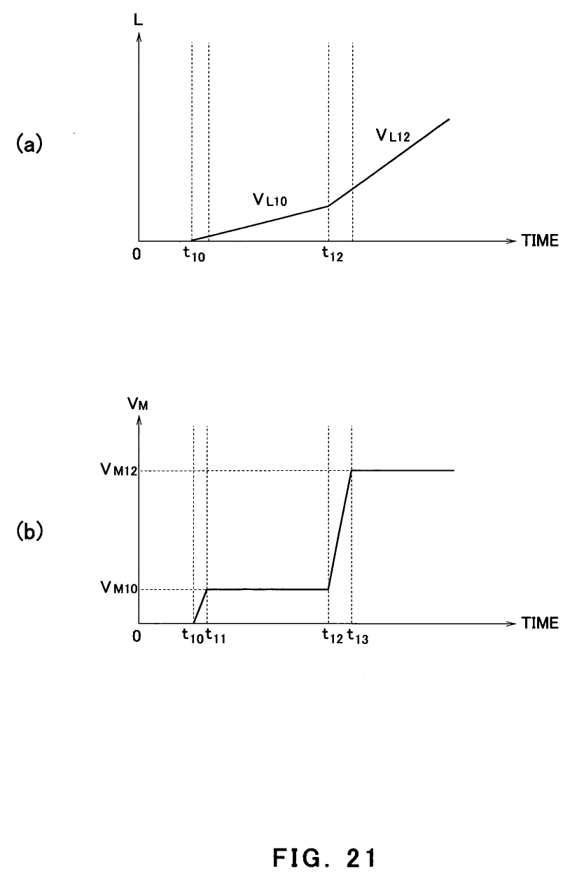

FIGS. 21(a) and 21(b) are graphs showing a control process for controlling the operation of the massaging system in the forward and backward direction according to an example 4, in which FIG. 21(a) shows a position (tilting angle) L of the lever 413b and FIG. 21(b) shows a corresponding target displacement speed (pivot speed) V_{M} of the massaging system 406 in the forward and backward direction, with respect to the time axis. As can be seen in FIG. 21(a), the lever 413b starts to be displaced at a constant speed V_{L10} and thereafter is accelerated at time t₁₂ to be displaced at a constant speed V_{L12} (>V_{L10}).

In contrast, as shown in FIG. 21(b), the massaging system 406 does not operate at a displacement speed V_{M10} corresponding to the displacement speed V_{L10} of the lever 413b immediately after the time t₁₀ but gradually increases its speed during a short time period from t₁₀ to t₁₁ up to V_{M10} which is a target displacement speed. Likewise, the massaging system 406 does not operate at a displacement speed V_{M12} corresponding to the displacement speed V_{L12} of the lever 413b immediately after the time t₁₂ at which the speed of the lever 413b is increased, but gradually increases its speed from the displacement speed V_{M10} up to V_{M12} which is a target displacement speed during a short time period from t₁₂ to t₁₃.

In this configuration, since the massaging system 406 operates to gradually increase its displacement speed when the speed of the lever 413b changes, excess impact is not applied to a back of the user. As a result, discomfort felt by the user is reduced.

A ratio of an increase in the speed of the massaging system 406, i.e., acceleration d (V_{M})/dt is determined using, as a gain, the displacement speed (V_{L}) of the lever 413b before the speed increases or the displacement speed (V_{M}) of the massaging system 406 before the speed increases. For example, when a coefficient is C₁, acceleration d (V_{M})/dt may be determined by a formula (1), a formula (2) or a combination of these formulae (1) and (2):

d(V_{M})/dt=C₁·V_{L}² (1)

d(V_{M})/dt=C₁·V_{M}² (2)

d(V_{M})/dt=C₁·V_{L}·V_{M} (3)

Alternatively, the acceleration d (V_{M})/dt may be determined using, as a gain, a difference value (ΔV_{L}) of the target displacement speed of the lever 413b before and after the speed increases or a difference value (ΔV_{M}) of the target displacement speed of the massaging system 406 before and after the speed increases. In this case, for example, when a coefficient is C₂, acceleration d (V_{M})/dt may be determined by a formula (4), a formula (5) or a combination of these formulae (4) and (5):

d(V_{M})/dt=C₂·ΔV_{L} (4)

d(V_{M})/dt=C₂·ΔV_{M} (5)

d(V_{M})/dt=C₂·ΔV_{M}·ΔV_{M} (6)

### Example 5

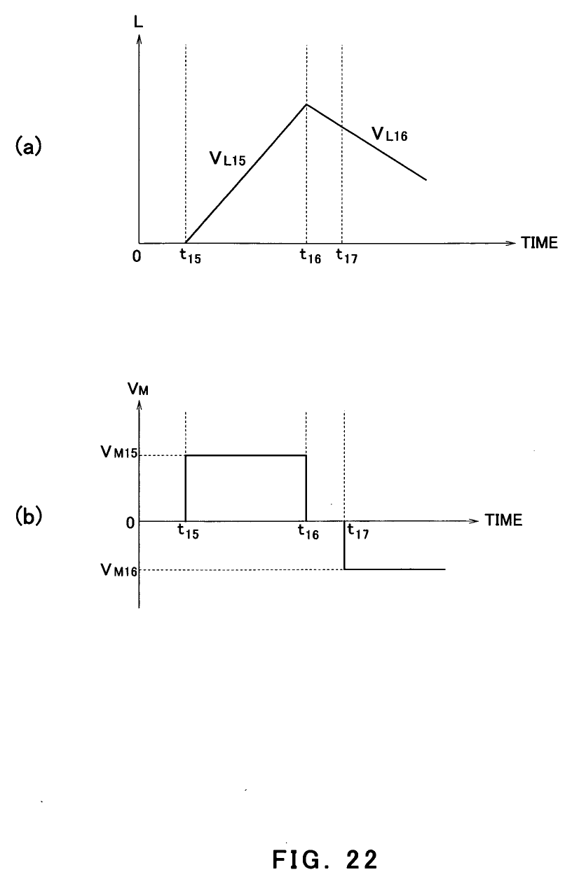

In the examples 1 to 4 described above, the control process for controlling the operation of the massaging system 406 when the lever 413b is displaced in one direction has been described. Now, a control process according to an example 5 for controlling the operation of the massaging system 406 in the case where the lever 413b is switched from one direction to an opposite direction will be described with reference to FIGS. 22(a) and 22(b). The control process of the example 5 may be combined with the examples 1 to 4. FIGS. 22(a) and 22(b) are graphs showing the control process for controlling the operation of the massaging system 406 in the forward and backward direction according to the example 5, in which FIG. 22(a) shows a position (tilting angle) of the lever 413b and FIG. 22(b) shows a corresponding target displacement speed of the massaging system 406 in the forward and backward direction, with respect to the time axis.

As can be seen from FIG. 22(a), the lever 413b starts to be displaced in one direction (e.g., forward) at a constant speed V_{L15} at time t₁₅, and thereafter reverses the displacement direction at time t₁₆ to be displaced in the opposite direction (e.g., backward) at a constant speed V_{L16}. In contrast, as can be seen from FIG. 22(b), the massaging system 406 starts to be displaced in one direction (e.g., forward) at a constant speed V_{M15} at time t₁₅ according to the displacement of the lever 413b, and thereafter is stopped at time t₁₆ at which the displacement direction of the lever 413b reverses. At time t₁₆, the actual position of the massaging system 406 is slightly delayed in time with respect to a target position corresponding to the position of the lever 413b at time t₁₆.

Then, after the lever 413b starts to displaced in the opposite direction, the actual position of the massaging system 406 coincides with the target position of the massaging system 406 corresponding to the position of the lever 413b at time t₁₇. At time t₁₇, the massaging system 406 starts to operate again according to the displacement of the lever 413b to be displaced at a constant speed V_{M16} in the opposite direction (e.g., backward).

In such a configuration, discomfort that may be felt by the user occurring when the displacement direction of the lever 413b is switched is reduced. To be specific, as described above, the actual position of the massaging system 406 corresponding to the position of the lever 413b being displaced is slightly delayed relative to the target position of the massaging system 406. If the control process mentioned in this example is not executed, then the massaging system 406 is likely to move by the delay in the direction before switching even after the displacement direction of the lever 413b has been switched. In that case, the lever 413b and the massaging system 406 are displaced in opposite directions, causing discomfort that may be felt by the user.

In contrast, in the configuration of this example, since the operation of the massaging system 406 stops when the displacement direction of the lever 413b is switched, there is no mismatch in displacement direction between the lever 413b and the massaging system 406. After the switching, at the time point when the target position and the actual position of the massaging system 406 match, the massaging system 406 re-starts the operation according to the displacement of the lever 413b. As a result, a delay of the operation of the massaging system 406 is inhibited.

### Example 6

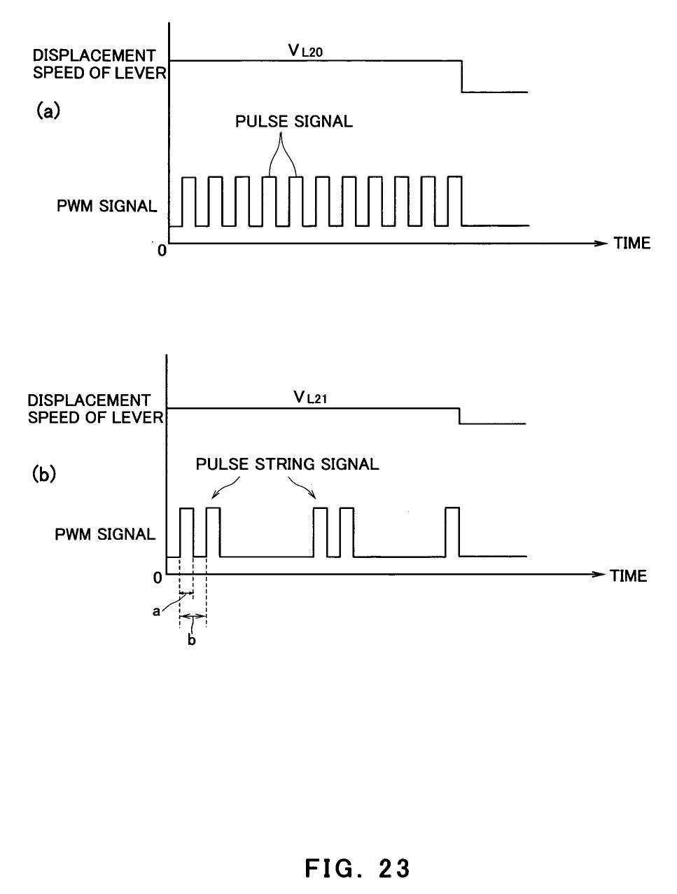

Now, a control process for driving the motor 436 (see FIG. 16) configured to cause the massaging system 406 to move forward and backward in the case where the lever 413b is displaced at a very low speed will be described. FIGS. 23(a) and 23(b) are graphs showing a time lapse variation in the displacement speed of the lever 413 and a PWM signal input to the motor 436, in which FIG. 23(a) shows that the lever 413b is displaced at a low speed, and FIG. 23(b) shows that the lever 413 is displaced at a very low speed.

As can be seen from FIG. 23(a), when the lever 413b is displaced at a normal low speed (V_{L20}), a PWM signal including pulse signals with a predetermined duty ratio is continuously input to the motor 436, and the massaging system 406 is displaced at the corresponding constant speed. On the other hand, as can be seen from FIG. 23(b), when the lever 413b is displaced at a very low speed (V_{L21}), a pulse string signal including one or a plurality of pulse signals is periodically (intermittently) input to the motor 436.

In more detail, even when the duty ratio of the pulse signals is set to a minimum value with which the motor 436 is able to start-up, an actual displacement speed of the massaging system 406 may in some cases exceed a target displacement speed if the PWM signal including the pulse signals with the duty ratio is continuously input to the motor 436. This phenomenon takes place when an activation torque of the motor 436 is above a drive torque in a steady state. In this case, every time when the actual position reaches the target position, the massaging system 406 stops. But, the massaging system 406 re-starts after an elapse of a time interval because the lever 413b is being displaced. As a result, the massaging system 406 operates intermittently.

Accordingly, in this example, the intermittent operation of the massaging system 406 during the very low speed operation of the lever 413b is inhibited as described below. To be specific, the pulse signal input to the motor 436 is set to a duty ratio (a/b) with which a minimum torque required to at least start-up the motor 436 is ensured. The control process for driving the motor 436, which is a feature of this example, is carried out when the drive torque of the motor 436 to maintain the target displacement speed of the massaging system 406 is smaller than the start-up torque of the motor 436, and the pulse string signal including one or a plurality of pulse signals is output from the drive circuit 431 (see FIG. 16) intermittently at predetermined time intervals (see FIG. 23(b)). As used herein, the term “predetermined time interval” refers to a time interval at which a next pulse string signal is input to the motor 436 before the massaging system 406 operating according to one pulse string signal stops, and is longer than the time interval between the individual pulse signals.

With such a configuration, the displacement speed of the massaging system 406 is reduced greatly while ensuring the start-up torque of the motor 436 configured to drive the massaging system 406. As a result, the above mentioned intermittent operation of the mentioned massaging system 406 is inhibited when the lever 413b is displaced at a very low speed, and thus, discomfort felt by the user is reduced.

### Embodiment 3

Now, another embodiment of the present invention will be described.

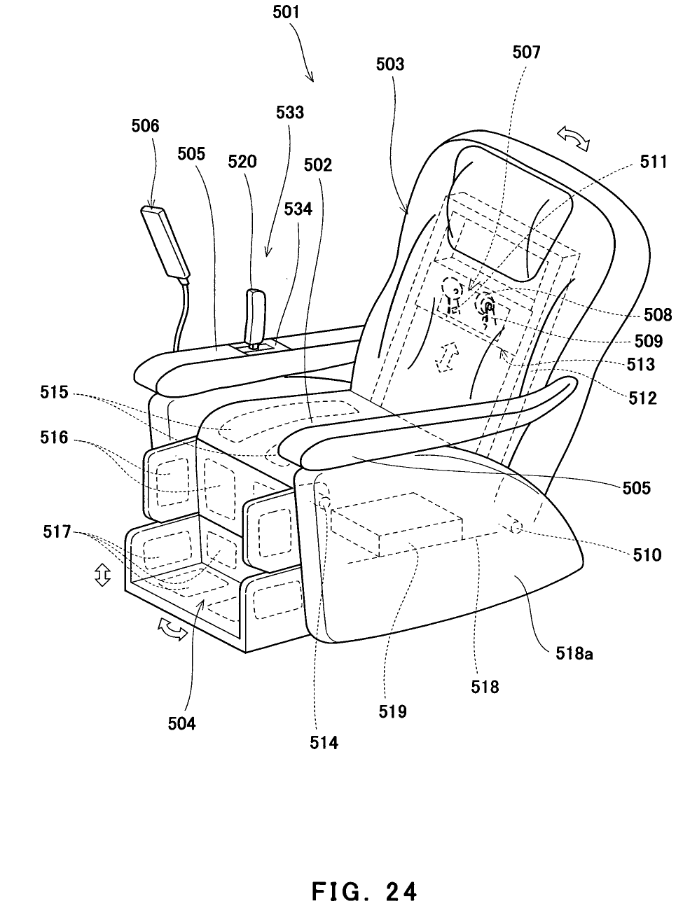

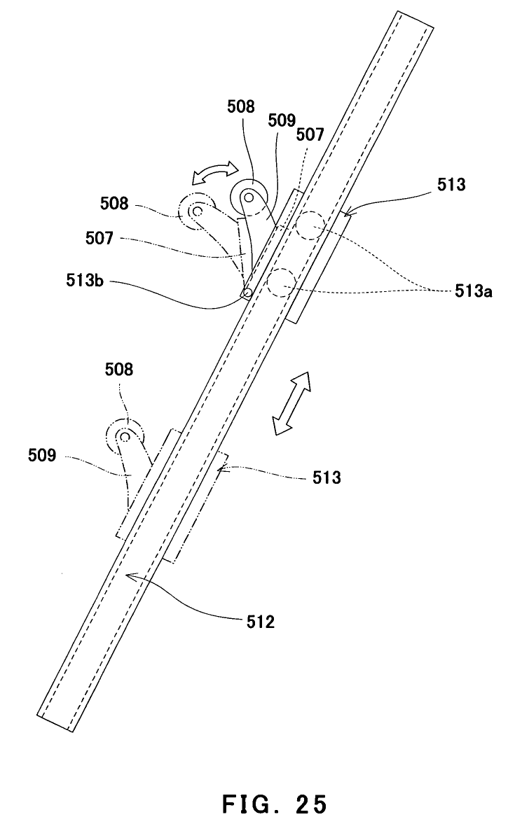

FIG. 24 is a perspective view showing a construction of an entire chair-type massaging apparatus according to a third embodiment of the present invention. FIG. 25 is a side view schematically showing a moving state of a massaging system of the chair-type massaging apparatus of FIG. 24. In this embodiment, a joystick will be described as an example of an operation member of a control device. In the third embodiment, the term “forward and backward and rightward and leftward” means the directions from the perspective of the user seated in the chair-type massaging apparatus 501. For example, the front side refers to forward of the user, the left side refers to leftward of the user, and the right side refers to rightward of the user.

As shown in FIG. 24, the chair-type massaging apparatus 501 of the third embodiment mainly comprises a seat portion 502, a back rest 503, a foot rest (leg rest) 504, and arm rests 505. The seat portion 502 is disposed on an upper region of the base 518 which is supported on a floor by leg portions 518a provided on both sides. A remote control device 506 is located in the vicinity of the arm rest 505. The remote control device 506 is provided with a display portion that displays an operating state of the chair-type massaging apparatus 501. 519 denotes a controller mounted on the base 518.

The back rest 503 provided at a rear region of the seat portion 502 has a substantially rectangular shape that is longitudinally elongated as seen in a front view and is supported at a lower end portion thereof on the base 518 by a support shaft 510 extending laterally at the rear region of the seat portion 502. The back rest 503 is rotatable around the support shaft 510 and is able to recline forward and backward. A massaging system 507 including massaging elements 508 is mounted in the interior of the back rest 503 and is configured to apply stimulation to the back of the user seated.

The massaging system 507 includes a plurality of (in FIG. 24, two on the right and left sides) roller-shaped massaging elements 508 configured to apply mechanical stimulation to the body of the user. The massaging elements 508 are attached to tip ends of right and left arms 509 positioned forward at the massaging system 507. The respective arms 509 cause the massaging elements 508 to perform the kneading operation and the tapping operation by a drive system mounted to the massaging system 507. Each arm 509 is provided with a vibrator 511 which is configured to vibrate the massaging element 508. As shown in FIG. 24, the massaging system 507 is mounted on an up-down base 513 that is guided by guide rollers 513a to be vertically movable along rails 512 provided at right and left end portions of the back rest 503. This enables the massaging system 507 including the massaging elements 508 to move vertically. As shown in FIG. 25, the massaging system 507 is pivotable forward around a support 513b of the up-down table 513, thereby enabling the massaging elements 508 to be pushed forward.

As shown in FIG. 24, the foot rest 504 is constructed in such a manner that its upper end is supported by a support shaft 514 provided at a lower region of a front end of the seat portion 502 and its lower end is movable closer to or away from the base 518. This enables the angle of the foot rest 504 to be adjusted such that the lower end of the foot rest 504 is tilted forward. The foot rest 504 has, for example, a slide mechanism to enable the lower end of the foot rest 504 to be closer to and away from the support shaft 514. This enables the foot rest 504 to adjust a distance between the support shaft 514 and the lower end of the foot rest 504. A massaging device such as a vibrator (not shown) configured to apply vibration, is mounted to a lower end portion of the foot rest 504 to be able to apply massage to a foot sole of the user.

Furthermore, the seat portion 502 is provided with air bags 515 that are expandable and contractable to press a thigh or a hip of the user. The foot rest 504 is provided with air bags 516 that are expandable and contractable to press calves and air bags 517 that are expandable and contractable to press feet. The configuration of these air bags 515, 516, and 517 is exemplary, and the number of or placement of these air bags are not intended to be limited to those of this embodiment.

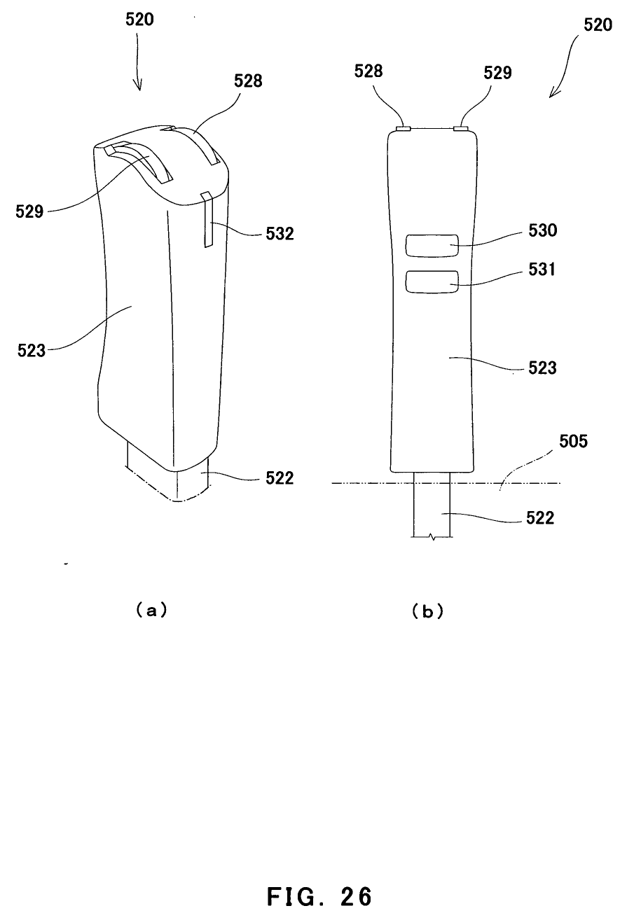

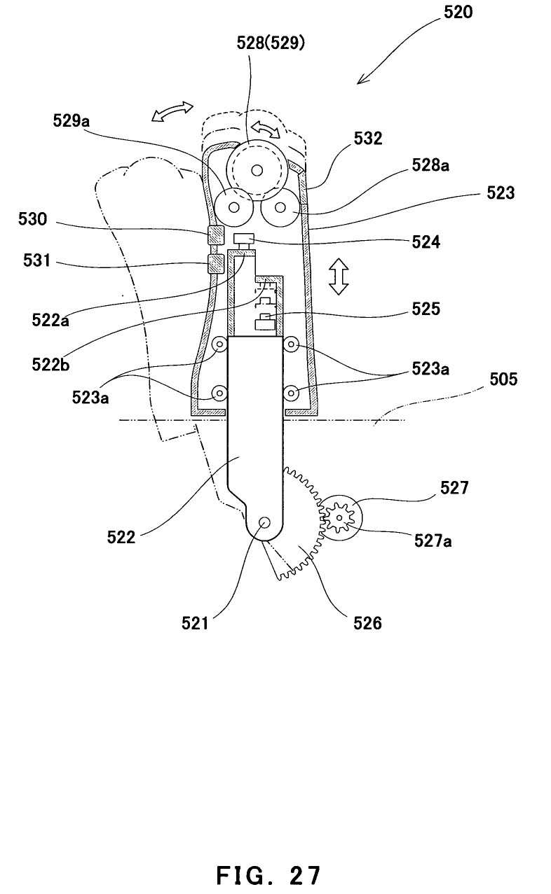

FIGS. 26(a) and 26(b) are views showing a joystick which is an example of the operation member of the control device of the chair-type massaging apparatus of FIG. 24, in which FIG. 26(a) is a perspective view from the back side and FIG. 26(b) is a front view. FIG. 27 is a longitudinal sectional view schematically showing an internal mechanism of the joystick of FIG. 26.

As shown in FIG. 27, the joystick 520 includes a guide member 522 that is rotatably mounted on a support shaft 521 of the arm rest 505 and a joystick body 523 that is guided vertically by guide rollers 523a. The joystick body 523 is provided with limit switches 524 and 525 configured to respectively contact contacting plates 522a and 522b arranged in step form on an upper region of the guide member 522. As indicated by a solid line in FIG. 27, the joystick body 523 is located in a lower position, in which the limit switch 524 is in contact with the contact plate 522a. As indicated by a dashed line in FIG. 27, the joystick body 523 is located in an upper position in which the limit switch 525 is in contact with the contact plate 522b. As indicated by a dotted line in FIG. 27, the joystick body 524 is in a neutral position. The limit switches 524 and 525 are configured to detect the upper position and the lower position of the up-down movement of the joystick body 523. The limit switches 524 and 525 may be replaced by potentiometers to detect the up and down positions of the joystick body 514. In FIG. 27, the joystick 520 is tilted to a foremost position as indicated by a two-dotted line.

A semicircular gear 526 is mounted on a lower end of the guide member 522 and is configured to rotate integrally with the guide member 522. The gear 526 is in mesh with a pinion gear 527a of the potentiometer 527 attached on the arm rest 505. The potentiometer 527 is configured to detect a rotational angle of the joystick 520.

Circular speed control elements 528 and 529 are mounted on an upper region of the joystick body 523 and are configured to be rotated in the forward and backward direction. In the third embodiment, in FIG. 26(a), the kneading speed control element 528 and the tapping speed control element 529 are located on the right side and on the left side, respectively. The amounts of rotation of the speed control elements 528 and 529 are detected by potentiometers 528a and 529a, respectively. The potentiometers 528a and 529a may be replaced by rotary encoders to detect the amounts of rotation.

Furthermore, reclining operation switches 530 and 531 are attached on a front surface of the joystick body 523 and are able to be operated with a hand gripping the joystick body 523. The reclining operation switches 530 and 531 are positioned to be able to be operated with an index finger and a middle finger. In this case, by operating the upper reclining operation switch 530 with the index finger, the back rest 503 (FIG. 24) rises up and the foot rest 504 moves down, while by operating the lower reclining operation switch 531 with the middle finger, the back rest 503 (FIG. 24) falls down and the foot rest 504 moves up. The reclining operation by the operation of the upper reclining operation switch 530 and the reclining operation by the operation of the lower reclining operation switch 531 may be reversed.

An LED 532 is attached on an upper region on the user side (rear side) of the joystick body 523. The LED 532 is configured to flash, for example, in the case where the joystick 520 is not in the neutral position in an initial state after a power supply is turned on in order to inform the user that the user must return the joystick 520 to the neutral position prior to the operation of the massaging apparatus. Upon the user returning the joystick 520 to the neutral position, the LED 532 lights up to inform the user that the user is now able to operate the joystick 520. The neutral position of the joystick 520 is detected based on a signal from the potentiometer 527 and the like. It shall be understood that a voice message, for example, “RETURN JOYSTICK TO NEUTRAL POSITION,” may be emitted to inform the user that the user must return the joystick 520 to the neutral position in the case where the joystick 520 is not in the neutral position after the power supply is turned on.

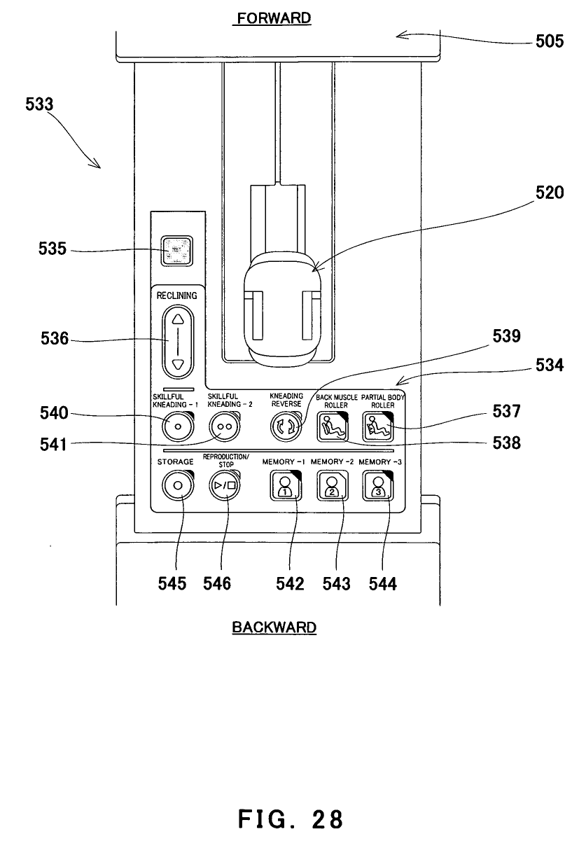

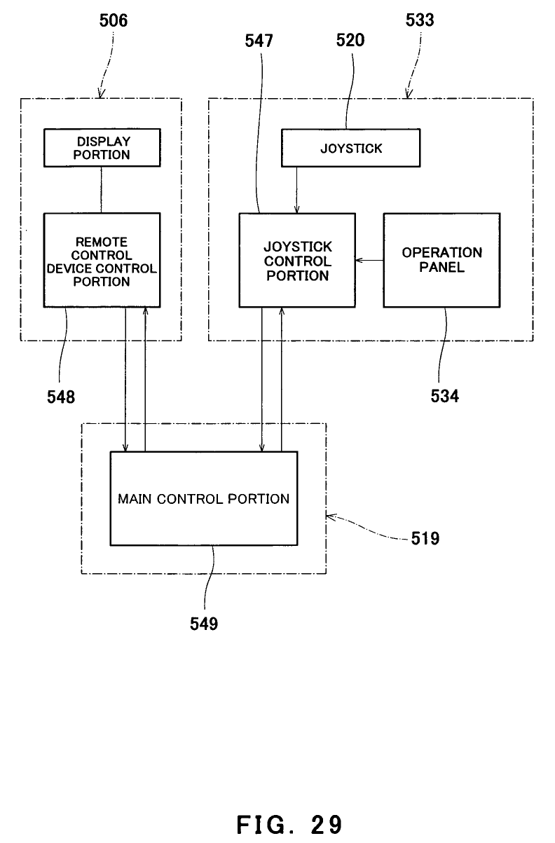

FIG. 28 is a plan view showing a control device of the chair-type massaging apparatus of the third embodiment. While the control device may be attached to a desired position of the chair-type massaging apparatus, it is desirably attached on the right or left arm rest to enable the user to easily operate the control device. FIG. 28 illustrates that the control device is attached on the right arm rest of FIG. 24. In FIG. 28, an upper side in the drawing represents a front side relative to the massaging apparatus and a lower side in the drawing represents a rear side. FIG. 29 is a block diagram of a control circuit including a control circuit of the control device of FIG. 28 and a control circuit of the remote control device 506 of the chair-type massaging apparatus 501.

As shown in FIG. 28, an operation panel (sub-remote control device) 534 of the control device 533 mounted on the arm rest 505 is provided with switches 535 to 546 to select various functions. The functions of the plurality of switches 535 to 546 will be described below. The switches 537 to 541 are massage operation switches to select massage operations. The switches 542 to 546 are switches provided in a storage device configured to store an operation history.

In FIG. 28, the switch 535 is a free-selection course. switch with which the user is able to select desired massage by combining operations of the joystick 520 and the massage operation switches 537 to 541. By operating the free-selection course switch 535, the chair-type massaging apparatus 501 is able to transition from an operation mode by the remote control device 506 to an operation mode in which the operation is controllable by the remote control device 506 and the control device 533 joystick 520 and operation panel 534). The operation panel 534 is provided with a reclining operation switch 536. By pressing a rear side of the reclining operation switch 536, the back rest 503 falls backward and the foot rest 504 moves up, while by pressing a front side thereof, the back rest 503 rises up forward and the foot rest 504 moves down.

The plurality of switches 537 to 546 are arranged in the lateral direction to extend in two-line form on front and rear sides behind the reclining operation switch 536 and the joystick 520. The partial body roller switch 537 provided on a right end in FIG. 28, which is among the massage operation switches 537 to 541 on the front side, is configured to be pressed down to cause the massaging element 508 (FIG. 25) to roll in the vertical direction against a back of the user, for example a part of the back of the user. A back muscle roller switch 538 located on the left side of the partial body roller switch 537 is configured to be pressed down to cause the massaging element 508 (FIG. 25) to roll in the vertical direction against, for example, an entire back of the user. A kneading reverse switch 539 is provided on the left side of the back muscle roller switch 538 and is configured to be pressed down to cause the massaging element 508 to reverse its kneading moving direction.

A skillful kneading-1 switch 540 located at a left end of FIG. 28 is configured to be pressed down to cause the massaging element 508 (FIG. 25) to carry out a kneading operation in a predetermined pattern, for example, three fast kneading operations and one slow kneading operation. A skillful kneading-2 switch 541 located on the right side of the skillful kneading-1 switch 540 is configured to be pressed down to cause the massaging element 508 to carry out a kneading operation in another predetermined pattern.

The switches 542 to 546 which are provided in the storage device on the rear side are such that the memory-1 switch 542, the memory-2 switch 543, and the memory-3 switch 544 which are arranged in the direction from the center to the right, and the storage switch 545 and the reproduction/stop switch 546 are arranged on the left side.

As shown in FIG. 29, the operation panel 534 (switches 537 to 546) shown in FIG. 28 and the joystick 520 are coupled to a joystick control portion 547. An operation signal from the joystick 520 is input to the joystick control portion 547 and an operation signal from the operation panel 534 (FIG. 28) is also input to the joystick control portion 547. The signals from the joystick control portion 547 are input to a main control portion 549 of the controller 519 and are converted into control signals to operate the chair-type massaging apparatus 501.

The signal input to the remote control device control portion 548 by operating the main remote control device 506 (FIG. 24) equipped in the chair-type massaging apparatus 501, is input to the main control portion 549 of the controller 519 (FIG. 24) and is converted into a control signal for causing the chair-type massaging apparatus 501 to operate. The main control portion 549 outputs control signals to the joystick control portion 547 and the remote control device control portion 548. In this case, input signals from the control device 533 joystick 520 and operation panel 534) may be sent to the remote control device 506 (FIG. 24) through the joystick control portion 547 and the main control portion 549 to allow information according to the input signals from the control device 533 to be displayed on a display portion of the remote control device 506.

Each of the control portions 547 to 549 typically includes a CPU, a ROM, a RAM, an input/output interface, etc. In particular, the main control portion 549 includes a flash memory that is able to store a large volume of data, a hard disk, etc.

Examples of the operation of the control device 533 of the chair-type massaging apparatus 501 constructed above will be described below. The illustrated combination is merely exemplary and other combinations may be used. The components described below are identified by reference numerals of FIGS. 24 to 27.

First, a combined operation of the massage operation switch (partial body roller switch 537, back muscle roller switch 538, kneading reverse switch 539, skillful kneading-1 switch 540, skillful kneading-2 switch 541) arranged on the front side of the operation panel 534 of FIG. 28, and the joystick 520 will be described.

### Example 1

Here, a combined operation of the partial body roller switch 537 and the joystick 520 will be described.

When the joystick 520 is operated to move upward while the massaging element 508 is moving up and down within a predetermined range by pressing the partial body roller switch 537, a center of the predetermined range becomes higher, and a moving range of the massaging element 508 is thus changed to include a region to be massaged. During this massage operation, when the joystick 520 is operated to move downward, the center of the moving range of the massaging element 508 becomes lower. Because such operation is carried out by using the joystick 520, the user is able to easily change the center of the massaging element 508 to change a position of “kneading” without mental effort.

### Example 2

Subsequently, a combined operation of the back muscle roller switch 538 and the joystick 420 will be described.

When the joystick 520 is operated to move upward while the massaging element 508 is moving downward by pressing the back muscle roller switch 538, the moving direction of the massaging element 508 reverses, i.e., the massaging element 508 moves upward. Conversely, when the joystick 520 is operated to move downward while the massaging element 508 is moving upward, the massaging element 508 moves downward.

When the joystick 520 is tilted forward while the massaging element 508 is moving in the vertical direction, the massaging system 513 moves toward the user, and thereby the massaging element 508 is pushed toward the user so as to increase a pressing intensity. In this manner, a kneading intensity is increased. Conversely, when the joystick 520 is tilted backward, the massaging element 508 moves away from the user together with the massaging system 513 so as to decrease a pressing intensity. In this manner, the kneading intensity is decreased. Because such operation is carried out by using the joystick 520, the user is able to easily change the direction and pressing intensity of the massaging element 508 to change the direction and intensity of “kneading” without mental effort.

### Example 3

Subsequently, an operation of speed control elements 528 and 529 (FIGS. 26 and 27) will be described.

The speed control elements 528 and 529 attached on an upper surface of the joystick body 523 are configured in such a manner that the kneading speed control element 528 is operated to control the kneading speed of the massaging element 508 and the tapping speed control element 529 is operated to control the tapping speed of the massaging element 508. The speed control elements 528 and 529 are able to be operated with the joystick body 523 held at the neutral position, or when the joystick body 513 is operated to move in the vertical direction or in the forward and backward direction in order to control the operation speed of the massaging element 508. The user may operate the speed control elements 528 and 529 to easily change the speed of the kneading and the speed of the tapping without mental effort.

### Example 4

Subsequently, a combined operation of the skillful kneading switches 540 and 541 and the joystick 520 will be described.

As in the combined operation of the back muscle roller switch 538 and the joystick 520 or the combined operation of the partial body roller switch 537 and the joystick 520, the skillful kneading-1 switch 540 and the skillful kneading-2 switch may be configured to be operated to cause the massaging element 508 to move upward by moving the joystick body 523 upward or configured to be operated to cause the massaging element 508 to move forward to press the user strongly by tilting the joystick body 523 forward, when a preset massage program for performing skillful-1 or skillful-2 is being run. In this case, also, the user is able to easily change the position of the “kneading” by using the joystick 520 without mental effort.

### Example 5

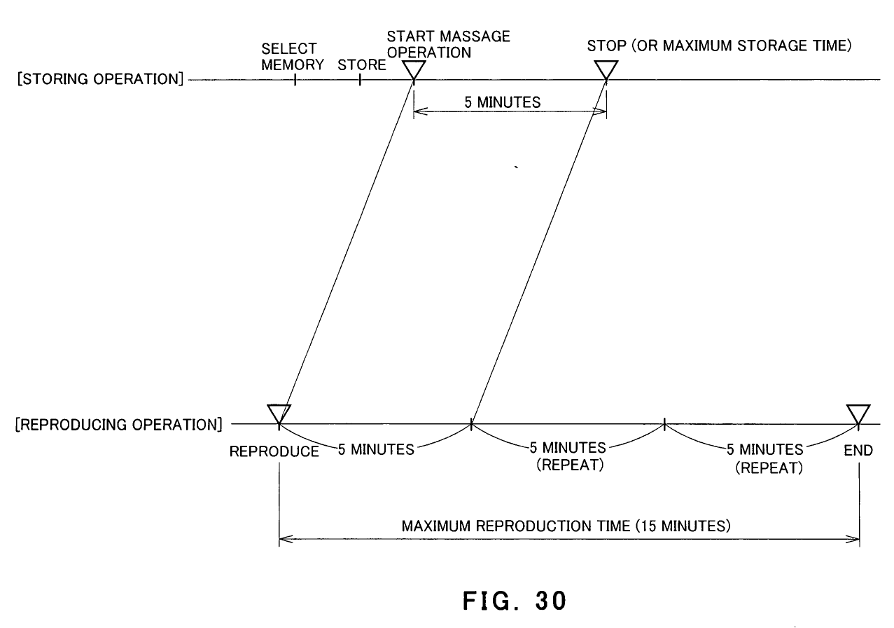

FIG. 30 is a view showing an example of an operation by the control device of the chair-type massaging apparatus of FIG. 28. With reference to FIG. 30, a combined operation of the switches (memory-1 switch 542, memory-2 switch 543, memory-3 switch 544, storage switch 545, and reproduction/stop switch 546) arranged on the rear side of the operation panel 534 in FIG. 28, and the joystick 520 will be described. The memory-1 switch 542, the memory-2 switch 543, and the memory-3 switch 544 are operated (pressed down) to cause operation history data to be stored in a predetermined area of a storage portion (e.g., flash memory, a hard disc, etc, which are provided in the storage device) of the control portion 547 or the main control portion 549. Since the memory-1 switch 542, the memory-2 switch 543, and the memory-3 switch 544 have the same function, the memory-1 switch 542 will be described below.

As shown by the upper side of FIG. 30, after the memory-1 switch 542 is pressed to be selected, the storage switch 545 is operated to start storing data. Thereafter, the joystick 520 and the like is operated to carry out the user's desired massage operation. The history of the massage operation is stored until the reproduction/stop switch 546 is operated or a maximum storing time (e.g., 5 minutes) of the memory is reached. In this embodiment, the histories of the massage operations may be stored into the memory-1 switch 542, the memory-2 switch 543, and the memory-3 switch 544 independently of each other. Also, massage operation history data may be overwritten into these storage portions.

The history of the massage operation stored in the memory-1 switch 542 is reproduced and carried out by operating the reproduction/stop switch 546 after the memory-1 switch 542 is operated (pressed down to be selected) as illustrated on the lower side of FIG. 30. The massage operation history that is able to be stored in the memory-1 switch 542, the memory-2 switch 543, and the memory-3 switch 544 is 5 minutes at maximum, and the stored massage operation is able to be reproduced for, for example, 15 minutes at maximum. For example, when the memory-1 switch 542 in which the massage operation history that is 5 minutes long is operated and then the reproduction/stop switch 546 is operated, the massage operation corresponding to the massage operation history stored in the memory-1 switch 542 is repeated three times (5 minutes×3 times=15 minutes). This time allocation is merely exemplary. For example, when the massage operation history is 3 minutes long, it is able to be reproduced 5 times at maximum (3 minutes×5 times=15 minutes).

### Example 6

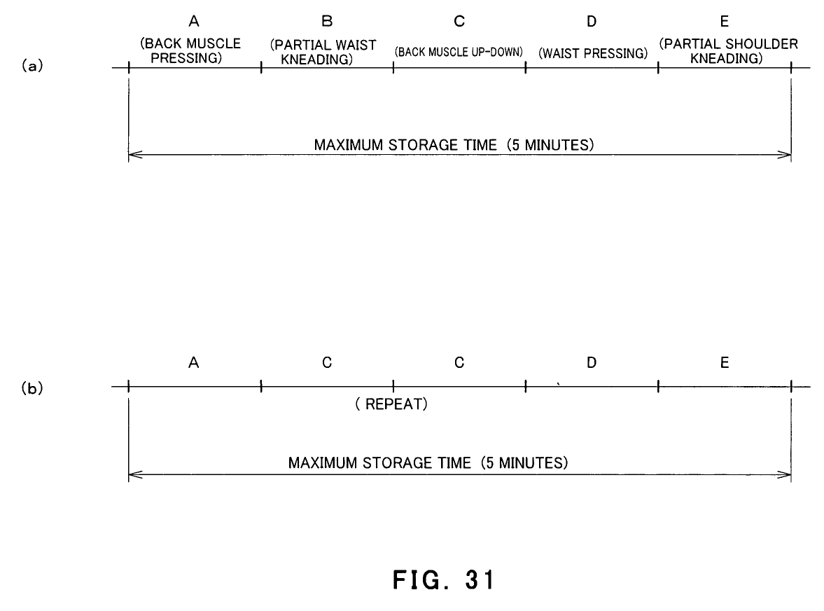

FIGS. 31(a) and 31(b) are views showing another example of the operation of the chair-type massaging apparatus of FIG. 28. This operation example is such that the massage operations of the stored massage operation history are re-combined. By way of example, the massage operation history stored in the memory-1 switch 542 will be described.

As shown in FIG. 31(a), here it is assumed that the massage operation history stored in the memory-1 switch 542 is 5 minutes long at maximum, and the massage operation history includes, for example, A (back muscle push), B (partial waist kneading), C (back muscle up-down), D (waist push), and E (partial shoulder kneading). As shown in FIG. 31(b), the massage operations of the massage operation history thus configured may be re-combined into A (back muscle push), C (back muscle up-down), D (waist push), and E (partial shoulder kneading). The re-combination of the massage operations may be accomplished in such a manner that an unwanted operation is deleted or an operation is repeated every time the massage operation history is reproduced, or otherwise the massage operations are visually displayed on a display portion of the remote control device 506 as shown in FIG. 31.

It shall be understood that the operations of the massage operation switches 537 to 541 and the joystick 520 are merely exemplary, and the functions of the massage operation switches 537 to 541 are merely exemplary. The combination of these or the functions of the massage operation switches 537 to 541 are not intended to be limited to those in this embodiment.

Furthermore, a voice message may be emitted in order to enable the user to correctly operate the respective switches provided on the operation panel 534. If the user operates any of the memory-1 switch 542, the memory-2 switch 543, and the memory-3 switch 544, in which the massage operation history is already stored, then a voice message stating, for example, “ALREADY STORED OVERWRITTEN?” may be emitted. Or, when the user operates any of the storage switch 545 and the reproduction/stop switch 546, a voice message stating which switch should be operated may be emitted. In this case, information indicating the voice message may be displayed on the display portion of the remote control device 506. These functions may be suitably adopted and added to the controller 519.

### Embodiment 4

Now, another embodiment of the present invention will be described.

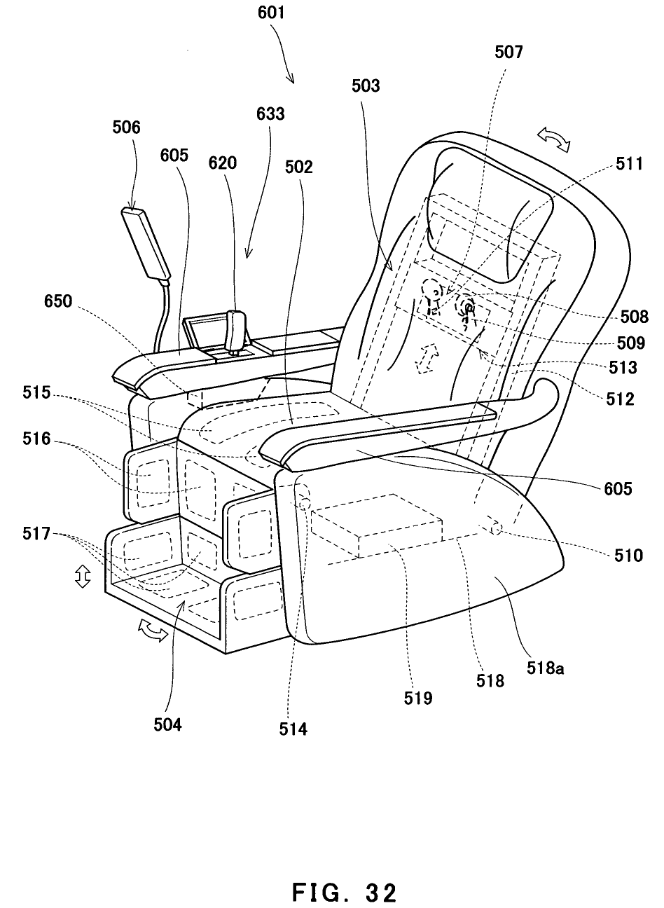

FIG. 32 is a perspective view showing a construction of an entire massaging apparatus according to a fourth embodiment of the present invention. In the embodiment described below, a construction in which a joystick control device which is one example of the control device, is mounted on the right arm rest, will be described.

First, the construction of the chair-type massaging apparatus will be described. Assume that the directions used in the fourth embodiment correspond with the directions used in the third embodiment.

Referring to FIG. 32, a chair-type massaging apparatus 601 includes the seat portion 502, the back rest 503, and the foot rest (leg rest) 504, which have the same configurations as those of the chair-type massaging apparatus 501 of the third embodiment (see FIG. 24). Since the components designated by the same reference numerals in FIG. 32 of the fourth embodiment are already described with reference to FIG. 24, they will not be further described.

The chair-type massaging apparatus 601 of the fourth embodiment is equipped with right and left arm rests 605 having configurations that are different from those of the chair-type massaging apparatus 501 of the third embodiment. A joystick control device 633 having a configuration different from that of the control device 533 of the third embodiment is mounted on the right arm rest 605. In the fourth embodiment, it is assumed that the leg portions 518a that support the base 518 on the floor are included in the base 518.

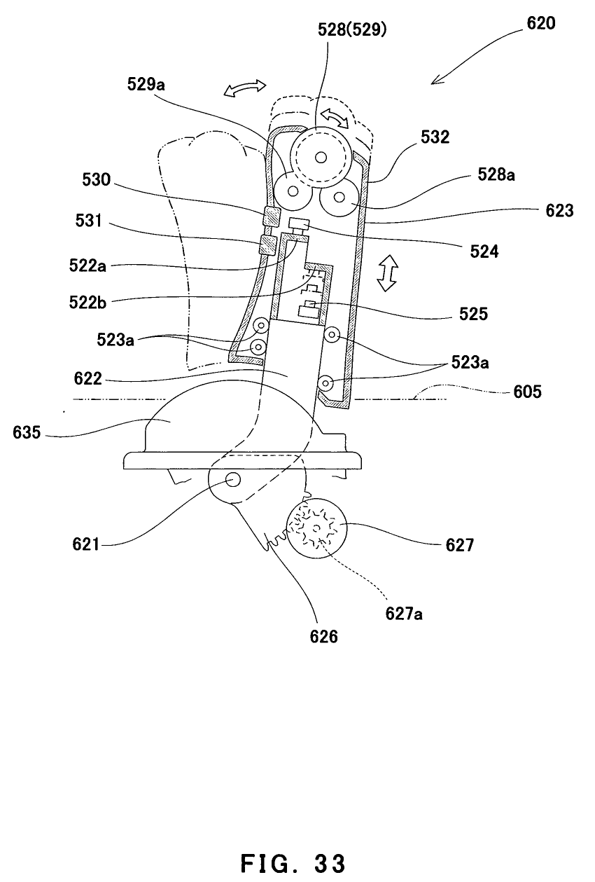

FIG. 33 is a longitudinal sectional view schematically showing an internal construction of a joystick 620 attached to a joystick control device 633 of FIG. 32. Since a number of the components of the joystick 620 are identical to those of the joystick 520 of FIG. 27, they are designated by the same reference numerals and will not be further described.

As shown in FIG. 33, the joystick 620 of this embodiment includes a guide member 622 rotatably attached to a support shaft 621 of a base 635 whose upper surface is of a circular-arc shape as seen in a side view, and a joystick body 623 that is guided in the vertical direction by the guide member 622.

A sector-form gear 626 is mounted on a lower region of the guide member 622 and is configured to rotate integrally with the guide member 622. The sector-form gear 626 is in mesh with a pinion gear 627a of a potentiometer 627 attached to the base 635 side. The potentiometer 627 is configured to detect a rotational angle of the joystick 620.

The joystick body 623 has a circular-arc lower region conforming to an upper surface of the base 635. In other respects, the joystick body 623 is identical in construction and internal structure to the joystick body 523 of FIG. 27.

An external construction of the joystick 620 of the fourth embodiment is illustrated in the perspective view and the front view of FIGS. 26(a) and 26(b) of the third embodiment. Therefore, the joystick 620 of this embodiment is equipped with the speed control elements 528 and 529, the reclining operation switches 530 and 531, and the LED 532 (see FIG. 26).

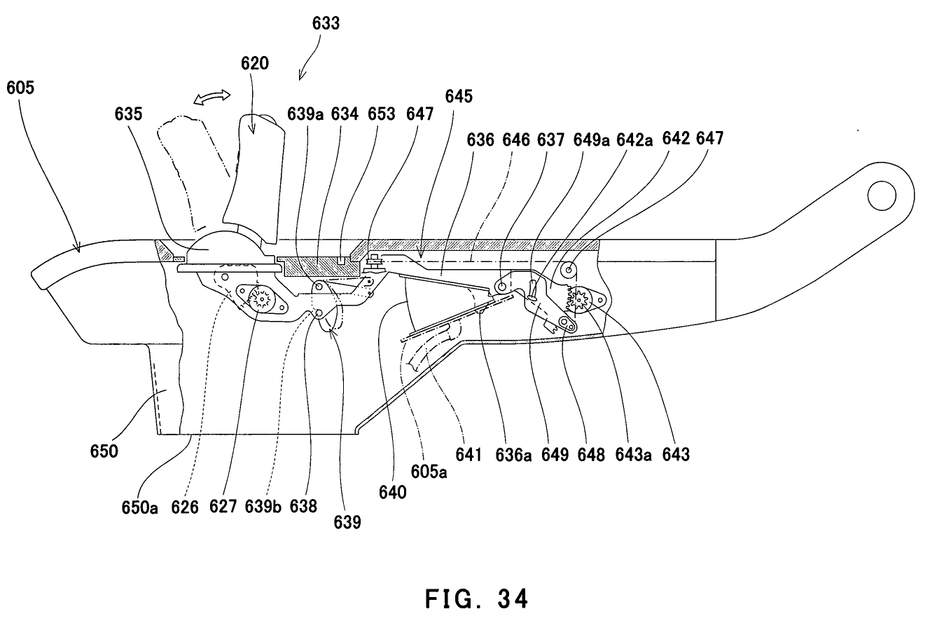

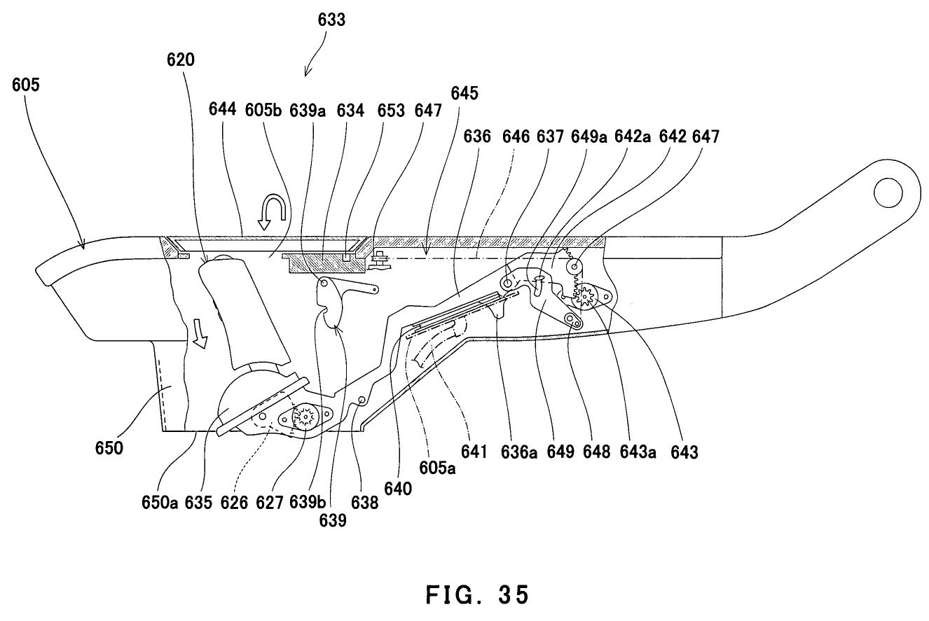

FIG. 34 is a cross-sectional view showing the internal structure of an arm rest 605 with the joystick control device 633 of the chair-type massaging apparatus 601 of FIG. 32 placed in an operation position. FIG. 35 is a cross-sectional view showing an internal structure of the arm rest 605 with the joystick control device 633 of the chair-type massaging apparatus 601 of FIG. 32 stored therein. With reference to these Figures, a configuration in which the joystick 620 is able to be stored in an operating configuration into the interior of the arm rest 605 will be described.

As shown in FIG. 34, the joystick control device 633 is mounted on a front side of the arm rest 605. The joystick control device 633 is equipped with the joystick 620. The joystick 620 is attached to a front end of a pivot arm 636 located in the interior of the arm rest 605. The pivot arm 636 is mounted at a rear region to the arm rest 605 by a support shaft 637. The pivot arm 636 extends forward from a support position, and its front end side is vertically pivotable around the support shaft 637 to cause the joystick 620 to be placed in an operation position of the arm rest 605 as shown in FIG. 34 and to be stored in the interior of the arm as shown in FIG. 35.

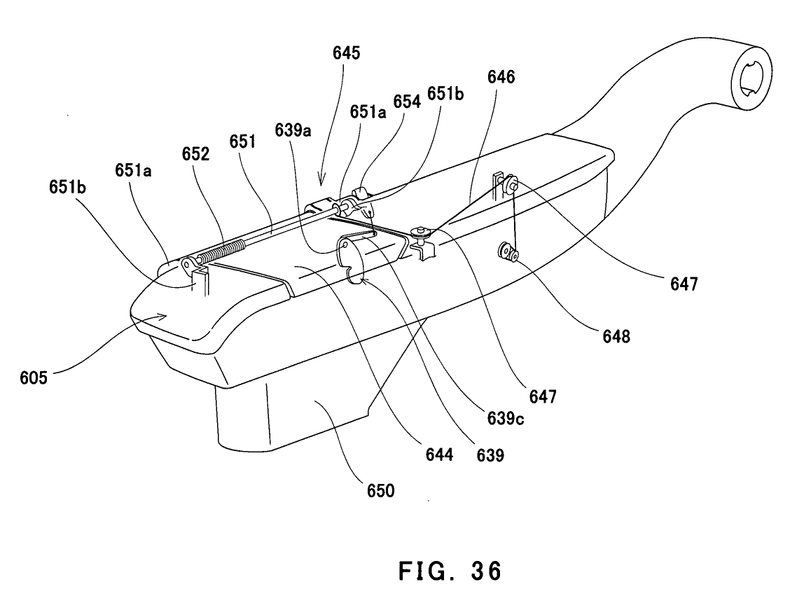

As shown in FIG. 34, with the joystick 620 placed in the operation position, a support pin 638 attached on the pivot arm 636 is stopped by an engagement portion 639b of a stopper 639 pivotally mounted on the arm rest 605 by a holding shaft 639a to allow the joystick 620 to be held in the operation position. In the fourth embodiment, the stopper 639 to hold the pivot arm 636 in the operation position is of a mechanical type. As shown in FIG. 36, the stopper 639 is coupled to a lever 639c at a position of the holding shaft 639a. The lever 639c is coupled at an end portion thereof to an unlock lever 654 attached outside the arm rest 605. The user rotates the unlock lever 654 to outside. This causes the stopper 639 to rotate counterclockwise around the holding shaft 639a together with the lever 639c (see two-dotted line in FIG. 34), causing the engagement portion 639b to release the support pin 638.

In the state illustrated in FIG. 34, the joystick 620 may be tilted forward as indicated by a two-dotted line, or the joystick body 623 is operated to move in the vertical direction, or the speed control elements 528 and 529 (see FIG. 26) may be rotated as shown in FIG. 33. Reference numeral 634 designates an operation panel located in the vicinity of the joystick 620.

In the state illustrated in FIG. 34, also, the pivot arm 636 is pivoted upward by an air bag 640 supported by a support plate 605a attached on the arm rest 605. Thus, the air bag 640 which is an air drive means is provided between the lower region of the pivot arm 636 and the support plate 605a of the arm rest 605 and serves as a drive means configured to place the joystick 620 from the state in FIG. 35 described later into the operation position of the arm rest 605. By supplying the air to the air bag 640, a tip end portion of the pivot arm 636 moves up to cause the joystick 620 to be placed in the operation position. Thus, by driving the pivot arm 636 by using the air drive means, an impact inadvertently externally applied to the joystick 620 when the pivot arm 636 is being driven is able to be absorbed by the air bag 640 filled with a compressive fluid.

The tip end portion of the pivot arm 636 is pivoted upward in such a manner that the guide portion 636a formed in the vicinity of the support shaft 637 of the pivot arm 636 is restricted by the support plate 605a, when the tip end side of the pivot arm 636 is pivoted upward. Thereby, the guide portion 636a is able to guide the pivot arm 636 while inhibiting the pivot arm 636 from being displaced in the width direction (direction perpendicular to the drawing) while the pivot arm 636 is pivoted. Reference numeral 641 designates an air pipe through which compressed air is supplied to the air bag 640.

A sector-form gear 642 is formed integrally with the pivot arm 636 at a location of the pivot arm 636 that is closer to a rear end (rightward in FIG. 34) than the support shaft 637 is and is configured to detect a pivot angle of the pivot arm 636. A potentiometer 643 is attached near the rear of the sector-form gear 642. The sector gear 642 is rotatable around the support shaft 637 in the vertically opposite direction to the pivot operation of the pivot arm 636 while the pivot arm 636 is pivoted, and is in mesh with the pinion gear 643a of the potentiometer 643 attached on the arm rest 605. The potentiometer 643 is a detecting device configured to detect a pivot angle of the pivot arm 636. Based on the angle of the pivot arm 636, how the joystick control device 633 is stored and placed is detectable.

A storage portion 650 forming a space to accommodate the joystick 620 is provided in a lower region of the arm rest 605 on which the joystick control device 633 is mounted, and is configured to protrude downward. An opening 650a is formed at a lower end of the storage portion 650, and is connected to the leg portion 518a (see FIG. 32). Through the opening 650a formed at the lower end of the storage portion 650, a signal is communicated between the joystick control device 633 mounted on the arm rest 605 and the controller 519 (see FIG. 32) mounted on the base 518, or air is supplied to the air bag 640.

As shown in FIG. 35, the joystick 620 is able to be stored in the storage portion 650 in an operating configuration (attitude) in which the joystick 620 is placed in the operation position of FIG. 34. As shown, the joystick 620 is stored in the interior of the arm rest 605. In the fourth embodiment, a front end side of the pivot arm 636 equipped with the joystick 620 is pivoted downward to allow the joystick 620 to be stored into the storage portion 650. The joystick 620 moves slowly with a downward force because of the weight of the joystick 620 and a damper effect produced by the air bag 640 when stored into the storage portion 650. In the fourth embodiment, in order to enable the joystick 620 to be stored into the storage portion 650, the user has only to rotate the unlock lever 654 attached outside the arm rest 605 in a predetermined direction. Upon this operation, the stopper 639 pivotally attached on the arm rest 605 by the holding shaft 639a rotates counterclockwise in FIG. 35, causing the support pin 638 to be released from the stopper 639. Then, the tip end side of the pivot arm 636 is pivoted downward because of the weight of the joystick 620, causing the joystick 620 to be stored into the storage portion 650. At this time, the air is released from the interior of the air bag 640 attached on the lower region of the pivot arm 636 to produce the damper effect. Under this condition, the joystick 620 moves slowly and is stored into the interior of the storage portion 650. The pivot arm 636 and the air bag 640 form a storage system to store the joystick 620 into the storage portion 650.

When the joystick 620 is stored into the storage portion 650, the guide member 636a of the pivot arm 636 is pivoted downward while being restricted by the support plate 605a. A guide pin 642a attached on the sector-form gear 642 is guided along a guide groove 649a of a bracket 649. The guide member 636a and the pin 642a enable the pivot arm 636 to be suitably pivoted.

A lid member 644 is attached over the joystick control device 633 in a stored state. The lid member 644 is provided to cover over an upper region of the control device 633 to form an upper surface of the flat arm rest 605. An open system 645 is mounted in the interior of the arm rest 605 to open the lid member 644. As shown in FIGS. 34 and 35, the open system 645 includes a wire 646 extending in the forward and backward direction behind the lid member 644 and two pulleys 647 attached on the arm rest 605 to convert the direction in which the wire 646 extends. The wire 646 and the two pulleys 647 are located above the pivot arm 636. A wire wind-up member 648 is coupled to an end portion (rear end portion in FIGS. 34 and 35) of the wire 646 which is away from the lid member 644 and is positioned laterally relative to the sector-form gear 642. The wire wind-up member 648 is attached on an end portion of the bracket 649 mounted on the support shaft 637. The guide groove 649a is formed on the bracket 649 to form a circular-arc shape around the support shaft 637 to guide the guide pin 642a.

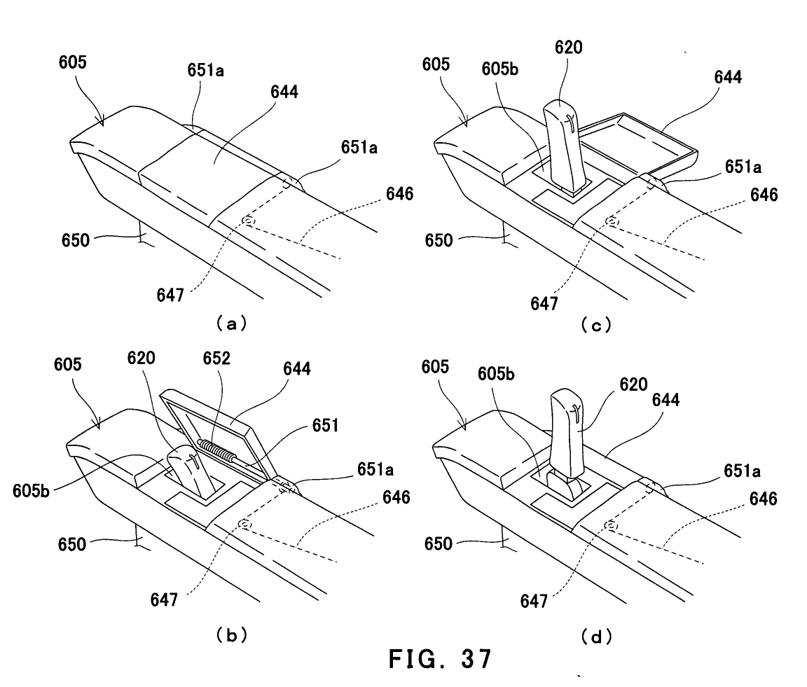

FIG. 36 is a perspective view of the arm rest 605, showing the open system to open the lid member 644 provided over the joystick control device 633 of the chair-type massaging apparatus 601 in FIG. 32 when the joystick control device 633 is stored into the storage portion 605. FIGS. 37(a) to 37(d) are perspective views showing a flow showing how the lid member 644 is opened by the open system of FIG. 36 and how the joystick 620 is placed in the operation position.

As shown in FIGS. 36, 34, and 35, the lid member 644 is attached on the upper region of the joystick control device 633 to cover the control device 633 from above with the joystick 620 stored in the interior of the arm rest 605. The lid member 644 covers the control device 633 attached on the arm rest 605 such that the upper surface of the arm rest 605 is substantially flat.

The lid member 644 is rotated from inward (from the seat portion 502 side) in the rightward and leftward direction of the arm rest 605 toward outward in the rightward and leftward direction and is thereby opened. The lid member 644 is pivotally attached at an outer end portion thereof to the arm rest 605 by a rotational shaft 651. The rotational shaft 651 is supported at both end portions by a shaft holding portion 651a attached outside the arm rest 605. Support brackets 651b are mounted in the interior of the shaft holding portion 651a and are configured to support the end portions of the rotational shaft 651.

The open system 645 is incorporated into the lid member 644 and is configured to, after the lid member 644 is rotated to a predetermined position, to automatically open the lid member 644. The open system 645 includes a spring 652 mounted on the rotational shaft 651, the wire 646 wound by the rotation of the rotational shaft 651, and the wire wind-up member 648 configured to apply a predetermined tension to the wire 646 by the pulleys 647.

The spring 652 is inserted into the rotational shaft 651 supporting the lid member 644. One end portion of the spring 652 is stopped on the arm rest 605 side and an opposite end portion thereof is stopped on the lid member 644 side. The spring 652 is configured to apply a force to open the lid member 644. In contrast, the wire 646 applies the force to the rotational shaft 651 to close the lid member 644.

When the user opens the lid member 644 constructed above, the lid member 644 is opened by the spring 652. The lid member 644 is opened slowly by the spring 652 under the predetermined tension applied from the wire 646. The open operation of the lid member 644 will now be described. As shown in FIG. 37(a), the upper surface of the arm rest 605 forms a flat surface with the lid member 644 closed. Then, as shown in FIG. 37(b), when the lid member 644 is opened, a sensor 653 (illustrated in FIGS. 34 and 35) detects that the lid member 644 has been opened up to a predetermined angle. As shown in FIG. 34, the air is supplied to the air bag 640, which causes the tip end side of the pivot arm 636 to be pivoted upward. Thereby, the joystick 620 protrudes upward from the storage portion 650. At this time, the rotational angle of the pivot arm 636 is detected by the potentiometer 643. Thereafter, as shown in FIG. 37(c), the lid member 644 is further opened, and the pivot arm 636 of FIG. 34 is rotated upward, causing the joystick 620 to protrude from the interior of the arm rest 605 and to move it into the operation position. Then, as shown in FIG. 37(d), the lid member 644 is rotated to outside of the arm rest 605, and the air is supplied to the air bag 640 of FIG. 34 until the joystick 620 is placed in the operation position. The angle of the pivot arm 636 pivoted upward by the air supplied to the air bag 640 is detected by the potentiometer 643, and based on the detection signal, air supply to the air bag 640 is stopped. As shown in FIG. 37(d), placement of the joystick 620 is completed.

As shown in FIG. 35, a rectangular opening 605b is formed on the upper region of the arm rest 605 and under the lid member 644 in a closed state. The opening 605b is connected to an inner space of the storage portion 650. The joystick 620 protrudes outside or is stored into the storage portion 650 through the opening 605b.

In this manner, once the lid member 644 is opened by the user up to the predetermined angle, the lid member 644 is slowly opened to a fully open position, and the pivot arm 636 is pivoted to cause the joystick 620 to protrude from the storage portion 650 of the arm rest 605 into the operation position.

In other words, in this embodiment, the control device 633 is placed in the operation position by manually operating the lid member 644 in the closed state up to the predetermined angle. After that, the following operation takes place automatically. The lid member 644 is slowly opened by the force relationship between the wire 646 and the spring 652. The sensor 653 detects the opening operation of the lid member 644. The air is supplied to the air bag 640 to cause the pivot arm 636 to be pivoted upward, thus enabling the joystick 620 to move upward to be placed in the operation position. As for the sensor 653, a proximity switch or an optical sensor may be used to detect that the lid member 644 has been opened.

In accordance with the control device 633 of the chair-type massaging apparatus 601 constructed above, the joystick 620 is stored into the interior of the arm rest 605 in an operating configuration and the upper region of the arm rest 605 is made flat by the lid member 644 when the joystick 620 is unoperated. Therefore, the user is able to be massaged in a relaxed attitude. Also, when the joystick 620 becomes necessary, the user has only to perform an initial operation to open the lid member 644. After that, the lid member 644 is opened automatically and the joystick 620 is caused to move from the interior of the arm rest 605 into the operation position. Thus, when the user thinks the joystick 620 (control device 633) is unnecessary, the joystick 620 is stored into the interior of the arm rest 605, while when the user desires the massage operation using the joystick 620, the joystick 620 is caused to move from the interior of the arm rest 605 into the operation position to enable the user to enjoy the desired massage operation.

In addition, since the joystick 620 is stored in the operating configuration, it is able to be operated stably without a substantial change in the shape of the joystick 620.

Alternatively, with the joystick 620 placed in the operation position, the joystick 620 may be operated preferentially, while with the joystick 620 stored, the remote control device 506 may be operated preferentially. To operate the joystick 620 preferentially, it may be detected that the joystick 620 is placed in the operation position, or a switch for causing the joystick 620 to operate preferentially may be provided to be operated so that the operation of the joystick 620 is operated preferentially.

In a further alternative, the remote control device 506 may be provided with a display portion that displays an operation state or the like of the joystick 620, or may be equipped with a switch that is operated to store or place the joystick 620.

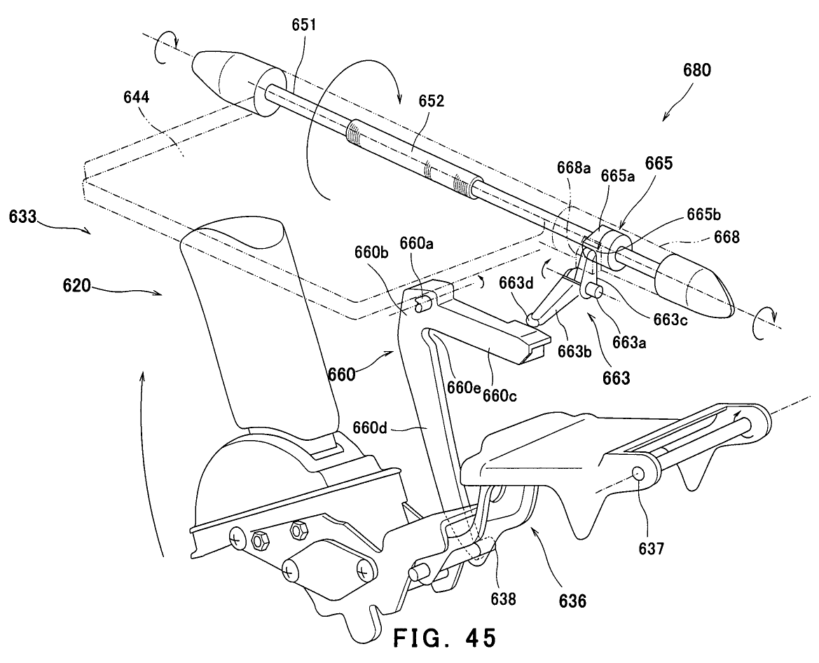

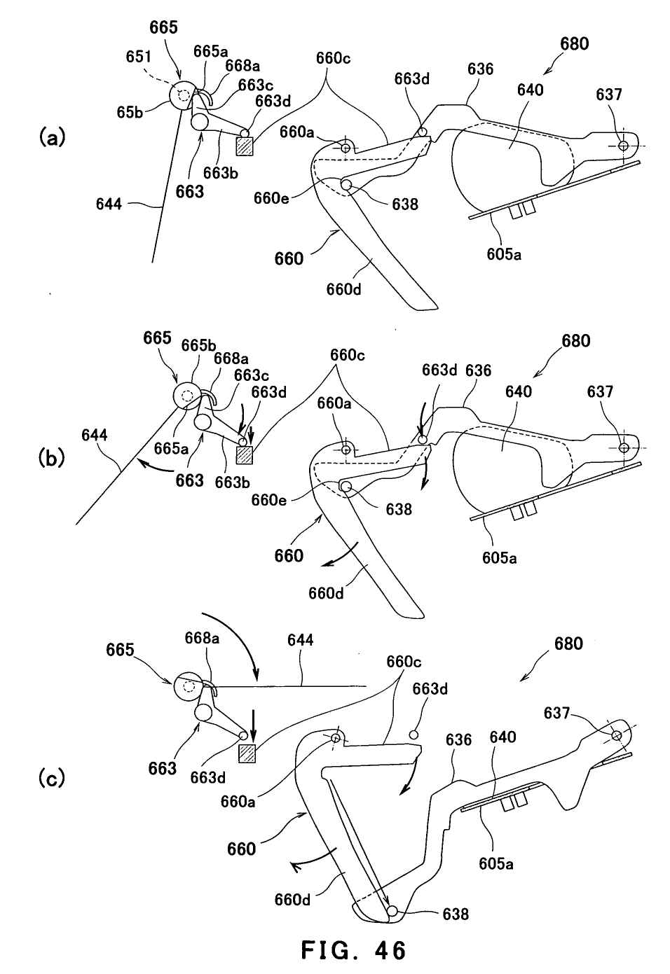

Subsequently, another configuration to place and store the joystick control device 633 will be described with reference to FIG. 45 and FIGS. 46(a) to 46(c). Here, the difference between this configuration and the configuration of FIG. 34 will be in large part will be described. In FIGS. 45 and 46(a) to 46(c), the components identified by the same reference numerals as those used in the foregoing description have the same construction or function, and will not be specifically described. FIG. 45 is a perspective view showing a construction of a storing system 680 in the interior of the arm rest 605 (see FIG. 32) with the joystick control device 633 stored therein. As shown in FIG. 45, the joystick 620 of the joystick control device 633 is attached at a front end region of the pivot arm 636 extending substantially in the forward and backward direction as in the construction described with reference to FIGS. 34 and 35. The pivot arm 636 is rotatably mounted at a rear end portion thereof on the arm rest 605 by the support shaft 637. The support pin 638 protrudes to extend laterally at a substantially center position in the forward and backward direction of the pivot arm 636.

The storing system 680 illustrated in FIG. 45 includes a stopper 660 that is substantially L-shaped in a side view, instead of the stopper of FIG. 34. The stopper 660 includes a bent portion 660b mounted on the arm rest 605 to be pivotable around a pivot shaft 660a, a rod-shaped extending portion 660c extending substantially rearward from the bent portion 660b, and a rod-shaped extending portion 660d configured to extend substantially downward from the bent portion 660b and to contact at a back surface thereof with the support pin 638. An engagement portion 660e is formed at a rear region of an upper end portion of the extending portion 660d and has a cut out shape that is recessed forward in a side view. The engagement portion 660e engages with the support pin 638 of the pivot arm 636 when the pivot arm 636 is pivoted upward around the support shaft 637 and the joystick 620 is placed in the operation position. Thereby, the joystick 620 is placed in the operation position.

A lever 663 is located on an outer side of the extending portion 660c of the stopper 660 and is mounted on the arm rest 605 to be pivotable around a pivot shaft 663a having an axis extending in the forward and backward direction. The lever 663 includes a rod-shaped extending portion 663b extending substantially inward from the pivot shaft 663a, and a rod-shaped extending portion 663c extending substantially upward from the pivot shaft 663a. A contacting sphere 663d is attached at a tip end of the extending portion 663b and is configured to contact an upper surface of a rear end portion of the extending portion 660c of the stopper 660.

The lid member 644 is provided over the arm rest 605 to cover the joystick 620 from above with the joystick 620 stored into the arm rest 605. The lid member 644 is supported by the rotational shaft 651 extending in the forward and backward direction. The rotational shaft 651 is rotatably supported on the arm rest 605. Although not shown in FIG. 45, the open system 645 of FIG. 36 is incorporated into the lid member 644. When the lid member 644 is rotated to a predetermined position, it is slowly and automatically opened thereafter.

A cam 665 is mounted integrally at a rear region of the rotational shaft 651. The cam 665 is substantially cylindrical and its axis conforms to the axis of the rotational shaft 651. The cam 665 has a flat region 665a formed by cutting out a part of a peripheral region thereof. The cam 665 has a curved region 665b extending along the periphery of the flat region 665a. The tip end portion of the extending portion 663c of the lever 663 is in contact with the curved region 665b. A tubular cover 668 covers the outer periphery of the cam 665. A protruding portion 668a is provided on the outer periphery of the cover 668 and has an inner space into which the tip end portion of the extending portion 663c of the lever 663 is stored.

In the storing system 680 of the above constructed joystick control device 633, when the lid member 644 is opened and closed, the cam 665 rotates together with the rotational shaft 651, and the tip end portion of the extending portion 663c of the lever 663 slides on the flat region 665a and the curved region 665b of the cam 665. When the lid member 644 is opened from the closed position to a predetermined rotational angle (e.g., 230 degrees), a contact region of the tip end portion of the extending portion 663c of the lever 663 transitions from the curved region 665b to the flat region 665a, and the lever 663 is pivoted counterclockwise in a front view around the pivot shaft 663a (see an arrow around the pivot shaft 663a in FIG. 45). As a result, the contacting sphere 663d attached at the tip end of the extending portion 636b of the lever 663 moves upward.

When the rotational shaft 651 that supports the lid member 644 rotates, the sensor 653 (see FIG. 34) detects a rotational angle of the rotational shaft 651. When the rotational angle of the rotational shaft 651 reaches a predetermined value, air is supplied to the air bag 640 (see FIG. 46). This causes the pivot arm 636 in a lowermost position to rotate around the support shaft 637, causing the joystick 620 to move upward. When the pivot arm 636 is in the lowermost position, the support pin 638 protruding from the pivot arm 636 is in contact with a back surface of a lower region of the extending portion 660d of the stopper 660. As the pivot arm 636 rotates to move upward, the support pin 638 slides upward on the back surface of the extending portion 660d of the stopper 660. When the joystick 620 reaches the operation position, the support pin 638 is brought into engagement with the engagement portion 660e and is thereby stopped. In this state, the joystick 620 is stably held in the operation position. When the support pin 638 is brought into engagement with the engagement portion 660e, the stopper 660 is pivoted around the pivot shaft 660a. Then, with the support pin 638 engaged with the engagement portion 660e, the extending portion 660c is located on the upper position, and the contacting sphere 663d of the lever 663 contacts the upper surface of the rear end portion of the extending portion 660c (see FIG. 46(a)).

Subsequently, an operation of the storing system 680 that occurs when the joystick 620 is stored into the arm rest 605 will be described with reference to FIG. 46. As described below, the joystick 620 of FIG. 45 is stored into the arm rest 605 merely by closing the lid member 644 without special operation by the user. FIG. 46(a) shows a state in which the joystick 620 is placed in the operation position with the lid member 644 being in a fully open position, FIG. 46(b) shows a state in which the lid member 644 is closed to a position, and FIG. 46(c) shows a state in which the joystick 620 is stored into the arm rest 605 with the lid member 644 being in a fully closed position. In each of FIGS. 46(a) to 46(c), a side view of the storing system 680 is shown on the right side, and a partial cross-sectional front view of the lid member 644, the stopper 660, the lever 663, and the cam 665 is illustrated on the left side. In FIGS. 46(a) to 46(c), the joystick 620 and the like are omitted for the sake of convenience and main operating portions are illustrated.

As shown in FIG. 46(a), with the air bag 640 expanded to its maximum degree and the lid member 644 opened to its maximum degree (in this embodiment, rotated 260 degrees from the closed state), the support pin 638 of the pivot arm 636 is in the uppermost position, and is brought into the engagement portion 660e of the stopper 660 from backward and is thereby stopped. As described above, the upper surface of the tip end portion of the extending portion 660c of the stopper 660 is, from downward, in contact with the contacting sphere 663d attached at the tip end of the extending portion 663b of the lever 663. The tip end portion of the extending portion 663c of the lever 663 is located in the interior of the protruding portion 668a of the cover 668 and is in contact with the flat region 665a of the cam 665 mounted integrally with the rotational shaft 651 of the lid member 644.

Under this condition, for example, when the user rotates the lid member 644 by a predetermined angle (e.g., 30 degrees) in a direction to close the lid member 644, the contact region of the tip end portion of the extending portion 663c of the lever 663 transitions from the flat region 665a to the curved region 665b of the cam 665, and the lever 663 is pivoted clockwise in a front view (see FIG. 46(b)). When the lever 663 rotates, the contacting sphere 663d at the tip end of the extending portion 663b presses down the upper surface of the tip end portion of the extending portion 660c of the stopper 660, causing the stopper 660 to be pivoted around the pivot shaft 660a. Thereby, the engagement portion 660e of the stopper 660 moves forward, causing the support pin 638 of the pivot arm 636 to disengage from the engagement portion 660e.

When the user further rotates the lid member 644 in the direction to close the lid member 644, and it is detected that the support pin 638 is in engagement during this rotation, the air is caused to outflow from the air bag 640 after an elapse of about 10 seconds. Alternatively, the air may be caused to outflow from the air bag 640 when the sensor 653 (see FIG. 34) detects that the rotational angle of the lid member 644 reaches a predetermined angle. While in this embodiment, the air is caused to outflow naturally by the gravitational force from the pivot arm 636, it may alternatively be forced to outflow by a pump so long as the air outflows at a slow speed so as not to apply an impact on the joystick 620 or the like when the joystick 620 is moving into the arm rest 605 for storage.

When the air starts to outflow from the air bag 640, the pivot arm 636 is pivoted around the support shaft 637 and the joystick 620 moves downward because of its weight. The support shaft 637 is suitably provided with, for example, a damper to reduce the speed of the downward movement of the joystick 620. While in this embodiment, the damper is mounted coaxially with the input shaft of the potentiometer 643 illustrated in FIG. 33, it may alternatively be mounted in other positions, or the potentiometer 643 may be configured to have a damper function. It shall be understood that, regarding the pivot arm 636 illustrated in FIG. 33, the damper may be mounted coaxially with the input shaft of the potentiometer 643 or in other positions, or the potentiometer 643 may be configured to have a damper function to reduce the operation speed of the pivot arm 636. In a further alternative, the speed of the downward movement of the joystick 620 may be reduced by reducing a dimension of an outflow outlet of the air bag 640. During the downward movement of the joystick 620, the support pin 638 of the pivot arm 636 moves downward while sliding on the back surface of the extending portion 660d of the stopper 660. When air outflow from the air bag 640 is substantially completed, the pivot arm 636 contacts the support plate 605a (see FIG. 34) mounted in the interior of the arm rest 605 and is thereby stopped. The support pin 638 is in contact with the back surface of the lower end portion of the extending portion 660d of the stopper 660 (see FIG. 45). Under this condition, the joystick 620 is entirely stored into the arm rest 605 (see FIG. 46(c)).

Thus, in accordance with the above mentioned storing system 680, the user has only to close the lid member 644 without special operation to enable the joystick 620 to be stored into the arm rest 605. The stopper 660 is pressed by the support pin 638 to be pivoted around the pivot shaft 660a, and thereby the extending portion 660c moves downward, while the extending portion 663c of the lever 663 is pivoted in a limited range in the inner space of the protruding portion 668a of the cover 668, and the extending portion 663b is unable to move downward from a predetermined position. Therefore, in the state in which the joystick 620 is stored into the arm rest 605, the extending portion 660c of the stopper 660 is distant from the contacting sphere 663d of the lever 663 (see FIG. 46(c)).

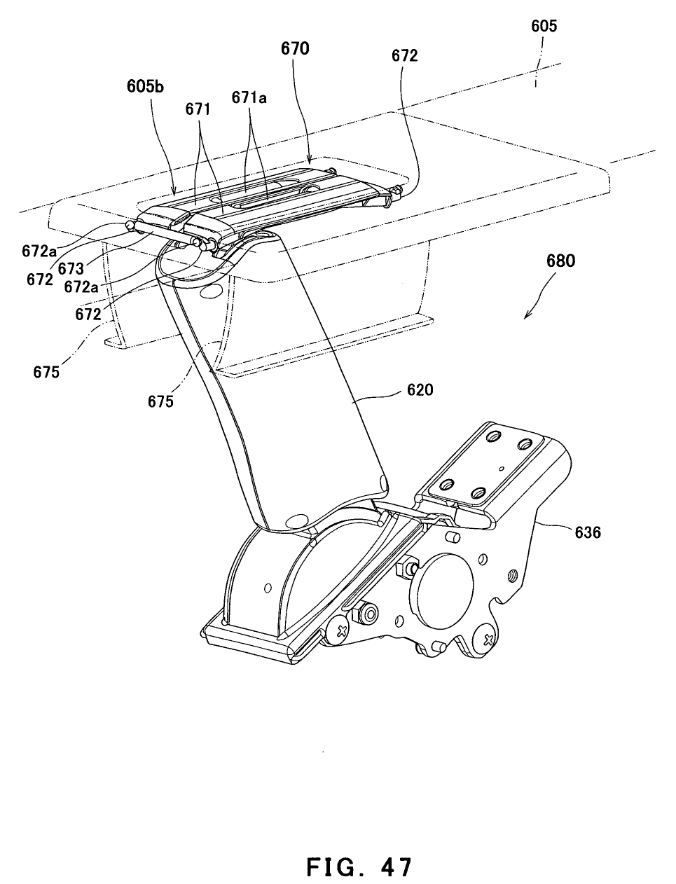

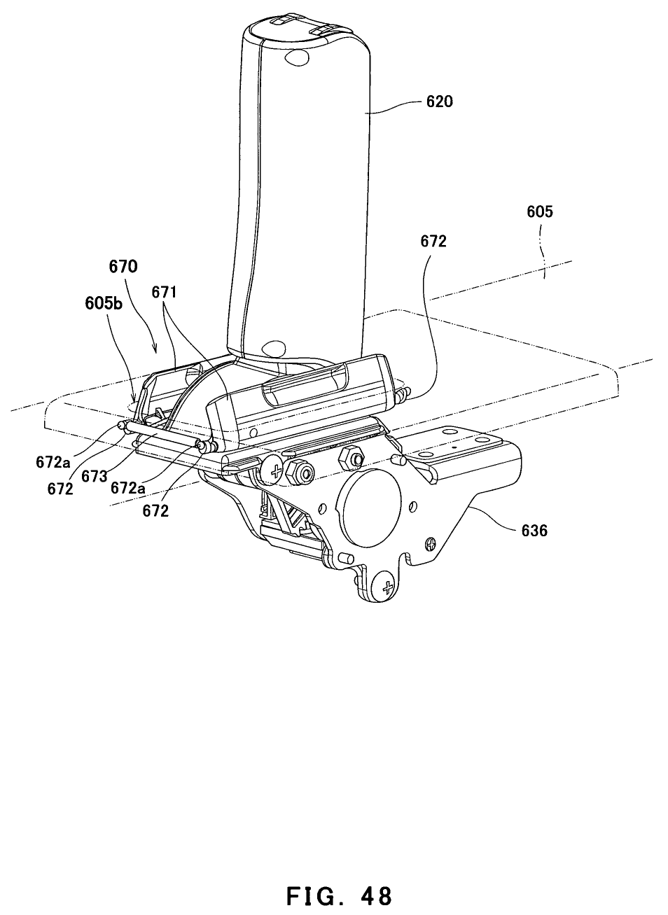

FIG. 47 is a perspective view showing a construction of the shutter 670 that is applicable to an opening through which the joystick 620 moves into and out of the arm rest 605, and a state in which the shutter 670 is closed. FIG. 48 is a perspective view showing a state in which the shutter 670 is opened.

As shown in FIG. 47, a rectangular opening 605b forming the opening through which the joystick 620 moves into and out of the interior of the arm rest 605 is formed on the upper surface of the arm rest 605. With the joystick 620 stored into the arm rest 605, its top portion is located lower than the opening 605b. The shutter 670 is mounted in the opening 605b. The shutter 670 is configured to open in the rightward and leftward direction and includes right and left doors 671 that are of a rectangular shape that is elongated in the forward and backward direction. Rotational shafts 672 having axes extending in the forward and backward direction are mounted on outer regions of a front end and a rear end of each door 671. The rotational shafts 672 are rotatably supported on the arm rest 605.

A protruding portion 672a extending in crank shape is provided on the rotational shaft 672 attached at the front end of each door 671. A coil spring 673 is mounted between the protruding portions 672a. The spring 673 causes the rotational shafts 672 to close the doors 671. A spring having the same configuration and function may be mounted between the rotational shafts 672 attached to the rear ends of the doors 671. Recessed portions 671a that are recessed downward are formed at a right region of an upper surface of the left door 671 and at a left region of an upper surface of the right door 671. The user pulls up the recessed portions 671a with fingers to open the shutter 670.

In the shutter 670 constructed above, when the pivot arm 636 is pivoted upward and the joystick 620 moves upward, the respective doors 671 are pushed up from downward by the top portion of the joystick 620, and the shutter 670 is opened in the rightward and leftward direction (see FIG. 48). Conversely, when the joystick 620 moves downward, the right and left doors 671 are rotated to be closed by the action of the spring 673. When the joystick 620 is moved to be located lower than the opening 605b, the shutter 670 is closed completely. Thus, with a simple construction, it is possible to inhibit unwanted substances such as trashes or dust from entering into the interior of the arm rest 605.

As shown in FIG. 47, dust shoots 675 are provided in addition to the shutter 670. The dust shoots 675 are disposed under the right and left sides of the opening 605b in the interior of the arm rest 605 and are curved such that a distance between them decreases in a downward direction. If the unwanted substances enter through the opening 605b, the dust shoots 675 allow the substances to gather to a desired position, and thus the substances do not scatter in the interior of the arm rest 605. The substances are easily collected during maintenance.

The shutter 670 may be replaced by a urethane structure filled in a gap between the joystick 620 in the operation position and the opening 605b. In this case, the urethane structure is provided with an opening smaller than a cross-section of the joystick 620 in the operation position that is formed by sectioning the joystick 620 along an opening surface of the opening 605b, as the opening through which the joystick 620 moves into and out of the interior of the arm rest 605. Also, the urethane structure is desirably provided with cuts or slits to be able to be deformed according to the shape of the joystick 620. Furthermore, the shutter 670 or the urethane structure may be replaced by a stretch element bonded to the opening 605b. In this case, for example, a slit extending in the forward and downward direction is formed in a center region of the stretch element covering the opening 605b to enable the joystick 620 to move into and out of the interior of arm rest 60 through the slit. Thus, by using the urethane structure or the stretch element, it is possible to inhibit the substances from entering into the arm rest 605 through the opening 605.

It shall be understood that the above mentioned system to store the control device 633 into the interior of the arm rest 605 is merely exemplary and other systems may be employed. Also, the configuration to cause the joystick 620 to move from the interior of the arm rest 605 into the operation position is merely exemplary, and other configurations may be used so long as the control device 633 stored in the interior of the arm rest 605 is placed into the operation position to be ready for the operation. These are not intended to be limited to the above embodiments.

Moreover, the above mentioned operation to store the joystick 620 into the storage portion 650, or the above mentioned operation to cause the joystick 620 stored in the storage portion 650 to be placed in the operation position are merely exemplary, and other methods may be employed to accomplish these.

### Embodiment 5

Now, another embodiment of the present invention will be described.

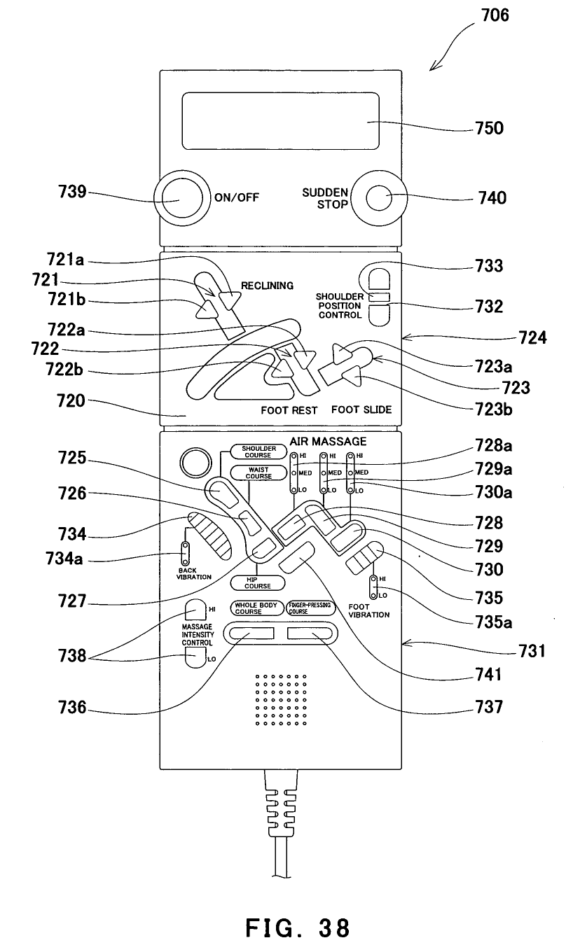

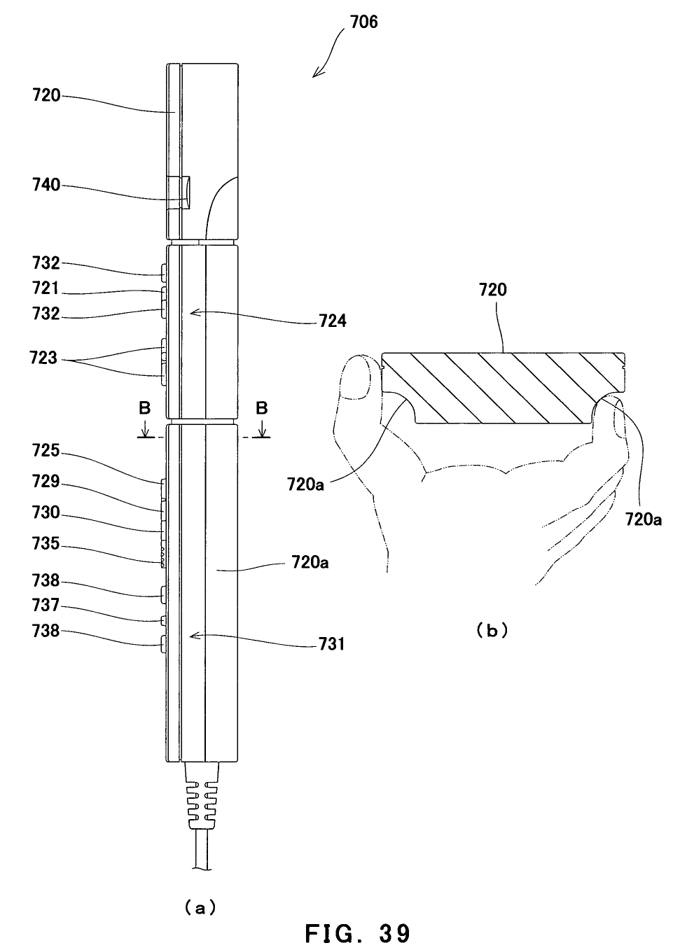

FIG. 38 is a front view showing a construction of an entire remote control device 706 of the chair-type massaging apparatus according to a fifth embodiment of the present invention. FIGS. 39(a) and 39(b) are views showing the remote control device 706 of the chair-type massaging apparatus of FIG. 38, in which FIG. 39(a) is a side view and FIG. 39(b) is a cross-sectional view along B-B. In this cross-sectional view, an internal structure is omitted. The remote control device 706 of the fifth embodiment may be applied to the chair-type massaging apparatus 501 illustrated in FIG. 24 of the third embodiment, instead of the remote control device 506. Below, description will be made with reference to FIG. 24 of the third embodiment in addition to FIGS. 38 and 39. In the fifth embodiment, the control device 533 may be omitted in the chair-type massaging apparatus 501 of FIG. 24. Also, the directions used in this embodiment correspond with the directions used in the third embodiment.

As shown in FIGS. 38 and 39, the remote control device 706 of the fifth embodiment is of a rectangular shape that is longitudinally elongated. A device body 720 of the remote control device 706 is provided with recesses 720a at both sides on the back side to enable the user to easily hold the device body 720. A position control portion 724 including arrow-shaped control buttons 721, 722, and 723 is provided on the upper side of the device body 720 of the remote control device 706. The control buttons 721, 722, and 723 are configured to control an angle of the back rest 503 of the chair-type massaging apparatus 501, and an angle and a position of the foot rest 504 of the chair-type massaging apparatus 501. A massage position control portion 731 including selection buttons 725, 726, 727, 728, 729 and 730 is provided on the lower side of the device body 720. The selection buttons 725, 726, 727, 728, 729, and 730 are used to select the massage operation of the massaging element 508 mounted in the back rest 503 and the massage operations of the air bags 515, 516, and 517 mounted in the foot rest 504 and the seat portion 502.

To be specific, the position control portion 724 provided on the upper side schematically illustrates a side-view shape of the chair-type massaging apparatus 501. The arrow-shaped reclining control button 721 is attached to a region schematically illustrating the back rest 503 to recline the back rest 503. The arrow-shaped foot rest control button 722 and the arrow-shaped foot slide control button 723 are attached to a region schematically illustrating the foot rest 504 to change the angle of the foot rest 504 and to move the tip end of the foot rest 504 in the vertical direction, respectively. In this manner, the control buttons 721, 722, and 723 are arranged in the side-view shape of the chair-type massaging apparatus 501. The reclining control button 721 includes an arrow-shaped control button 721a that is configured to be pressed to raise the back rest 503 and to lower, a lower end of the foot rest 504, and an arrow-shaped control button 721b that is configured to be pressed to fall the back rest 503 down and to raise the lower end of the foot rest 504 forward. The foot rest control button 722 includes an arrow-shaped control button 722a that is configured to be pressed to raise the lower end of the foot rest 504 forward, and an arrow-shaped control button 722b that is configured to be pressed to lower the lower end of the foot rest 504. The foot slide control button 723 includes an arrow-shaped control button 723a that is configured to be pressed to cause the lower end of the foot rest 504 to move closer to the seat portion 502, and an arrow-shaped control button 723b that is configured to be pressed to cause the lower end of the foot rest 504 to move away from the seat portion 502. In this manner, these control buttons 721, 722, and 723 which are arrow-shaped are pressed to enable the back rest 503 and the foot rest 504 to move in the direction as indicated by the respective arrows.

The position control portion 724 is provided with a shoulder position control button 732 to control a shoulder position to be massaged by the massaging element. The shoulder position control button 732 includes upper and lower shoulder position control buttons. When the upper shoulder position control button 732 is pressed, the massaging element 508 moves up, while when the lower position shoulder control button 732 is pressed, the massaging element 508 moves down. A LED lamp 733 is positioned between the shoulder position control buttons 732. The LED lamp 733 lights up in an orange color to inform the user that the shoulder position of the massaging element is now controllable.

The selection buttons 725 to 730 are arranged on the lower massage position control portion 731 in a side-view shape of the user seated in the seat portion 502 of the chair-type massaging apparatus 501. To be specific, as shown in FIG. 38, a shoulder, a waist, a hip, and a thigh of the user are bent in L-shape with a head of the user positioned on an upper region on the left side. A shoulder selection button 725, a waist selection button 726, and a hip selection button 727 are arranged in this order from above to correspond to the shoulder position, the waist position, and the hip position, respectively. By pressing the shoulder selection button 725, the waist selection button 726, and the hip selection button 727, a preset shoulder selection course, a preset waist selection course, and a present hip selection course are selected, respectively. In the respective courses, the present massage programs are run in automated courses.

A calf of the user is schematically illustrated to be bent and connected to a region schematically illustrating a thigh of the user so as to form an inverted-L shape. A foot of the user is schematically illustrated to be bent and connected to a region schematically illustrating the calf so as to form an L-shape. A thigh selection button 728, a calf selection button 729, and a foot selection button 730 are arranged in this order from above in the region schematically illustrating the side-view shape of the user so as to correspond to the thigh, the calf, and the foot, respectively. The thigh selection button 728, the calf selection button 729, and the foot selection button 730 are provided so as to correspond to the thigh position, the calf position, and the foot position, and are each configured to include “HIGH” “MEDIUM,” and “LOW,” one of which is selectable. LED lamps 728a, 729a, and 730a are attached to inform the user of a selected one of “HIGH” “MEDIUM,” and “LOW.” The “HIGH,” “MEDIUM,” or “LOW” is selected so that the pressing forces of the air bags 515, 516, and 517 are adjusted to change the massage forces to be applied to the user.

“HIGH,” “MEDIUM,” or “LOW” to control the pressing forces of the air bags 515, 516, and 517 is selectable by the operations of the selection buttons 728 (729, 730) to select the massage operations according to the user's preference. The intensity of the massage operation may be controlled in such a manner that the massage starts at “MEDIUM” by pressing the selection buttons 728 (729, 739), and thereafter “HIGH”, “STOP,” “LOW,” “MEDIUM,” “HIGH,” . . . are repeated every time the same selection buttons 728 (729, 739) are pressed. The user is able to be informed of the selected one of the “HIGH” “MEDIUM,” and “LOW” by lighting up of the LED lamps 728a, 729a, or 730a. The massage operations of the air bags 515, 516, and 517 may be carried out in such a manner that plural spots are massaged by pressing the selection buttons 728, 729, and 730 simultaneously. Alternatively, the massage operations of the air bags 515, 516, and 517 may be alternately carried out at predetermined intervals by operating the selection buttons 728, 729, and 730.

Thus, the control buttons 721 to 723 corresponding to the respective parts of the massaging apparatus 501 are arranged on the position control portion 724 provided on the upper side of the front surface of the device body 720 in the schematic side-view shape of the chair-type massaging apparatus 501, and the selection buttons 725 to 730 corresponding to the respective massage positions are arranged on lower massage position control portion 731 in the side-view shape of the user.

Furthermore, a vibrator button 734 is attached to a region on the back side (left side) near the shoulder selection button 725, the waist selection button 726, and the hip selection button 726 respectively corresponding to the shoulder, the waist, and the hip of the user which are schematically illustrated on the massage position control portion 731 and is configured to cause the vibrators 511 (see FIG. 24) to provide vibration to the massaging elements 508 that are configured to massage at the positions corresponding to the buttons 725, 726, and 726. In addition, a vibrator button 735 is attached to a region under and near the foot selection button 730 corresponding to the foot position of the user which is schematically illustrated on the massage position control portion 731 and is configured to allow vibration to be applied to the sole of a foot. The vibrator buttons 734 and 735 are provided with convex and concave portions on a surface thereof, and their tactile feel is different from the tactile feel of the other selection buttons 725 to 730. In addition, the vibrator buttons 734 and 735 are configured to be able to select “HIGH” or “LOW,” and LED lamps 734a and 735a are provided to indicate “HIGH” or “LOW” selected.

These vibrator buttons 734 and 735 are able to be selectively operated and its intensity is selectively controllable. By way of example, “HIGH” or “LOW” is controlled in such a manner that the vibrator starts-up at “LOW” by pressing the vibrator button 734 (735), and thereafter “HIGH”, “STOP,” “LOW,” “HIGH,” . . . are repeated every time the same selection button 734 (735) is pressed. The user is able to be informed of “HIGH” or “LOW” selected by lighting up the LED lamps 734a or 735a.

Furthermore, a whole body course selection button 736 and a finger-pressing selection button 737 are provided at a lower region of the massage position control portion 731. The whole body course selection button 736 is configured to allow a whole body of the user to be massaged according to a preset massage program, rather than a specified massage position. These are automated courses in which preset massage programs are run.

Furthermore, in the fifth embodiment, intensity control buttons 738 are provided to select “HIGH” or “LOW” of the massage carried out by pressing the selection buttons 725 to 730, 736, and 737. “HIGH” or “LOW” is selected by pressing the upper “HIGH” intensity control button 738 or the lower “LOW” intensity control button 738, respectively. Each intensity control button 738 is adapted to be able to be operated during the massage.

The LED lamps 728a, 729a, and 730a light up to indicate “HIGH,” “MEDIUM,” or “LOW,” which is selected by pressing the selection buttons 728, 729, and 730, and the LED lamps 734a and 735a light up to indicate “HIGH” or “LOW” which is selected by pressing the vibrator buttons 734 and 735, by an orange color when the automated courses are selected, and by a green color when the manual courses in which the selection buttons 728, 729, 730, 734, and 735 are individually selected. The LED lamps lighting up in different colors enables the user to easily recognize the courses of the massage being carried out.

A display portion 750 is equipped in an upper end region of the device body 720. Under the display portion 750, a power supply button 739 and a sudden stop button 740 are attached. Various messages are displayed on the display portion 750 during an operation in which the power supply button 739 is on. For example, upon the power supply button 739 being turned on, messages such as product name “ . . . MEDICAL CHAIR (registered mark), model name, or “BEING PREPARED” are displayed. Also, the massage operation selected by the massage position control portion 731 is displayed, and in the case of the automated course, explanation of the selected massage program, a course name “SHOULDER” and a message stating “THIS COURSE IS INTENDED TO BREAK UP STIFFNESS IN BODY PARTS FROM NECK TO SHOULDER” are displayed. If some communication errors take place during the control of the body or the like, a message stating “TURN ON POWER SUPPLY AGAIN,” is displayed for resetting. The display portion 750 may include a fluorescent display tube or a liquid crystal panel.

741 designates a heater button. The depicted configurations of the buttons 721 to 723, 725 to 730, 732, and 734 to 741 are not intended to be limited to those in this embodiment, but may be determined depending on the size or configuration of the chair-type massaging apparatus 501.

In accordance with the remote control device 706 configured as described above, since the control buttons 721 to 723 are arranged in the side-view shape of the chair-type massaging apparatus 501, and the selection buttons 725 to 730 are arranged in the side-view shape of the user seated in the chair-type massaging apparatus 501, the user seated in the chair-type massaging apparatus 501 is able to easily select desired massage operations using the remote control device 706 without mental effort. As a result, a user who is unfamiliar with the operation of the massaging apparatus is able to easily select a desired massage operation.

In addition, since the control buttons 721 to 723 configured to control the angle of the back rest 503 and the position of the foot rest 504 are positioned on the upper side and the selection buttons 725 to 730 configured to select the massage operation are positioned on the lower side, the user seated in the chair-type massaging apparatus 501 first adjusts the attitude using the control buttons 721 to 723 attached on the position control portion 724, and then selects a desired massage using the selection buttons 725 to 730 or the selection buttons 736 and 737 which are attached on the massage position control portion 731. Thus, the user is able to easily select the massage operation.

Furthermore, during the operation of the control buttons 721 to 723 and the selection buttons 725 to 730, and 736 and 737, different operation sounds may be emitted according to the respective massage spots. For example, an air sound “shu . . . ” may be emitted during the operation of the air bags 515, 516, and 517, or otherwise, a vibration sound “buruburu . . . ” may be emitted during the operation of the vibrator 511 (e.g., vibrator attached on the foot rest 504 to massage the sole of the foot of the user). This enables the user to recognize the massage operation by the sounds.

Thus, in accordance with the remote control device 706 for the chair-type massaging apparatus, the user is able to visually select a desired massage operation using the remote control device 706 without mental effort. As a result, even a user which is unfamiliar with the operation of the massaging apparatus or the remote control device is able to easily select a desired massage operation.

The depicted number of the selection buttons of the fifth embodiment is merely exemplary. The number of massage positions or placement of the air bags may be determined depending on the specification of the chair-type massage apparatus to which these are applied, and are not intended to be limited to those in this embodiment.

### Embodiment 6

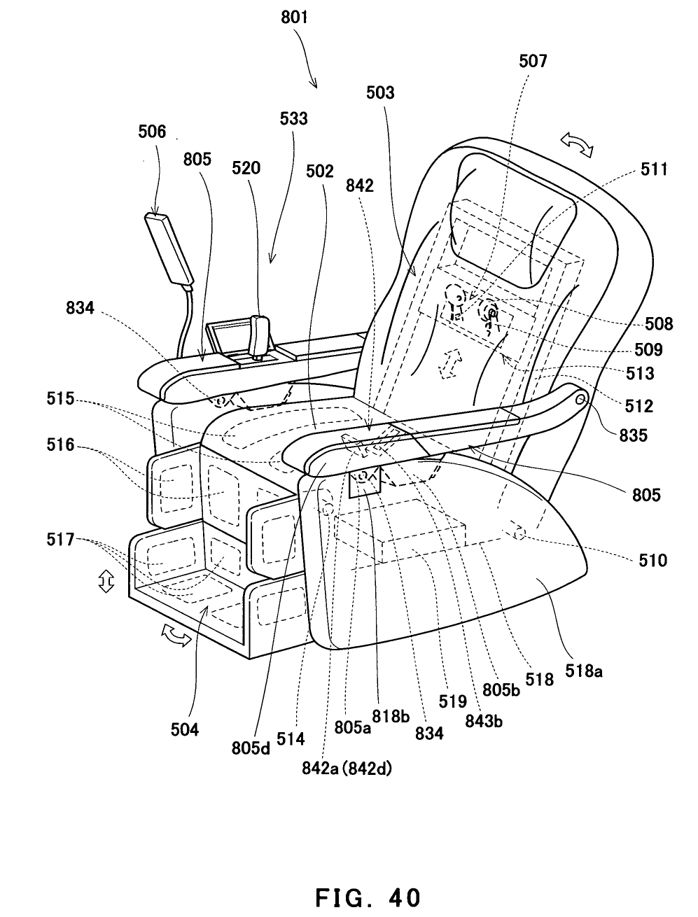

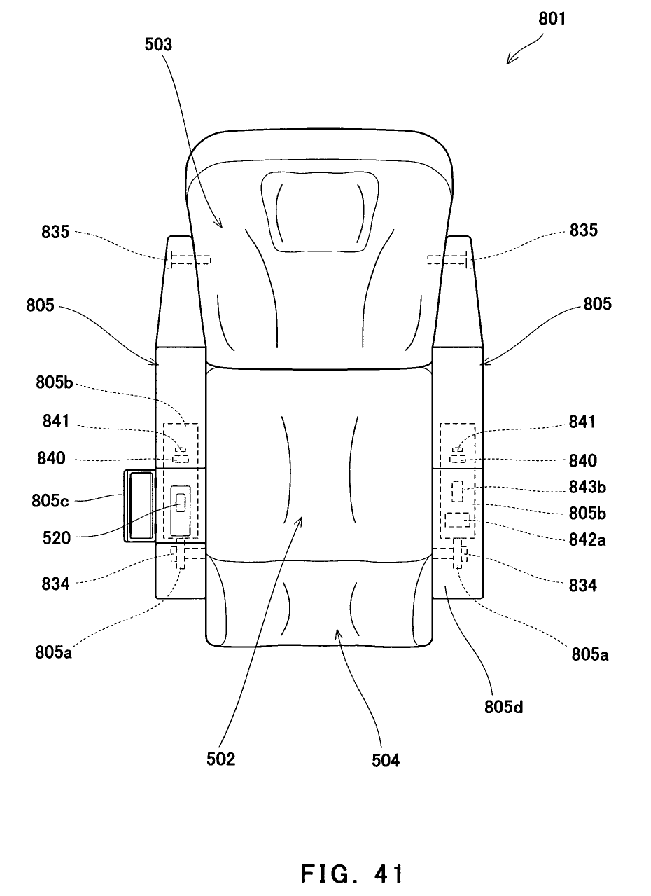

Now, another embodiment of the present invention will be described. FIG. 40 is a perspective view showing a construction of an entire chair-type massaging apparatus according to a sixth embodiment of the present invention. FIG. 41 is a plan view of the chair-type massaging apparatus. In a chair-type massaging apparatus 801 in FIGS. 40 and 41, the same components as those of the chair-type massaging apparatus 501 of the third embodiment are designated by the same reference numerals, and will not be further described. It is assumed that the directions used in the sixth embodiment corresponds with the directions used in the third embodiment. As shown in FIGS. 40 and 41, the chair-type massaging apparatus 801 of the sixth embodiment mainly comprises the seat portion 502, the back rest 503, the foot rest (leg rest) 504, and right and left arm rests 805. A joystick control device 533 having the same configuration as that described with reference to FIGS. 26 and 27 of the third embodiment is mounted on the right arm rest 805. The right and left arm rests 805 are detachable and interchangeable.

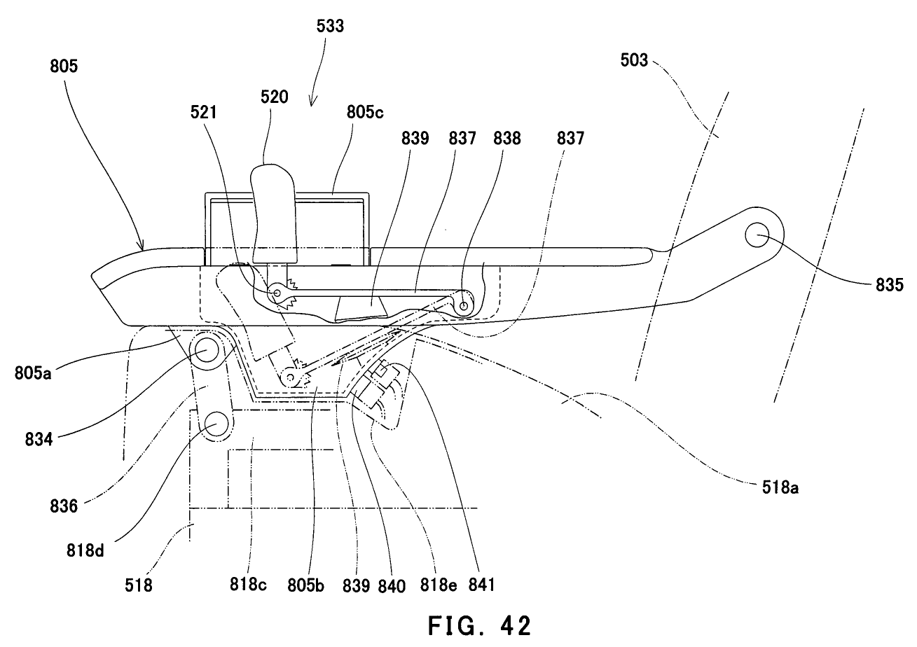

As shown in FIGS. 40 and 41, the right and left arm rests 805 have outer shapes of the same size and are symmetric in the rightward and leftward direction as viewed from above. The right and left arm rests 805 are mounted in the same manner. Each arm rest 805 of this embodiment is supported at a front end portion thereof on the leg portion 518a by a bracket 805a mounted under the arm rest 805 and by a support pin 834, and is mounted at a rear portion thereof on the back rest 503 by a support pin 835. Since the rear support pin 835 moves backward away from the seat portion 502 when the back rest 503 is reclined, the front support pin 834 is mounted to be movable backward with the movement of the rear support pin 835. The front support pin 834 is mounted to be movable in the forward and backward direction by supporting the front support pin 834 using a link 836 of FIG. 42 described later, a slide rail, etc.

The front support pin 834 and the rear support pin 835 that are configured to support the arm rest 805 are removably attachable on the leg portion 518a and the back rest 503. The support pin 834 is inserted through a support pin opening 818b formed on outside of an upper region of the leg portion 518a and toward the seat portion 502 and is fixed to allow the front portion of the arm rest 805 to be supported by the leg portion 518a. The rear support pin 835 is inserted from the side of the user toward the back rest 503 and is fixed to allow the rear portion of the arm rest 805 to be supported on the back rest 503. By removing these support pins 834 and 835, the arm rest 805 is detachable from the leg portion 518a and the back rest 805.

FIG. 42 is a side view showing the arm rest 805 to which the joystick control device 533 of the chair-type massaging apparatus 801 of FIG. 40 is mounted. In this embodiment, the joystick 520 of the joystick control device 533 is configured to be stored into the interior of arm rest 805. First, the right arm rest 805 to which the joystick control device 533 is mounted will be described with reference to FIG. 42. The joystick 520 in FIG. 42 is placed in a predetermined position where the user is able to operate it as indicated by a solid line and is stored into the interior of the arm rest 805 as indicated by a two-dotted line.

As shown in FIG. 42, the bracket 805a, configured to be supported by the front support pin 834, is mounted at a front region of the right arm rest 805. The bracket 805a is coupled to a frame 818c attached on the leg portion 518a by the link 836 supported by the pin 818d and the support pin 834. In this state, the front region of the arm rest 805 is supported on the leg portion 518a (base 518). The rear region of the arm rest 805 is supported on the back rest 503 by the rear support pin 835. With the arm rest 805 supported in the manner, the rear support pin 835 moves backward from the seat portion 502 when the back rest 503 is caused to fall down backward. With this movement, the upper region (on the front support pin 834 side) of the link 836 is tilted backward, causing the support pin 834 to move backward.

A storage portion 805b that stores the joystick 520 protrudes downward from the lower region of the arm rest 805. A storage portion hole 818e into which the storage portion 805b is accommodated is formed in a region of the leg portion 518a that corresponds to the storage portion 805b.

The joystick 520 is constructed in such a manner that the support shaft 521 (see FIG. 27) is mounted on a front end of the pivot arm 837 and a rear end of the pivot arm 837 is mounted on a rear region of the storage portion 805b of the arm rest 805 by a support shaft 838. In this construction, when the pivot arm 837 is pivoted in the vertical direction, the joystick 520 is stored in the interior of the arm rest 805 or is moved from the interior of the arm rest 805 into the predetermined position. 805c designates a lid member configured to close an upper opening of the arm rest 805 with the joystick 520 stored in the interior of the arm rest 80 wall of the storage portion 805b and is expanded to push up the pivot arm 837 by supplying the air into its interior, causing the joystick 520 to be placed in the predetermined position.

In order to store the joystick 520 into the arm rest 805, the user pushes the joystick 520 downward, causing the pivot arm 837 to be pivoted around the support shaft 838, which enables the joystick 520 to be placed into the storage portion 805b. In order to move the joystick 520 from the interior of the storage portion 805b into the predetermined position, the air is supplied to the air bag 839 attached on the lower region of the pivot arm 837, causing the front end side of the pivot arm 837 to move upward, which enables the joystick 520 to be placed into the predetermined position (in FIG. 42, only an upper end of the air bag 839 in an expanded state is illustrated). In this embodiment, the user exerts a force to store the joystick 520 into the interior of the arm rest 805, while the air bag 839 is expanded to enable the joystick 520 to be moved into the predetermined position. How to store the joystick 520 and to move it into the predetermined position is not intended to be described in this embodiment. The method (FIGS. 34 to 37, 45 to 48) described in the fourth embodiment may be employed to store the joystick 520 and to move it into the predetermined position.

A transmission device 840 is mounted between the storage portion 805b and the storage portion hole 818e and is configured to couple the joystick control device 533 mounted on the arm rest 805 to the controller 519 mounted on the base 518 and to communicate a signal between them. The transmission device 840, which is an example of a transmission device, is a wire joint whose storage portion 805b side is indicated by a solid line and whose storage portion hole 818e side is indicated by a two-dotted line. Since the air bag 839 that is expandable and contractable is used to place the joystick 520 into the predetermined position, a connecting device 841 is mounted between the storage portion 805b and the storage portion hole 818e and is configured to removably connect the air bag 839 to a pump (not shown) mounted on the base 518 side in order to supply, from the base 518 side, compressed air which is a drive force to expand the air bag 839. The connecting device 841, which is an example of the connecting device, is, for example, a fluidic joint that is capable of supplying air. In FIG. 42, the storage portion 805b side of the connecting device 841 is indicated by a solid line and the storage portion hole 818e side thereof is indicated by a two-dotted line. Since the wire joint is used as the transmission device 840 and the fluidic joint is used as the connecting device 841 in this embodiment, connection/removal of the devices that enable the signal and the drive force to be transmitted between the arm rest 805 and the base 518 is easily accomplished. The depicted constructions of the transmission device 840 and the connecting device 841 are merely exemplary, and other configurations may be used to transmit a control signal or to transmit the drive force.

The controller 519 is configured to detect connecting states of the transmission device 840 and the connecting device 841. The controller 519 is configured to disable the function of the remote control device 506 if correct connections of the transmission device 840 and the connecting device 841 are not established. Since the controller 519 is configured to cause connecting states to be displayed on the remote control device 506, the user is able to easily confirm the connecting states of the transmission device 840 and the connecting device 841. In this case, which of the arm rests 805 the joystick control device 33 is coupled to may be displayed on the remote control device 506. Also, the connecting states of the transmission device 840 and the connecting device 841 may be detected and displayed on the remote control device 506.

A detecting device configured to detect whether or not the arm rest 805 is correctly mounted at the front and rear regions may be mounted to a mounting portion of the arm rest 805, and a mounting state of the arm rest 805 may be displayed on the remote control device 506 based on a signal from the detecting device.

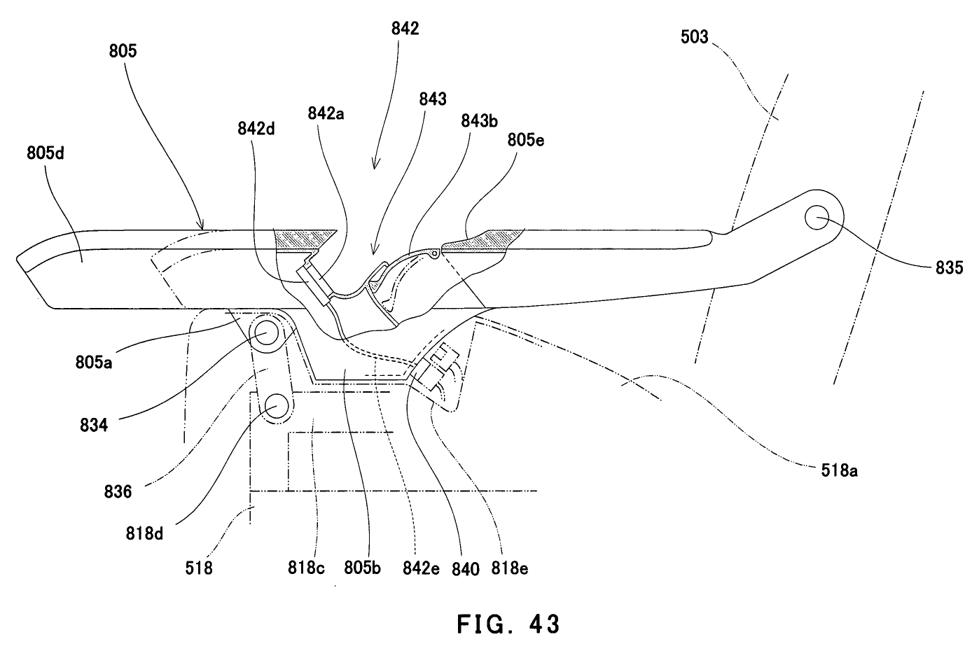

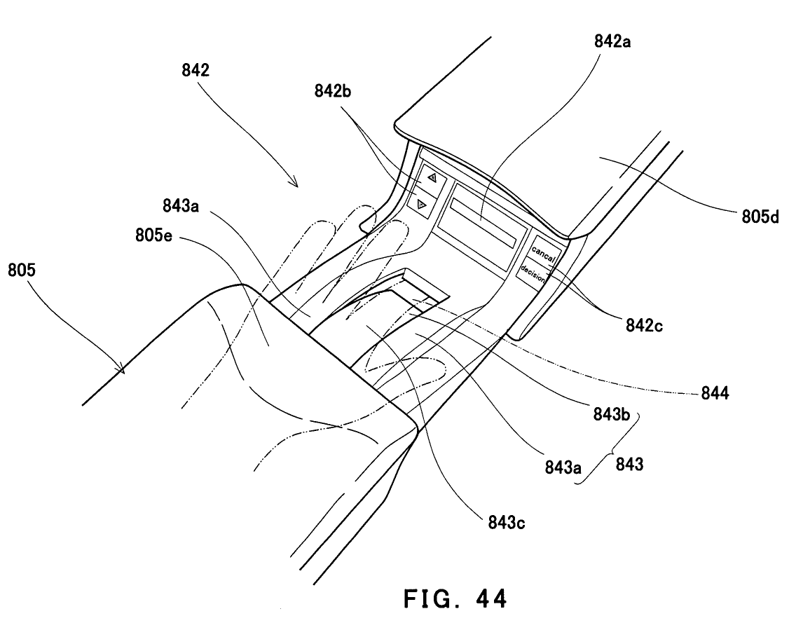

FIG. 43 is a side view of the left arm rest 805 to which a pulse wave measuring device in FIG. 40 is mounted, and FIG. 44 is a perspective view showing a region of the arm rest of FIG. 43 to which the pulse wave measuring device is mounted. In FIGS. 43 and 44, the same components as those in FIG. 42 are identified by the same reference numerals, and will not be further described.

As shown in FIGS. 43 and 44, an outer arm rest portion 805d is located at a front region of the left arm rest 805 and is configured to be slidable forward. In these Figures, a solid line indicates a state in which the arm rest portion 805d is slid forward and a two-dotted line indicates a tip end side of the arm rest portion 805d in a state in which the arm rest portion 805d is slid backward and closed. By sliding the arm rest portion 805d forward, the pulse wave measuring device 842 which is a measurement device mounted in the interior of the arm rest 805 appears. In this case, a concave hand region 805e also appears in an upper region of the arm rest 805 which is located at a rear end side of the arm rest portion 805d, i.e. at a location behind and near the pulse wave measuring device 842 with the arm rest portion 805d slid forward. Also, when the arm rest portion 805d is slid forward, a power supply of the pulse wave measuring device 842 is turned on, while when the arm rest portion 805d is slid backward and closed, the power supply of the pulse wave measuring device 842 is turned off. The pulse wave measuring device 842 is capable of measuring a fingertip pulse wave and a pulse. For example, the pulse wave measuring device 842 may be able to optically capture a pulsation of arterial blood by a pulse of a fingertip, and to observe a fluctuation in each of the amount of transmission light with respect to red color light and infrared light. The depicted pulse wave measuring device 842 of the sixth embodiment is merely exemplary, and other configuration may be used.

As shown in FIG. 44, the pulse wave measuring device 842 is equipped with a sensor 843, a display portion 842a, and control switches 842b and 842c. The sensor 843 includes a raised portion 843a on which the hand is put and a measuring portion 843b having a center region into which a finger 844 is put. The measuring portion 843b has a finger board 843c on which the finger 844 is put during use. The finger board 843c serves as a lid when it is not used. When the finger 844 presses the finger board 843c, its front portion is pivoted downward so that the finger 844 is put into the measuring portion 843b (see FIG. 43). A menu representing measurement operations to be selected is displayed on a display portion 842a. For example, selectable items are displayed within a frame at a center region of the display portion 842a. The display portion 842a employs an LCD display method. In the sixth embodiment, control switches 842b and 842c are attached on both sides of the display portion 842a. The list control switch 842b is attached on the left side and configured to scroll a menu displayed on the display portion 842a, and the selection control switch 842c is attached on the right side and configured to select or cancel the menu displayed on the display portion 842a. The list control switch 842b located on the left is able to scroll to the right or to the left, according to the content displayed on the display portion 842a. The pulse wave measuring device 842 is equipped with a memory 842d (see FIG. 43) that stores measurement data. In the depicted construction, the memory 842d is coupled to the transmission device 840 through a wire 842e.

In this construction, furthermore, the left list control switch 842b enables desired items to be displayed on the display portion 842a and the right selection control switch 842c enables a desired item to be decided. In the sixth embodiment, the selection switch 842c is separate from the display portion 842a. Alternatively, the display portion 842a may be configured by a touch panel to serve as the selection control switch 842c. Other configurations may be employed to select a desired item.

A specific procedure for operating the pulse wave measuring device 842 constructed above will be explained. Prior to the operation, conditions such as a user name, sex, age, etc. are entered, and the finger 844 is put into the measuring portion 843b of the sensor 843. Then, an item “START MEASUREMENT” is displayed on the display portion 842a by using the list control switch 842b, and a decision button of the selection control switch 842c is pressed. Thereby, measurement is completed in a predetermined time, and the resulting measurement data is displayed on the display portion 842a. Thereafter, after the massage is carried out, the pulse wave is measured again. The operation is such that the finger 844 is put into the measuring portion 843b, the item “START MEASUREMENT” is displayed on the display portion 842a using the list control switch 842b, and the decision button of the selection control switch 842c is pressed. Thereby, measurement is completed in a predetermined time, and the resulting measurement data is displayed on the display portion 842a. The data indicates comparison before and after the massage.

The memory 842d of the pulse wave measuring device 842 is able to store a measurement history. “DISPLAY SWITCH” is displayed on the display portion 842a and decided so that switching is made between a current measurement data image and a past history display image. Furthermore, a pulse waveform is displayed on the display portion 842a, and the selection switch 842c is able to scroll to the right or to the left to display the waveform. The data measured in this way may be stored, and switching may be made between the current measurement data image and the past history display image.

In accordance with the chair-type massaging apparatus 801 constructed as described above, the arm rest equipped with the joystick control device 533 and the pulse wave measuring device 842 is exchangeable between the right and left sides to enable the user to easily operate it. For example, the joystick control device 533 may be positioned on the user's dominant arm side, and an opposite arm may, for example, select the massage operation while measuring the pulse wave. In addition, the joystick control device 533 and the pulse wave measuring device 842 are able to obtain power supply from the base 518 side by connecting the removable transmission device 840 to them.

While both of the joystick control device 533 and the pulse wave measuring device 842 are mounted to the right or left arm rest 805 in the sixth embodiment, one of them may be mounted. In this case, the arm rest 805 to which the device 533 or 842 is mounted may be positioned on the right side or on the left side where the user is able to easily operate the device 533 or 842.

The position illustrated in the sixth embodiment in which the arm rest 805 is detachable is merely exemplary, and the arm rest 805 equipped with the devices 533 and 842 may be detachable and exchangeable between the right side and the left side. In addition, how to support the arm rests 805 is merely exemplary, and the arm rests 805 are not necessarily supported on the leg portions 518a and the back rest 503. By way of example, the arm rests 805 may be supported at front and rear regions on the leg portions 518a.

The first to sixth embodiments of the present invention described thus far are merely exemplary and numerous other modifications and variations can still be made without departing the sprit and scope of the invention. The present invention is not intended to be limited to the embodiments described above.

### INDUSTRIAL APPLICABILITY

The present invention is useful in chair-type massaging apparatuses and massaging apparatuses that are adapted to massage a body of a user, and various control devices equipped in these massaging apparatuses. In particular, the present invention is useful in chair-type massaging apparatuses and massaging apparatuses that are adapted to massage a body of a user seated therein by the user's operation without mental effort or feeling discomfort, and various control devices equipped in these massaging apparatuses.

1. A chair-type massaging apparatus comprising:
a massaging element that is mounted in a back rest configured to support a back of a user and is configured to be movable to apply stimulation to the back of the user;
a control device that includes a grip configured to be operated by the user to be displaceable from a predetermined neutral position and is configured to output a signal indicating an operation of the grip; and
a controller configured to, based on the signal from the control device, execute control to move the massaging element in a direction corresponding with a direction in which the grip is operated to move.

2. The chair-type massaging apparatus according to claim 1,
wherein the massaging element and the grip of the control device are each configured to be movable in a forward and backward direction; and
wherein the controller is configured to cause the massaging element to move in the forward and backward direction when the grip is operated to move in the forward and backward direction.

3. The chair-type massaging apparatus according to claim 2,
wherein the controller is configured to cause the massaging element to move according to a time period in which the grip of the control device is operated to move in the forward and backward direction from the neutral position.

4. The chair-type massaging apparatus according to claim 2,
wherein the controller is configured to cause the massaging element to move according to a displacement amount of the grip of the control devices which is operated to move in the forward and backward direction from the neutral position.

5. The chair-type massaging apparatus according to claim 1,
wherein the massaging element and the grip of the control device are each configured to be vertically movable; and
wherein the controller is configured to cause the massaging element to move in a vertical direction when the grip is operated to move in the vertical direction.

6. The chair-type massaging apparatus according to claim 5,
wherein the controller is configured to cause the massaging element to move according to a time period in which the grip of the control device is operated to move in the vertical direction from the neutral position.

7. The chair-type massaging apparatus according to claim 5,
wherein the controller is configured to cause the massaging element to move according to a displacement amount of the grip of the control device, which is operated to move in the vertical direction from the neutral position.

8. A massaging apparatus comprising:
a massaging portion that is configured to be movable to apply stimulation to a user;
a control device configured to output a signal indicating a displacement amount of the control device from a neutral position; and
a controller configured to control an operation of the massaging portion based on the signal from the control device;
wherein the controller is configured to cause the massaging portion to move by a displacement amount proportional to a displacement amount of the control device from the neutral position; and
wherein a dead zone in which the massaging portion does not operate is set in a predetermined displacement range of the control device so as to include at least one of the neutral position and a maximum displacement position of the control device.

9. A massaging apparatus comprising:
a massaging portion that is configured to be movable to apply stimulation to a user;
a control device configured to output a signal indicating a displacement amount of the control device from a neutral position; and
a controller configured to control an operation of the massaging portion based on the signal from the control device;
wherein the controller is configured to cause the massaging portion to move by a displacement amount proportional to a displacement amount of the control device from the neutral position; and
wherein the controller is configured to cause the massaging portion to move at a speed according to the maximum displacement speed of the control device during displacement of the control device.

10. The chair-type massaging apparatus according to claim 9, wherein the controller is configured to cause the massaging portion to move at a speed varying in a step shape according to a displacement speed of the control device.

11. A massaging apparatus comprising:
a massaging portion that is configured to be movable to apply stimulation to a user;
a control device configured to output a signal indicating a displacement amount of the control device from a neutral position; and
a controller configured to control an operation of the massaging portion based on the signal from the control device;
wherein the controller is configured to cause the massaging portion to move by a displacement amount proportional to the displacement amount of the control device from the neutral position; and
wherein the controller is configured to cause the massaging portion to increase its speed when a difference value between a target position of the massaging portion that corresponds to the displacement of the control device and a current position of the massaging portion meets or exceeds a threshold.

12. A massaging apparatus comprising:
a massaging portion that is configured to be movable to apply stimulation to a user;
a control device configured to output a signal indicating a displacement amount of the control device from a neutral position; and
a controller configured to control an operation of the massaging portion based on the signal from the control device;
wherein the controller is configured to cause the massaging portion to move by a displacement amount proportional to the displacement amount of the control device from the neutral position; and
wherein the controller is configured to, when a displacement speed of the control device increases, set an acceleration to enable the massaging portion to reach a target displacement speed after the increase in the displacement speed of the control device, using, as a gain, the displacement speed of the control device or the massaging portion before the increase.

13. A massaging apparatus comprising:
a massaging portion that is configured to be movable to apply stimulation to a user;
a control device configured to output a signal indicating a displacement amount of the control device from a neutral position; and
a controller configured to control an operation of the massaging portion based on the signal from the control device;
wherein the controller is configured to cause the massaging portion to move by a displacement amount proportional to the displacement amount of the control device from the neutral position; and
wherein the controller is configured to, when a displacement speed of the control device increases, set an acceleration to enable the massaging portion to reach a target displacement speed after the increase in the displacement speed of the control device, using, as a gain, a difference value between displacement speeds of the control device or a difference value between target displacement speeds of the massaging portion before and after the increase in the displacement speed of the control device.

14. A massaging apparatus comprising:
a massaging portion that is configured to be movable to apply stimulation to a user;
a control device configured to output a signal indicating a displacement amount of the control device from a neutral position; and
a controller configured to control an operation of the massaging portion based on the signal from the control device;
wherein the controller is configured to cause the massaging portion to move by a displacement amount proportional to the displacement amount of the control device from the neutral position, and to cause the massaging portion to stop when a displacement direction of the control device is changed.

15. A massaging apparatus comprising:
a massaging portion that is configured to be movable to apply stimulation to a user;
a control device configured to output a signal indicating a displacement amount of the control device from a neutral position; and
a controller configured to control an operation of the massaging portion based on the signal from the control device;
wherein the controller is configured to output a control signal to the massaging portion to cause the massaging portion to move by a displacement amount proportional to the displacement amount of the control device from the neutral position;
wherein the massaging portion includes a motor configured to be driven based on the control signal from the controller; and
wherein a PWM signal including pulse signals with a duty ratio that is able to at least start-up the motor is input to the motor, and a pulse string signal including one or a plurality pulse signals is input to the motor at predetermined time intervals, when a displacement speed of the control device is a predetermined low speed or less.

16. The massaging apparatus according to claim 8,
wherein the massaging portion is mounted in a back rest configured to support a back of the user, and the massaging portion and the control device are each movable in a forward and backward direction;
and wherein the controller is configured to control an operation of the massaging portion such that a displacement direction of the control device corresponds with a displacement direction of the massaging portion.

17. The massaging apparatus according to claim 8, wherein the control device is configured to be able to hold a position of the control device that has been displaced from the neutral position, in a non-operating state.

18. A control device of a chair-type massaging apparatus including a massaging system that is equipped in a back rest and is provided with a massaging element configured to massage a back of a user, the control device comprising:
an operation member configured to be able to control movement of the massaging system; and
a plurality of massage operation switches with which a massage operation of the massaging element is able to be selected;
wherein the control device is configured to move the massaging system according to an operation of the operation member in addition to the massage operations selected with the massage operation switches.

19. The control device according to claim 18,
wherein the operation member includes a grip configured to be gripped by a user;
and wherein the grip is equipped with a reclining operation switch of the chair-type massaging apparatus.

20. The control device according to claim 18, further comprising:
a storage device configured to store an operation history of the operation member and the massage operation switch.

21. A chair-type massaging apparatus comprising:
a control device according to claim 18 that is mounted in an arm rest; and
a controller configured to execute control to cause a massage operation to be performed according to an operation of the control device.

22. A control device of a chair-type massaging apparatus comprising:
a back rest including a massaging system provided with a massaging element configured to massage a back of a user; and
an arm rest;
wherein the control device is configured to be mountable on the arm rest and to be stored into a storage portion provided in the arm rest;
and wherein the control device is configured to be stored into the storage portion by a storing operation, and the control device stored in the storage portion is configured to be placed into an operation position by a placing operation.

23. The control device according to claim 22, further comprising:
a lid member that is attached to a region of the arm rest where the control device is located and is configured to cover an upper region of the control device to form an upper surface of the arm rest with the control device stored in the storage portion.

24. The control device according to claim 22, further comprising:
a shutter mounted in an opening that is formed in an upper region of the arm rest to allow the control device to move into and out of an interior of the arm rest, the shutter being configured to be opened and closed when the control device moves out of and into the interior of the arm rest.

25. The control device according to claim 23, further comprising:
an open system configured to start the placing operation of the control device, by the user's operation to open the lid member attached on the arm rest.

26. The control device according to claim 23, further comprising:
a storing system configured to start a storing operation of the control device, by the user's operation to close the lid member attached on the arm rest.

27. The control device according to claim 22, further comprising:
a drive device configured to place the control device stored into an interior of the arm rest into the operation position, which includes an air drive device.

28. A chair-type massaging apparatus comprising:
a control device according to claim 22 that is mounted on an arm rest; and
a detecting device configured to detect a storage state and a placement state of the control device.

29. A remote control device for a chair-type massaging apparatus comprising:
a massage position control portion at which selection buttons are arranged in a side view shape of a user seated in the chair-type massaging apparatus, the selection buttons being configured to be operated to select massage positions of a massaging element mounted in a back rest and massage positions of air bags mounted in a foot rest and a seat portion.

30. The remote control device for a chair-type massaging apparatus according to claim 29, further comprising:
a position control portion at which control buttons are arranged in a side view shape of the chair-type massaging apparatus, the control buttons being configured to be operated to control an angle of the back rest, and an angle and a position of the foot rest.

31. The remote control device for a chair-type massaging apparatus according to claim 29, wherein the selection buttons with which the massage position of the massaging element in the back rest is selected and the massage position of the air bags in the foot rest and the seat portion are selected are configured to be combined to enable massage including a combination of massage by the massaging element and massage by the air bags to be selectively carried out.

32. A chair-type massaging apparatus including a back rest, a seat portion, and a foot rest, comprising:
a remote control device for a chair-type massaging apparatus according to claim 29, wherein the remote control device is configured to select a massage operation of a massaging element mounted in the back rest and air bags mounted in the foot rest and the seat portion.

33. A chair-type massaging apparatus equipped with arm rests on right and left sides of a base, comprising:
a control device mounted on one of the arm rests,
wherein the arm rest on which the control device is mounted and an opposite arm rest are configured to be removably mounted to be interchangeable; the massaging apparatus further comprising:
a transmission device that is mounted between the arm rest on which the control device is mounted and the base and is configured to allow a signal to be transmitted therethrough between the control device and the base.

34. The chair-type massaging apparatus according to claim 33,
wherein the control device mounted on one of the arm rests is a massage control device configured to control a massage operation of a massaging system equipped in the massaging apparatus.

35. The chair-type massaging apparatus according to claim 34,
wherein the massage control device is configured to be stored into an interior of the arm rest, the massaging apparatus further comprising:
a drive device that is mounted in the interior of the arm rest and is configured to place the massage control device stored in the interior of the arm rest into a predetermined position; and
a connecting device removably mounted between the arm rest and the base to allow a drive force of the drive device to be supplied therethrough from the base to the arm rest.

36. The chair-type massaging apparatus according to claim 33, wherein the control device mounted on one of the arm rests is a measurement device configured to measure biological information of a user to be massaged by the massaging apparatus.

37. The chair-type massaging apparatus according to claim 33, further comprising:
a controller configured to detect a connecting state of the transmission device, and to cause a remote control device of the chair-type massaging apparatus to display the detected connecting state.
